(19) United States
(12) Patent Application Publication
(10) Pub. No.: US 2014/0136996 A1
(43) Pub. Date: May 15, 2014

(54) VIRTUAL REMEMBRANCE SYSTEM

(71) Applicant: MYEBITUARY LLC, Kenosha, WI (US)

(72) Inventors: Michael G. Boozer, Kenosha, WI (US); Derric Dennis Brissette, Oak Creek, WI (US); Eric Eugene Garza, Kenosha, WI (US)

(73) Assignee: MYEBITUARY LLC, Kenosha, WI (US)

(21) Appl. No.: 13/800,012

(22) Filed: Mar. 13, 2013

Related U.S. Application Data
(60) Provisional application No. 61/749,854, filed on Jan. 7, 2013.
(60) Provisional application No. 61/725,674, filed on Nov. 13, 2012.

(51) Int. Cl. G06F 3/01

(52) U.S. Cl. CPC G06F 3/01
USPC 715/753

(57) ABSTRACT

Systems and methods for creating and sharing an ebituary and a virtual scene of remembrance and reflection within a social networking environment. One system includes at least one processor. The at least one processor is configured to receive registration information from a first user, generate a profile for the first user within the social networking environment based on the registration information, generate a unique code for the profile, provide the unique code to the first user, receive the unique code from a second user within the social networking environment, update the profile to identify the second user as a manager of the profile, and automatically grant the second user rights to modify the profile after the first person dies.

### RELATED APPLICATIONS

The present application claims priority to U.S. Provisional Application No. 61/725,674, filed Nov. 13, 2012 and U.S. Provisional Application No. 61/749,854, filed Jan. 7, 2013, the entire contents of which are both incorporated by reference herein.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Embodiments of the invention relate to methods and systems for creating and sharing an obituary and a virtual scene of remembrance and reflection within a social networking environment.

### SUMMARY

The entire process associated with death is costly, disjointed, disorganized, and non-centralized. Therefore, the bereaved are often left with a myriad of tasks that typically need to be addressed at a time when the bereaved are in a distressed state of mind. Most of these tasks, from publishing a conventional newspaper obituary, communicating with family and friends about the decedent's funeral services, designing and purchasing a memorial (e.g., a headstone), sending flowers, etc., have to be obtained from multiple sources or services that are not readily known or available to the bereaved. Additionally, the dissemination of information to those who may be affected by a death can be delayed by conditions beyond an individual's control. For example, subscriptions and circulations for conventional newspapers, which typically print obituaries, are declining.

In addition, in today's fast paced society, many people do not have time to visit a burial place or place of remembrance as often as they would like. Many people feel awkward attending funerals or even visiting a burial place or place of remembrance and often are unsure of what to say to the bereaved when doing something as simple as sending their condolences. Additionally, some decedents don't have a physical burial place due to cost constraints or the fact that their bodies were never recovered, such as may be the case with missing people, plane crash victims, victims of explosions, etc. In addition, conventional cemetery use for the deceased, either for a funeral or as a place of remembrance, is declining due to space and cost limitations and the increasing use of cremation services, green burials where the deceased is dissolved in an alkaline or acidic bath, and even drive-by funerals where guests can pay their last respects to the deceased without leaving their automobile. Also, in some situations, the bereaved do not have the financial resources to visit an actual burial place or place of remembrance.

It has often been said that time and distance help alleviate the pain of the bereaved. While this may be true, it also unfortunately allows the deceased to not necessarily be forgotten, but allows the memories of the deceased to gradually fade away as the living continue on, even though many feel an innate obligation to never forget those who have passed away.

As social networking sites are intended for the living, most social networking sites have not addressed the issue of what to do when a user passes away. While some networking sites deactivate the deceased's profile, other sites leave the profile active but only allow family members to view the profile. In the truest sense of social networking, the deceased have been left out of the social networking world as there currently exists no centralized place for people to go and obtain current information for the deceased in a graphics-rich environment that is representative of the lives of the deceased or to share their feelings with others in a respectful manner.

Therefore, embodiments of the present invention provide a centralized place for remembrance, reflection, and respect for the deceased that combines the major elements associated with death, such as obituaries, funeral attendance, paying of respects, sending flowers, visiting places of remembrance and reflection, shared grieving, etc. Embodiments of the invention combine these features into a single place that users can use to their own liking, in private or public, and at any time, regardless of time and/or distance.

In particular, embodiments of the present invention provide a virtual remembrance system (“VRS”) for creating a profile (also referred herein to as an “ebit”) within a social networking environment. The ebit can include a virtual scene of remembrance, such as a cemetery scene. The ebit can also include an obituary (hereinafter referred to as an “ebituary”) that a user can write for themselves (or someone else) even before an individual dies. Therefore, the VRS allows users to keep their (or someone else's) life history and significant events updated while eliminating the emotional and cost burdens on others of having to write a conventional obituary postmortem and having it published in a conventional hard copy format, such as a newspaper. The VRS also allows authorized users to designate a person as deceased (accompanied by a verification procedure), which provides other users and the general public with timely notice of a death and the corresponding ability to view the deceased person's ebit and ebituary through the VRS and pay respects. Therefore, the VRS allows others to virtually pay their respects to the deceased and the bereaved even if they are geographically separated from the deceased or the bereaved.

For example, one embodiment of the invention provides a virtual remembrance system. The system includes at least one processor. The at least one processor is configured to receive registration information from a first user, generate a profile for the first user within a social networking environment based on the registration information, wherein the profile includes a text portion and a graphical scene, and set the graphical scene to a default scene including a default landscape. The at least one processor is further configured to receive a plurality of customizations to the default scene from the first user, wherein the plurality of customizations include a selection of a landscape for the graphical scene and a selection of one or more decorations for the graphical scene at positions selected by the first user. The at least one processor is configured to update the graphical scene based on the plurality of customizations and make the profile available within the social networking environment. The at least one processor is also configured to receive a selection of an additional decoration at a selected location within the graphical scene from a second user within the social network environment, update the graphical scene based on the additional decoration, and make the updated profile available within the social networking environment.

Another embodiment of the invention provides a system of handling profiles within a social networking environment. The system includes at least one processor. The at least one processor is configured to receive registration information from a first user, generate a profile for the first user within the social networking environment based on the registration information, generate a unique code for the profile, provide the unique code to the first user, receive the unique code from a second user within the social networking environment, update the profile to identify the second user as a manager of the profile, and automatically grant the second user rights to modify the profile after the first person dies.

Yet another embodiment of the invention provides a method of handling a death of a user within a social networking environment. The method includes receiving, at at least one processor, a report of a death of a first user associated with a profile available within the social networking environment from a second user, updating, by the at least one processor, the profile to indicate that the first user has been reported dead, and making, by the at least one processor, the updated profile available within the social networking environment. The method also includes verifying the report, wherein verifying the report includes one of (1) receiving, at the at least one processor, official documentation of the death from at least one of the second user and a third user, and (2) identifying, by the at least one processor, the death in at least one external database storing identifiers of deceased individuals. The method further includes after verifying the report, updating, by the at least one processor, the updated profile to indicate that the first user has been reported dead and that the death has been verified and making the further updated profile available within the social networking environment.

Other aspects of the invention will become apparent by consideration of the detailed description and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1a and 1b illustrate systems for accessing a virtual remembrance system (“VRS”).

FIGS. 2a-j are flow charts illustrating methods for accessing and using the VRS.

FIG. 3 is a screen shot illustrating a registration page generated by the VRS.

FIG. 4 is a screen shot illustrating a log-in page generated by the VRS.

FIG. 5 is a screen shot illustrating an administrator page generated by the VRS.

FIG. 6 is a screen shot illustrating an account settings page generated by the VRS.

FIG. 7 is a screen shot illustrating a page generated by the VRS for viewing an ebit.

FIG. 8 is a screen shot illustrating a page generated by the VRS for managing ebit settings.

FIG. 9 is a screen shot illustrating a page generated by the VRS for entering life information.

FIG. 10 is a screen shot illustrating a page generated by the VRS for entering family and friend information.

FIG. 11 is a screen shot illustrating a page generated by the VRS for entering bucket list information.

FIG. 12 is a screen shot illustrating a page generated by the VRS for entering service information.

FIG. 13 is a screen shot illustrating a page generated by the VRS for entering donation information.

FIG. 14 is a screen shot illustrating a page generated by the VRS displaying “last words” when a person is identified as being alive (i.e., the last words are hidden from view).

FIG. 15 is a screen shot illustrating a page generated by the VRS displaying “last words” when a person is identified as being deceased (i.e., the last words are unlocked and viewable).

FIG. 16 is a screen shot illustrating a manage photos page generated by the VRS.

FIG. 17 is a screen shot illustrating a page generated by the VRS displaying a caretaker card.

FIG. 18 is a screen shot illustrating a page generated by the VRS for contacting a caretaker.

FIG. 19 is a screen shot illustrating a page generated by the VRS for editing a landscape by displaying a single available landscape images at a time.

FIG. 20 is a screen shot illustrating a page generated by the VRS for editing a landscape by displaying multiple available landscape images at a time (e.g., as a gallery).

FIG. 21 is a screen shot illustrating a page generated by the VRS displaying a confirm-landscape message.

FIG. 22 is a screen shot illustrating a page generated by the VRS for selecting a headstone from among available categories of headstones.

FIG. 23 is a screen shot illustrating a page generated by the VRS for selecting a headstone from available types of headstones.

FIG. 24 is a screen shot illustrating a page generated by the VRS displaying a confirm-headstone message.

FIG. 25 is a screen shot illustrating a page generated by the VRS for selecting a friend's headstone.

FIG. 26 is a screen shot illustrating a page generated by the VRS for managing friends' headstones.

FIG. 27 is a screen shot illustrating a page generated by the VRS for selecting a decoration.

FIG. 28 is a screen shot illustrating a page generated by the VRS displaying a selected decoration.

FIG. 29 is a screen shot illustrating a page generated by the VRS displaying a confirm-decoration message.

FIG. 30 is a screen shot illustrating a page generated by the VRS displaying a placed decoration.

FIG. 31 is a screen shot illustrating a page generated by the VRS for managing decorations.

FIG. 32 is a screen shot illustrating a page generated by the VRS for sharing an ebit scene.

FIG. 33 is a screen shot illustrating a search page generated by the VRS (e.g., displaying search results for the search term “Smith”).

FIG. 34 is a screen shot illustrating a page generated by the VRS displaying an add-as-friend selection.

FIG. 35 is a screen shot illustrating a page generated by the VRS displaying a friend list.

FIG. 36 is a screen shot illustrating a page generated by the VRS for commenting on an ebit.

FIG. 37 is a screen shot illustrating a page generated by the VRS for chatting with another user.

FIG. 38 is a screen shot illustrating a page generated by the VRS displaying notifications.

FIG. 39 is a screen shot illustrating a page generated by the VRS displaying an add-as-caretaker selection and a remove-as-friend selection.

FIG. 40 is a screen shot illustrating a page generated by the VRS for becoming a caretaker.

FIG. 41 is a screen shot illustrating a page generated by the VRS for redeeming a caretaker code.

FIGS. 42 and 43 are screen shots illustrating pages generated by the VRS displaying an unverified reported death.

FIG. 44 is a screen shot illustrating a page generated by the VRS for verifying a reported death.

FIG. 45 is a screen shot illustrating a page generated by the VRS displaying a verified death.

FIG. 46 is a screen shot illustrating a page generated by the VRS for reporting abuse.

FIG. 47 is a screen shot illustrating a page generated by the VRS for managing tributes.

FIG. 48 is a screen shot illustrating a page generated by the VRS for adding a tribute to an ebit.

FIG. 49 is a screen shot illustrating a page generated by the VRS for selecting a tribute.

FIG. 50 is a screen shot illustrating a page generated by the VRS for selecting a tribute from available categories of tributes.

FIG. 51 is a screen shot illustrating a page generated by the VRS displaying a selected tribute.

FIG. 52 is a screen shot illustrating a page generated by the VRS displaying a confirm-tribute message.

FIG. 53 is a screen shot illustrating a page generated by the VRS displaying a placed tribute.

FIG. 54 is a screen shot illustrating a page generated by the VRS displaying all placed tributes.

FIG. 55 is a screen shot illustrating a page generated by the VRS hiding all placed tributes.

FIGS. 56-58 are screen shots illustrating pages generated by the VRS for making payments.

### DETAILED DESCRIPTION

Before any embodiments of the invention are explained in detail, it is to be understood that the specific configurations illustrated in the drawings are intended to exemplify embodiments of the invention and that other alternative configurations are possible. Therefore, the invention is not limited in its application to the details of construction and the arrangement of components set forth in the following description or illustrated in the following drawings but is capable of other embodiments and of being practiced or of being carried out in various ways.

Also, it is to be understood that the phraseology and terminology used herein is for the purpose of description and should not be regarded as limited. The use of “including,” “comprising” or “having” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Also, electronic communications and notifications may be performed using any known means including direct connections, wireless connections, etc.

In should also be understood that the invention is implemented using various computing devices, such as computers (e.g., desktop computers, laptop computers, tablet computers, etc.), servers, and other devices that have processors or that are capable of executing programs or sets of instructions (e.g., smart televisions and smart cellular phones and similar devices), including special-purpose devices. In general, the invention may be implemented using existing hardware or hardware that could be readily created by those of ordinary skill in the art. Thus, the architecture of exemplary devices will not be explained in detail, except to note that the devices will generally have one or more processors, one or more non-transitory memory modules (e.g., RAM or ROM), and one or more input and output interfaces. In some cases, the devices may also have operating systems and application programs that are managed by the operating systems. Each computing device has the ability to communicate with another computing device over one or more networks. In reality, one or more networks or communication systems, such as the Internet, the telephone system, wireless networks, satellite networks, cable TV networks, and various other private and public networks, can be used in various combinations to provide the communication links desired or needed to create embodiments or implementations of the invention, as would be apparent to one of ordinary skill in the art. Thus, the invention is not limited to any specific network or combinations of networks.

As noted above, embodiments of the invention provides a virtual remembrance system (“VRS”) that provides a virtual place of remembrance and reflection upon a life once lived that users can access at anytime from anywhere in the world for special occasions or whenever someone feels the need to reflect upon another's life (e.g., as people do currently with the conventional bereavement process). In particular, the VRS provides a system for creating and sharing a profile accessible within a social networking environment. The profile can include an obituary and other related textual and non-textual information (collectively referred to herein as an “ebituary”). The profile can also include a graphical scene, such as a virtual scene of remembrance. The overall profile including the ebituary and the graphical scene is collectively referred to in the present application as an “ebit.” Therefore, the ebit contains personal, bibliographical, and graphical information. Users of the VRS can create an ebit for themselves or someone else, including pets and other animals. As used in the present application, the “person” associated with an ebit can include the user creating and managing the ebit, another person (alive or dead), or an animal (alive or dead).

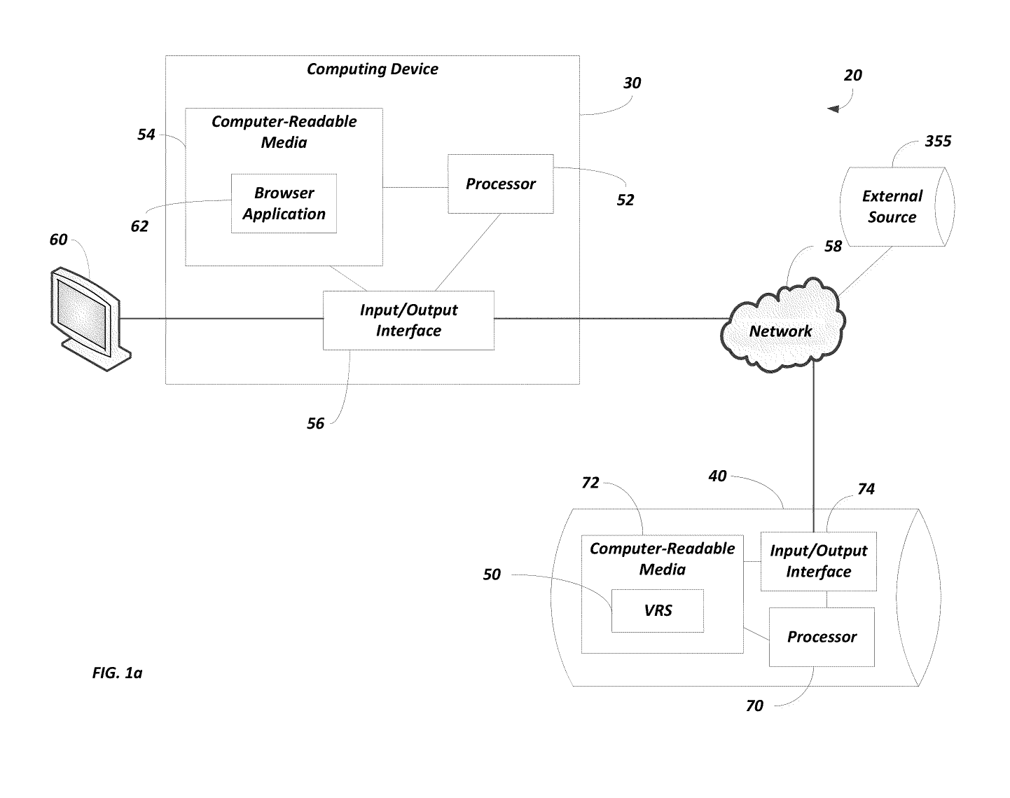

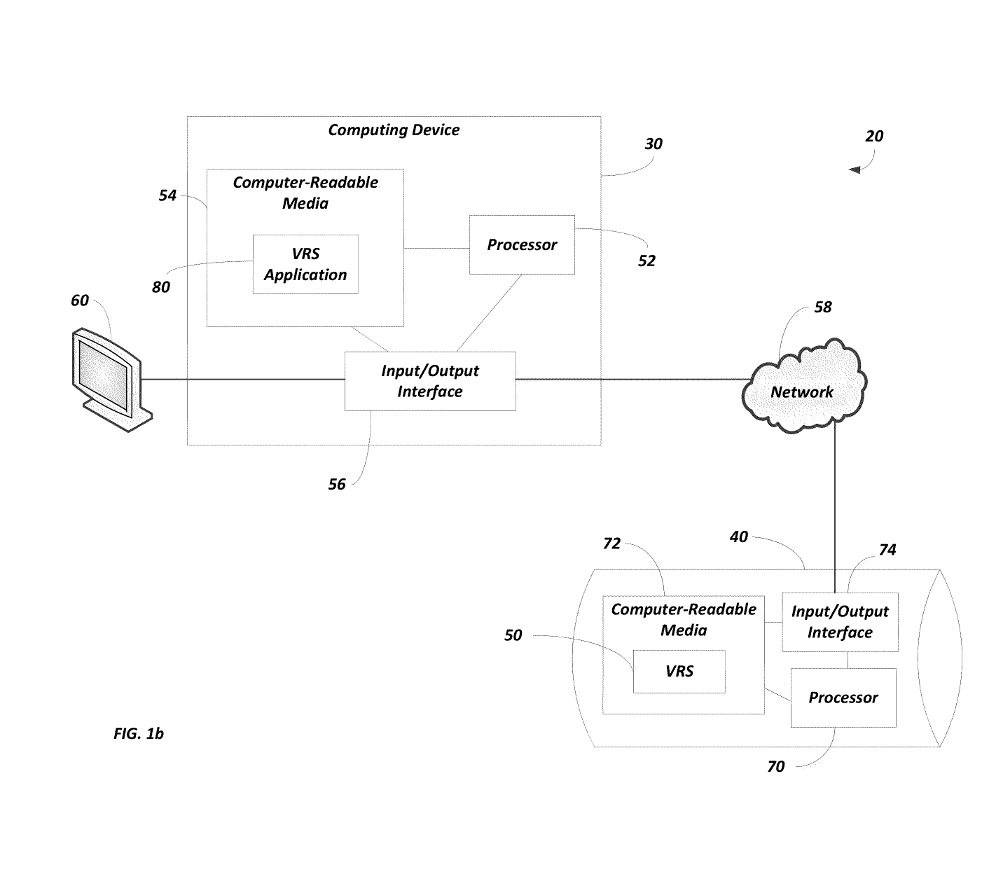

In some embodiments, users access the VRS as an online service available over the Internet. For example, FIG. 1a illustrates a system 20 for accessing the VRS as an online service. As illustrated in FIG. 1a, a user operates a computing device 30, such as a computer (e.g., desktop, laptop, or tablet computer), a television with access to the Internet, or a mobile device such as a cellular device, to access a server 40 hosting the VRS 50. The computing device 30 includes a processor 52, non-transitory computer-readable media 54, and an input/output interface 56. The computer-readable media 54 can include random access memory (“RAM”) and/or read-only memory (“ROM”). The input/output interface 56 exchanges information with the server 40 over a network 58. The network 58 can include a wired connection, a wireless connection, or a combination thereof. The network 58 can include a local area network, wide area network, the Internet, the cellular network, or combinations thereof. As illustrated in FIG. 1a, the input/output interface 56 can also transmit data to a monitor 60. The monitor 60 can be included in the computing device 30 (e.g., a display on a mobile device or a tablet or laptop computer) or connected to the device 30 over a wired connection, a wireless connection, or a combination thereof. In some embodiments, the monitor 60 includes a touchscreen. It should be understood that the computing device 30 can include additional devices, such as peripheral devices (e.g., a keyboard, mouse, joystick, printer, multiple screens, projector, etc.) directly included in the device 30 or connected to the device 30 over a wired connection, a wireless connection, or a combination thereof. In addition, it should be understood that although only a single processor, input/output interface, and computer-readable media module are illustrated in FIG. 1a, the computing device 30 can include multiple processing units, memory modules, and/or input/output interfaces.

The processor 52 receives information (e.g., from the media 54 and/or the input/output interface 56) and processes the information by executing one or more instructions or modules. The instructions or modules are stored in the computer-readable media 54. In particular, as illustrated in FIG. 1a, a browser application 62, such as Microsoft Internet Explorer®, Google Chrome®, or Moxilla Firefox®, is stored in the media 54. The browser application 62 allows the computing device 30 to access data (e.g., web pages) stored on and provided by other computing devices, such as the server 40. In some embodiments, in addition to or as an alternative to the browser application 62, the computer-readable media 54 stores a specially-programmed application for the VRS 50, such as a mobile application. The mobile application can be configured to provide functionality similar to the VRS 50 (e.g., provide similar pages and functionality) and can use data from the VRS 50 to populate pages provided to a user. Accordingly, it should be understood that the functionality of the VRS 50 described below can be distributed between the VRS 50 and the mobile application (if a mobile application is used) in various configurations.

As illustrated in FIG. 1a, the server 40 can include similar components as the computing device 30. In particular, the server 40 includes a processor 70, non-transitory computer-readable media 72, and an input/output interface 74. The computer-readable media 72 can include random access memory (“RAM”) and/or read-only memory (“ROM”). The input/output interface 74 exchanges information with the computing device 30 over the network 58.

The processor 70 receives information (e.g., from the media 72 and/or the input/output interface 74) and processes the information by executing one or more instructions or modules. The instructions or modules are stored in the computer-readable media 72. In particular, as illustrated in FIG. 1a, the computer-readable media 72 stores the VRS 50. The VRS 50 includes instructions that, when executed by the processor 70, generate screens or pages that allow a user to view and create or otherwise interact with an ebit. It should be understood that the VRS 50 can be distributed across multiple media modules or across multiple servers. Also, it should be understood that multiple computing devices 30 can access the VRS 50 through the server 40.

The computer-readable media 72 and/or additional media modules included in the server 40 or additional servers 40 can also store one or more databases associated with the VRS 50. The database(s) stores data relating to users registered with the VRS 50 and ebits created by users or created automatically by the VRS 50 as described below. For example, the VRS 50 can create and manage data records stored in a database, wherein each data record is associated with a registered user and at least one ebit created by the registered user. Each record can be uniquely identified, and the VRS 50 can be configured to initially create and modify the record based on the registered user's interaction with the VRS 50, other registered user's or guest's interaction with the user's ebit, and other automatic administrative functions.

In other embodiments, as illustrated in FIG. 1b, rather than or in combination with using the browser application 62, the computing device 30 can store and execute a VRS application 80. The VRS application 80 can be configured to provide all or a portion of the functionality of the VRS 50 stored on the server 40 described below based on data stored locally on the computing device 30 and/or data accessible from another computing device, such as the server 40, over the network 58. For example, the VRS application 80 can be configured to generate pages similar to the pages generated by the VRS 50 but can pull data used to populate the pages from another computing device (e.g., the VRS 50 executed by the server 40). In general, the functionality of the VRS 50 described below can be distributed between the VRS 50 and the VRS application 80 in various configurations. Therefore, it should be understood that the methods of accessing and using the VRS 50 described below can be used to access and use the VRS 50 through the VRS application 80 or through the browser application 62.

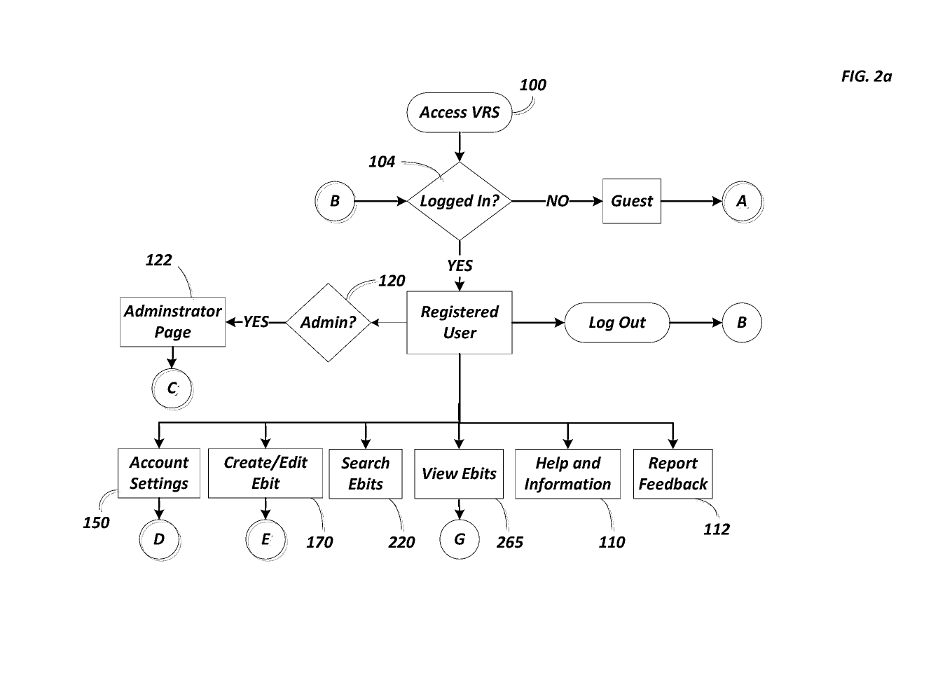

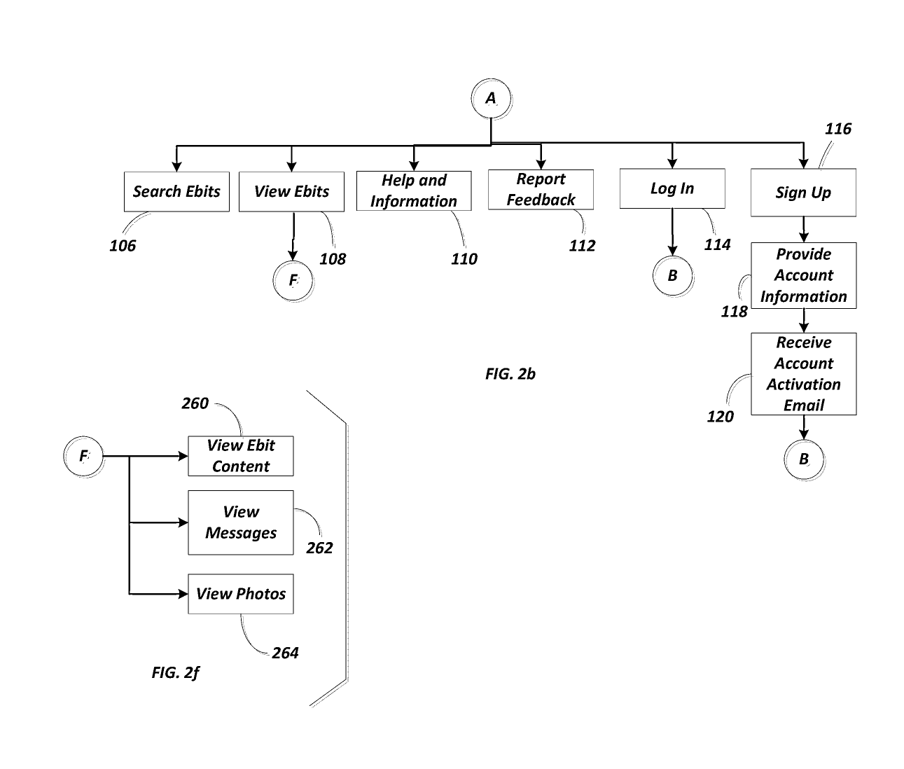

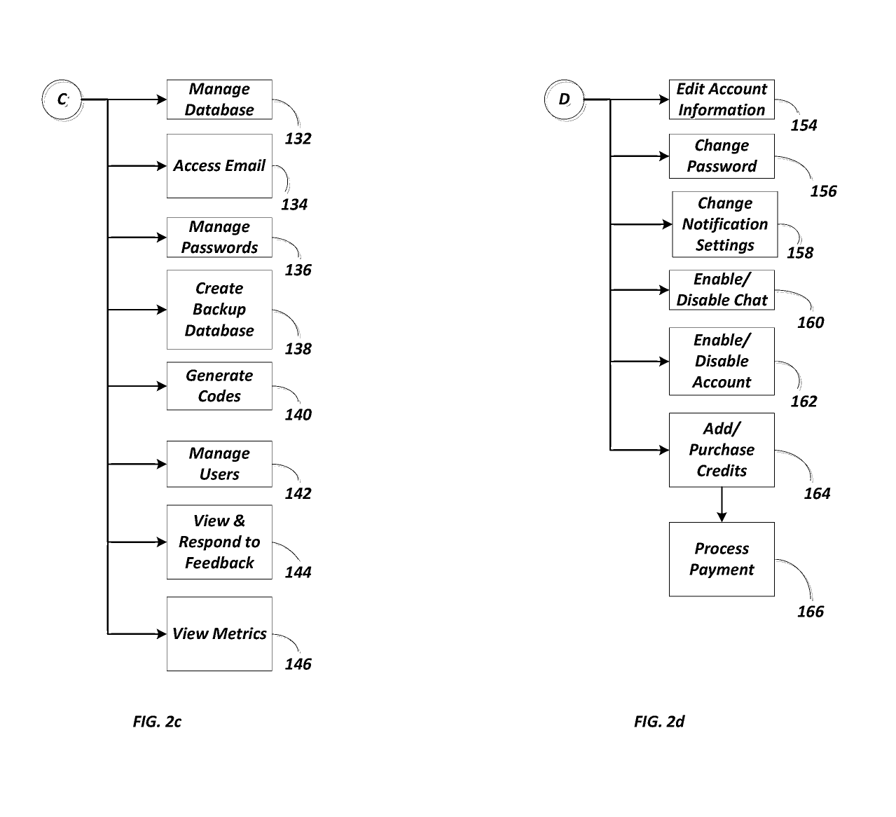

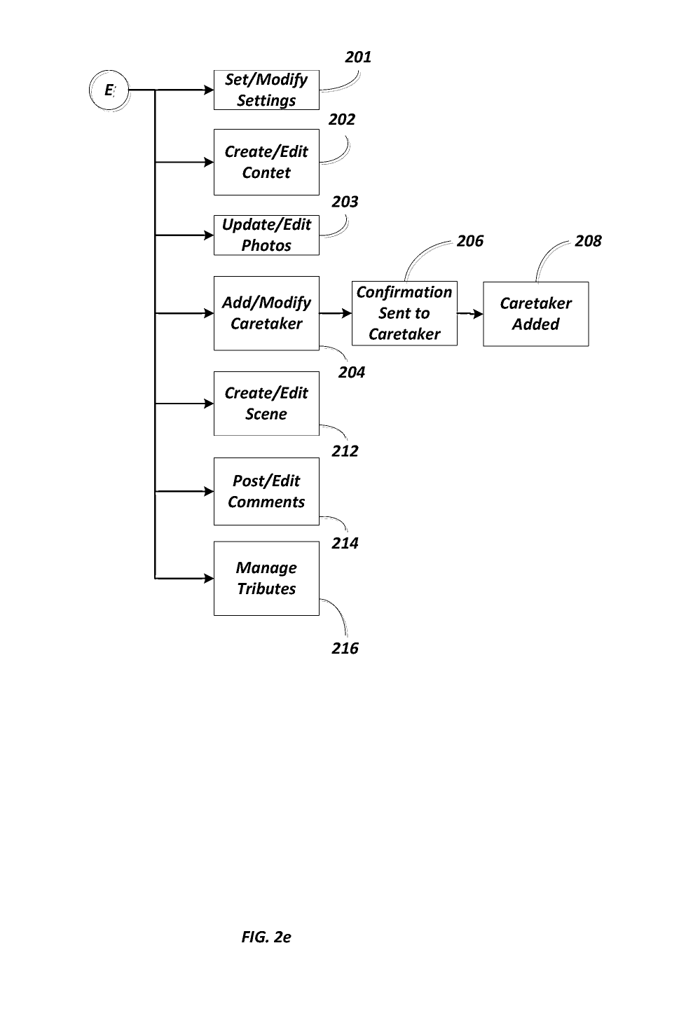

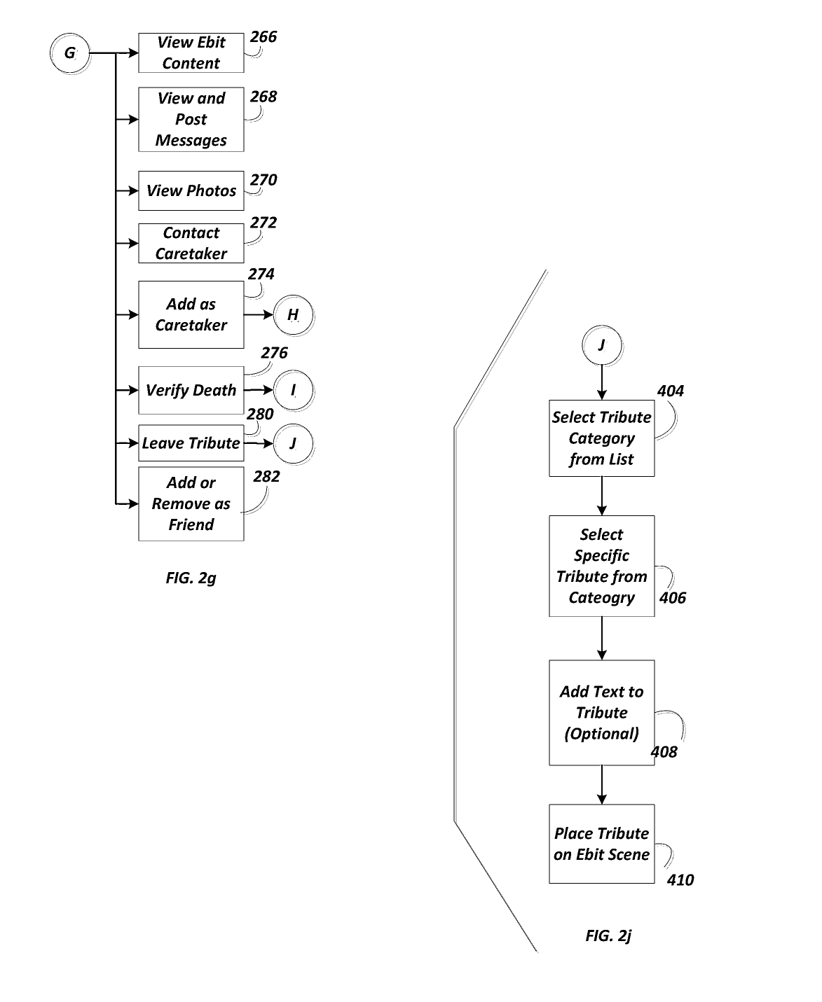

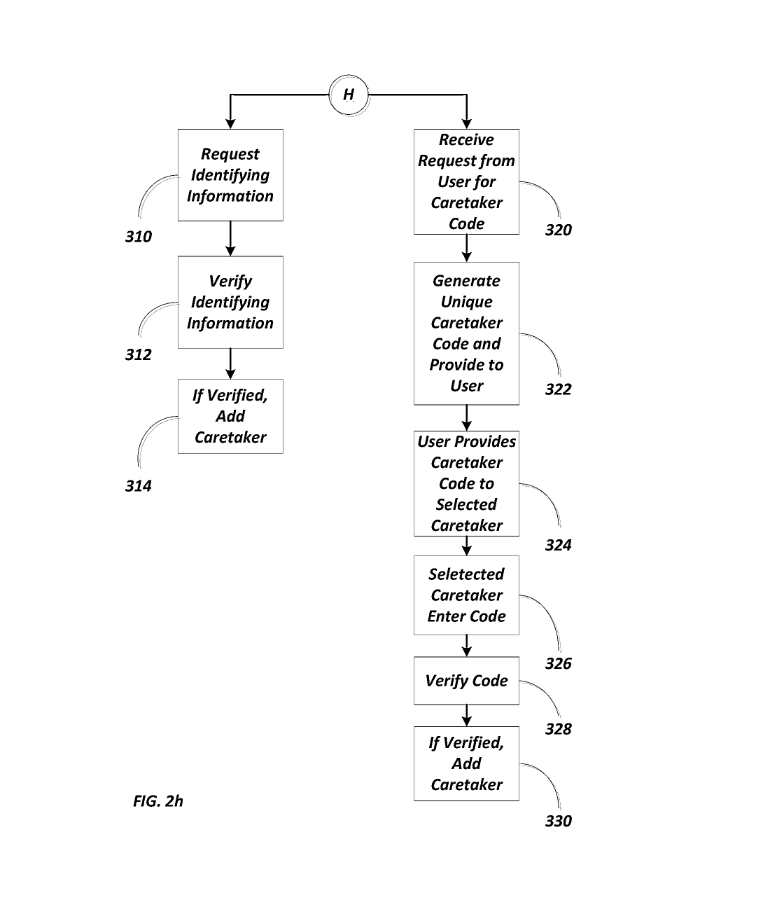

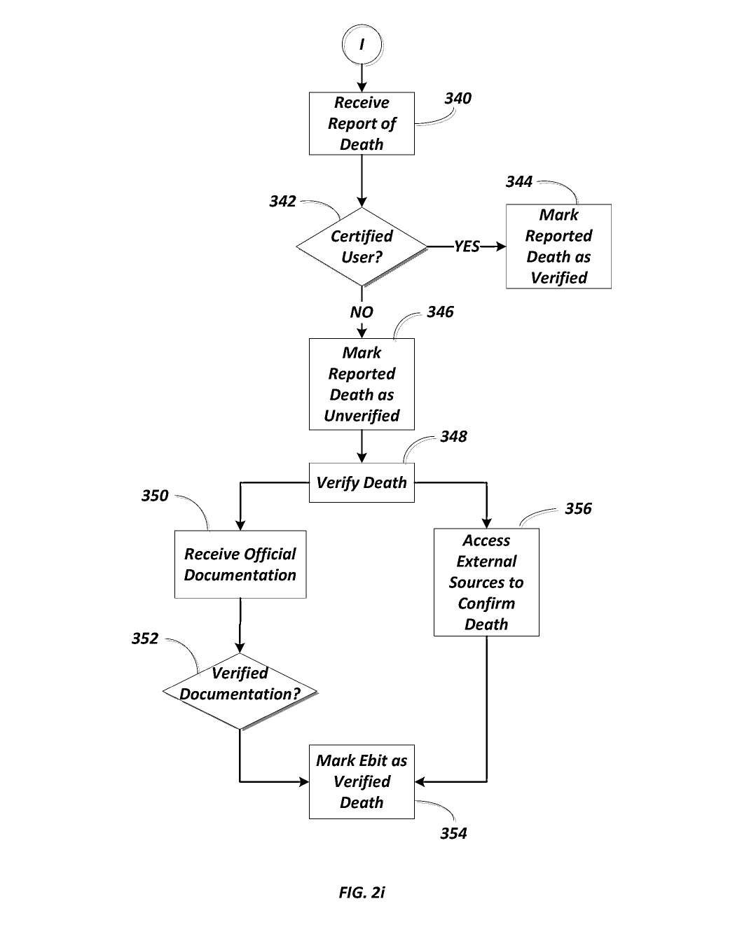

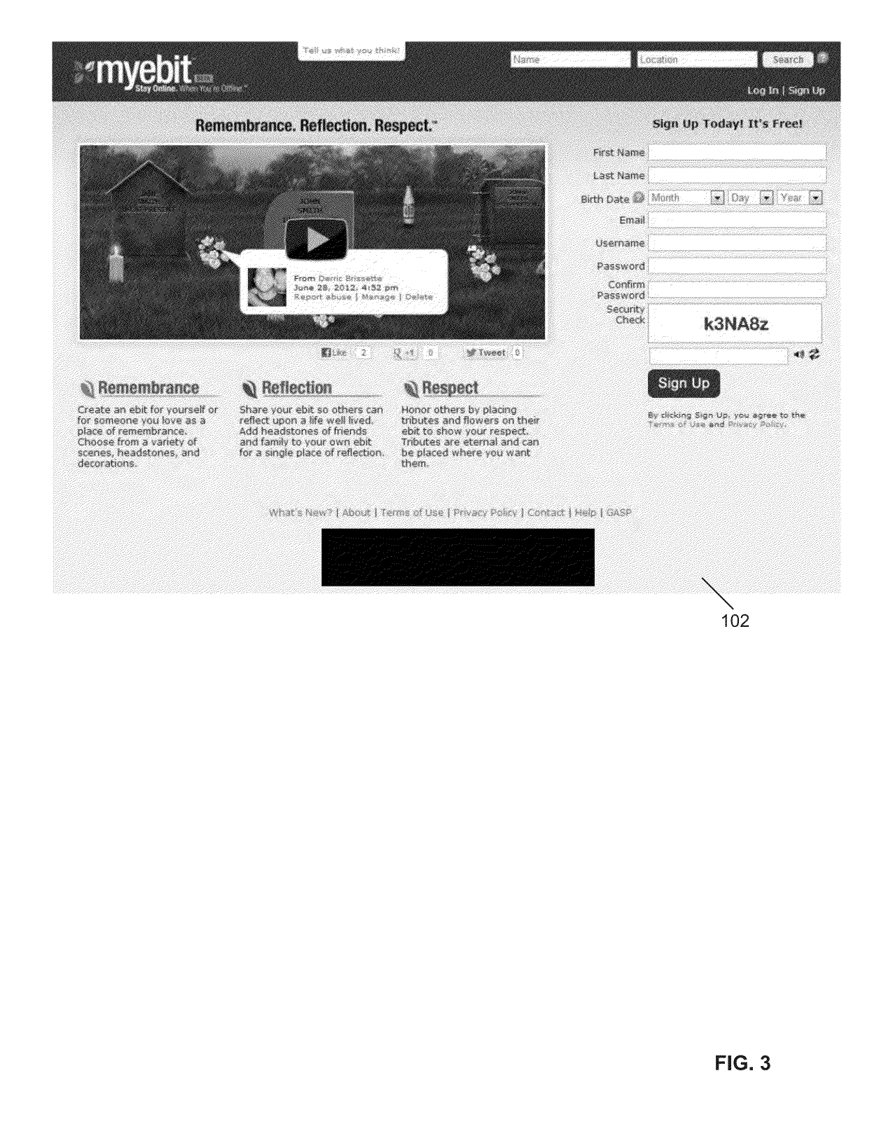

FIG. 2a illustrates a method performed by the system 20 for accessing and using the VRS 50. As illustrated in FIG. 2a, a user can use the computing device 30 to connect to or access the VRS 50 (at 100). Initially, the user can be routed to a registration or home page 102 of the VRS 50, as illustrated in FIG. 3. Once at the page 102, a user has the option of logging-in as a registered user or using the VRS 50 as a guest (at 104). As illustrated in FIG. 2b, guests can use the VRS 50 to search for ebits (at 106) and view ebits (at 108). In some embodiments, however, the VRS 50 may limit or deny a guest's ability to view and/or interact with the ebits of one or more particular registered users (e.g., depending on access settings associated with each ebit). As illustrated in FIG. 2b, a guest can also use the VRS 50 to get help and other information regarding the VRS 50 (at 110) and provide feedback regarding the VRS 50 (at 112). The help and other information regarding the VRS 50 can include a tutorial for using the VRS 50, updates regarding the VRS 50, general information about the VRS 50, terms of use, a privacy policy, help sources, and user agreements, such as a graphic artist share project (“GASP”) agreement. If a guest has previously registered with the VRS 50, the guest can also log-in to VRS 50 (at 114).

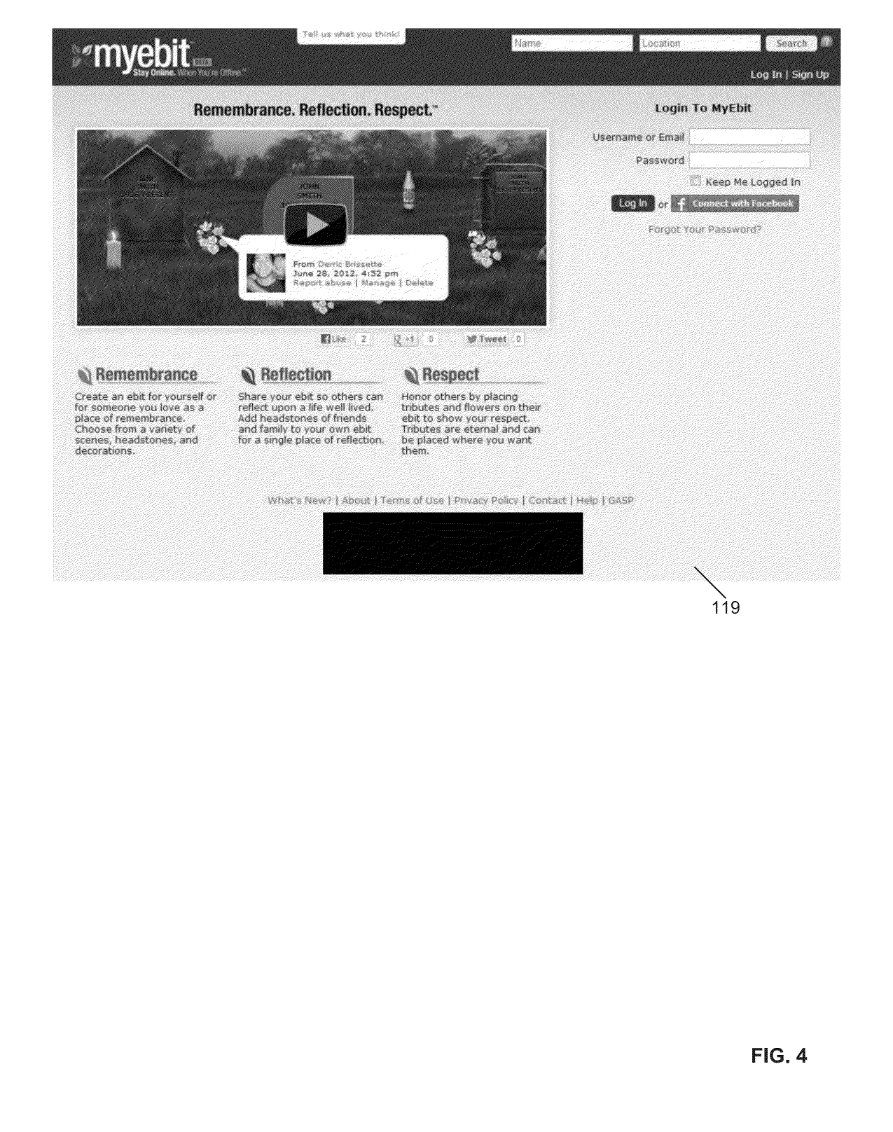

A guest can also sign-up or register with the VRS 50 (at 116). To register, the VRS 50 prompts the user for registration or account information (at 118). As illustrated in FIG. 3, the account information can include user information (e.g., first name, last name, date of birth, etc.) and log-in information, such as a unique username and password. In some embodiments, after providing the account information, the VRS 50 sends the user an account activation email (at 120) that the user can use to complete their registration. Once registered with the VRS 50, a registered user can log into the VRS 50 as illustrated in the log-in page 119 illustrated in FIG. 4.

Upon initially registering with the VRS 50, the VRS 50 creates a profile for the user. As described below, the profile can include a text portion and a graphical scene. In some embodiments, the VRS 50 initially sets the graphical scene to a default scene. The default scene can include a default background. The default scene can also include at least one default decoration. For example, in some embodiments, the at least one default decoration includes a headstone. The headstone can be initially hidden in the graphical scene, but the user can unhide the headstone as part of customizing the scene or defining settings for the profile.

Returning to FIG. 2a, if a registered user logs in to the VRS 50 as an administrator (at 120), the VRS 50 provides an administrator page (at 122). FIG. 5 illustrates an administrator page 130 according to one embodiment of the invention. As illustrated in FIGS. 2c and 5, the administrator page 130 allows administrators to manage the functionality of the VRS 50, such as managing the databases associated with the VRS (at 132), accessing email sent to an administrator account of the VRS 50 (at 134), managing passwords (at 136), creating backups of the databases (at 138), generating codes (e.g., caretaker codes, credit codes, etc.) (at 140), managing users (e.g., grant or revoke user access) (at 142), and viewing and responding to user feedback (e.g., reports of abuse, user agreements, user verifications, etc.) (at 144). The VRS 50 administrator page 130 also provides administrators with metrics or other statistical information regarding the VRS 50 (at 146). As illustrated in FIG. 5, the metrics can include a total number of registered users and/or guests, a total number of purchased items, etc. Similarly, the VRS 50 can be configured to provide death statistics based on data managed by the VRS 50, such as a number of deaths over a past period of time, an average age at time of death, etc.

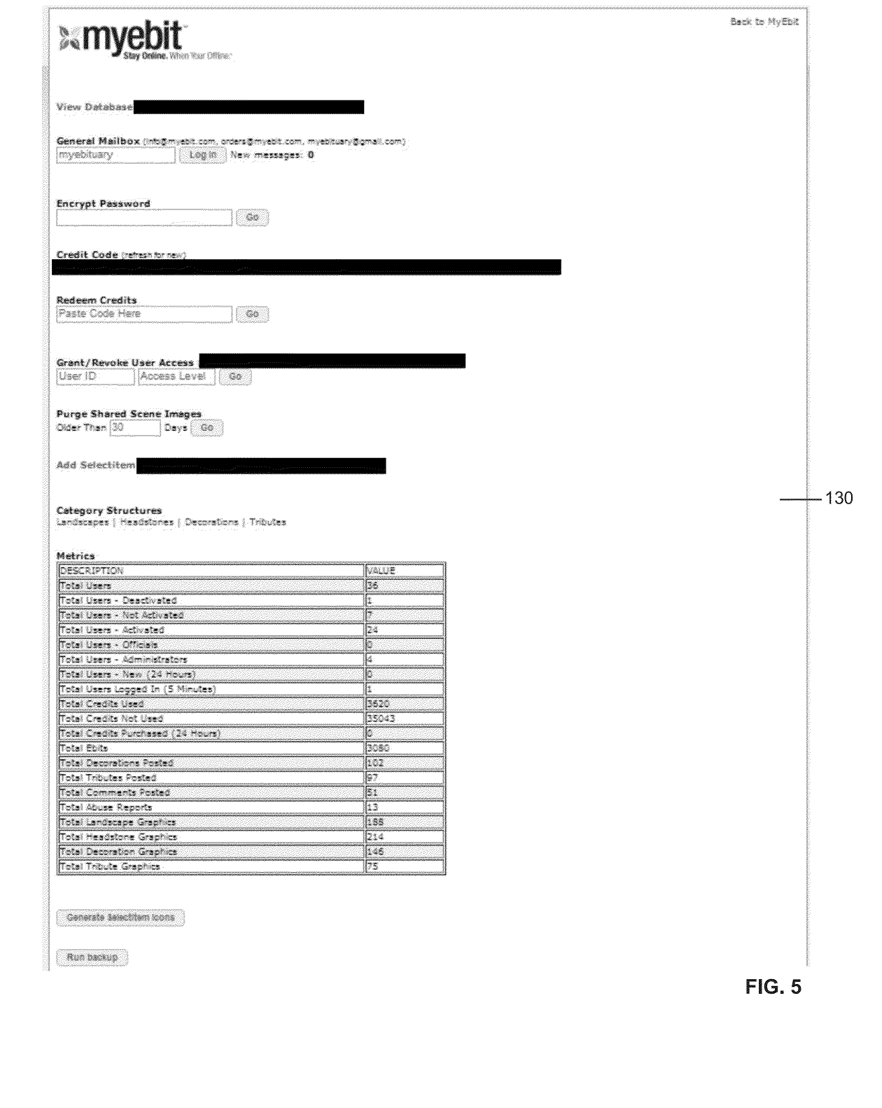

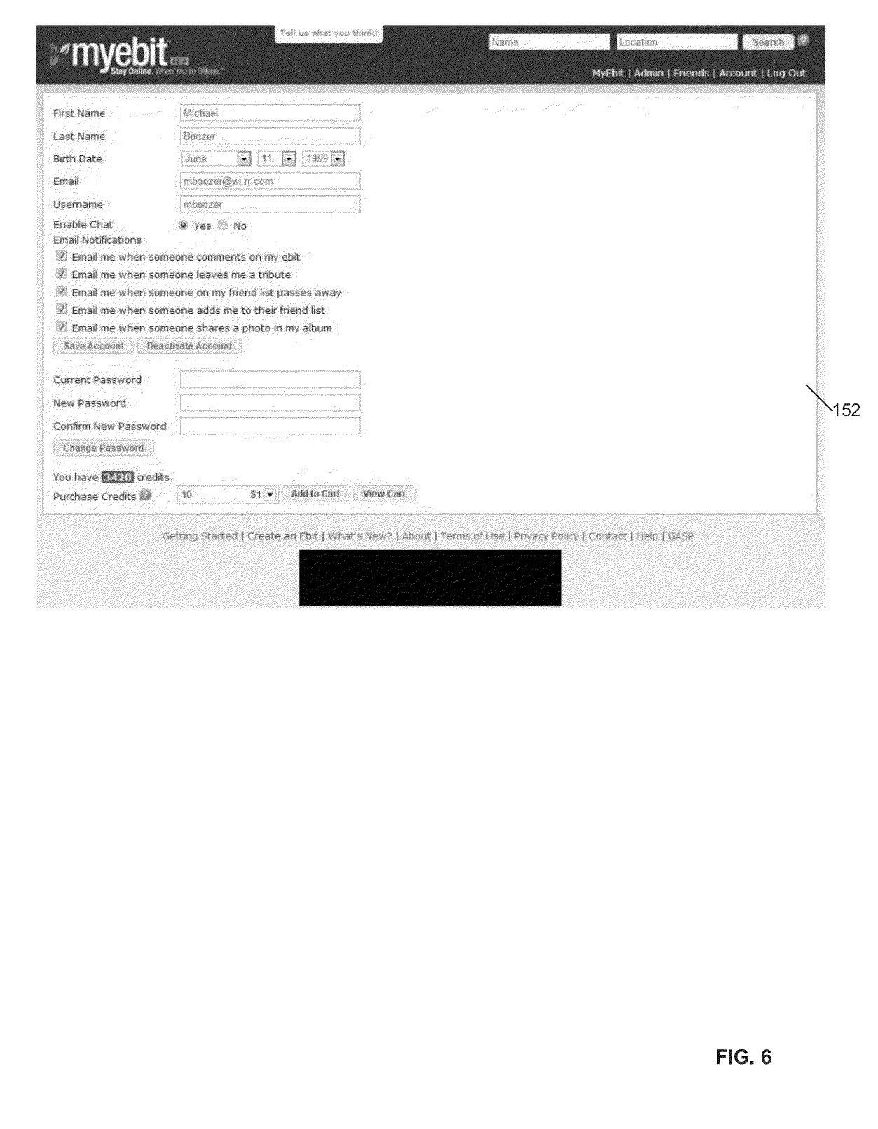

If a registered user is not an administrator, the VRS 50 allows the registered user to set and modify account settings (at 150). For example, FIG. 6 illustrates an account settings page 152 generated by the VRS 50. As illustrated in FIG. 6, the account settings page 152 allows a registered user to manage the settings associated with their account with the VRS 50. As illustrated in FIG. 2d, a registered user can use the account settings page 152 to edit account information (at 154), change a username or password (at 156), change notification settings (at 158), enable or disable particular features, such as a chat feature (at 160), enable or disable the entire account (at 162), and view and manage an account (at 164). As described below in more detail, a user can add credits to their account and can use the credits to purchase items or features within the VRS 50. As illustrated in FIG. 2d, if the registered user desires to add credits to their account, the VRS 50 or a separate payment processing system can process a payment for the credits (at 166).

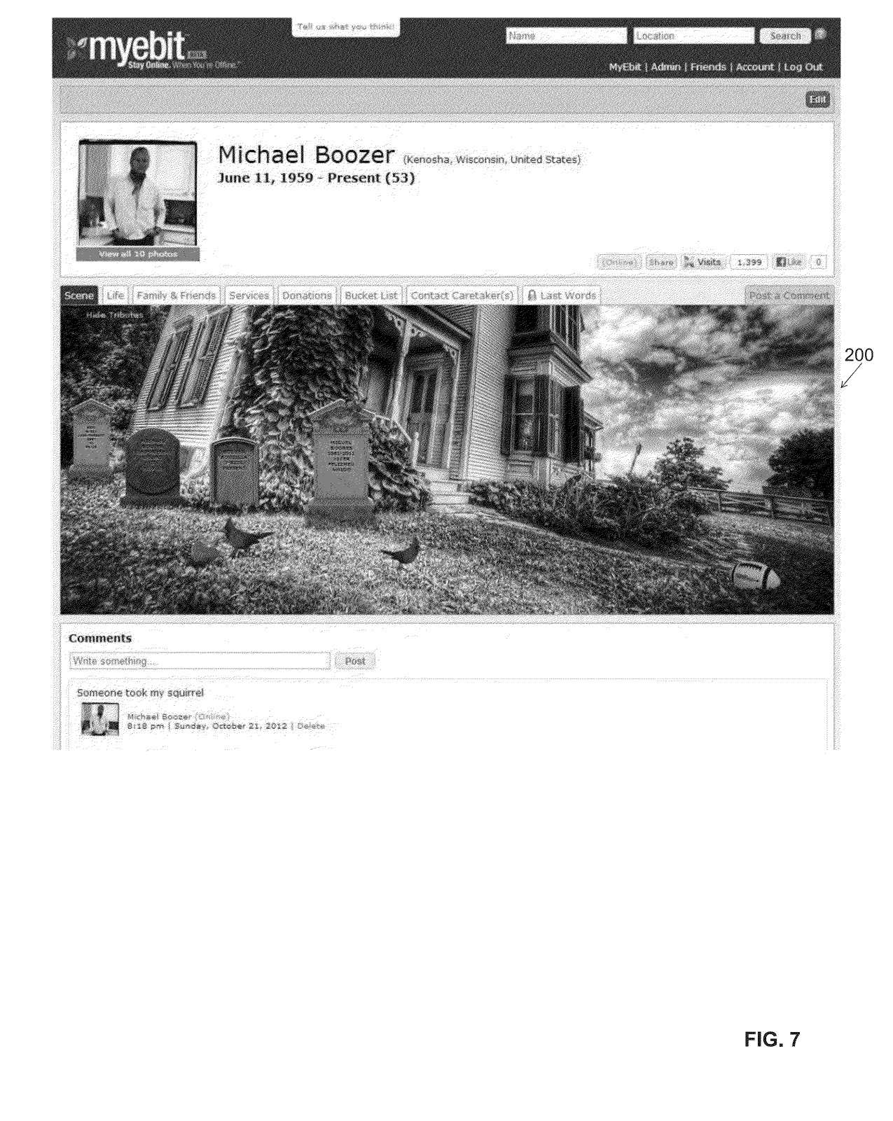

A registered user can also create and thereafter edit an ebit for a person within a social networking environment (at 170). FIG. 7 illustrates a portion of an ebit 200 accordingly to one embodiment of the invention, and FIG. 2e illustrates how a registered user can create and edit an ebit 200. As noted above, the ebit 200 includes textual and non-textual (e.g., graphical elements) associated with a person designated by the user that serves as a place of remembrance, respect, and reflection for the person both while the person is alive and after the person dies.

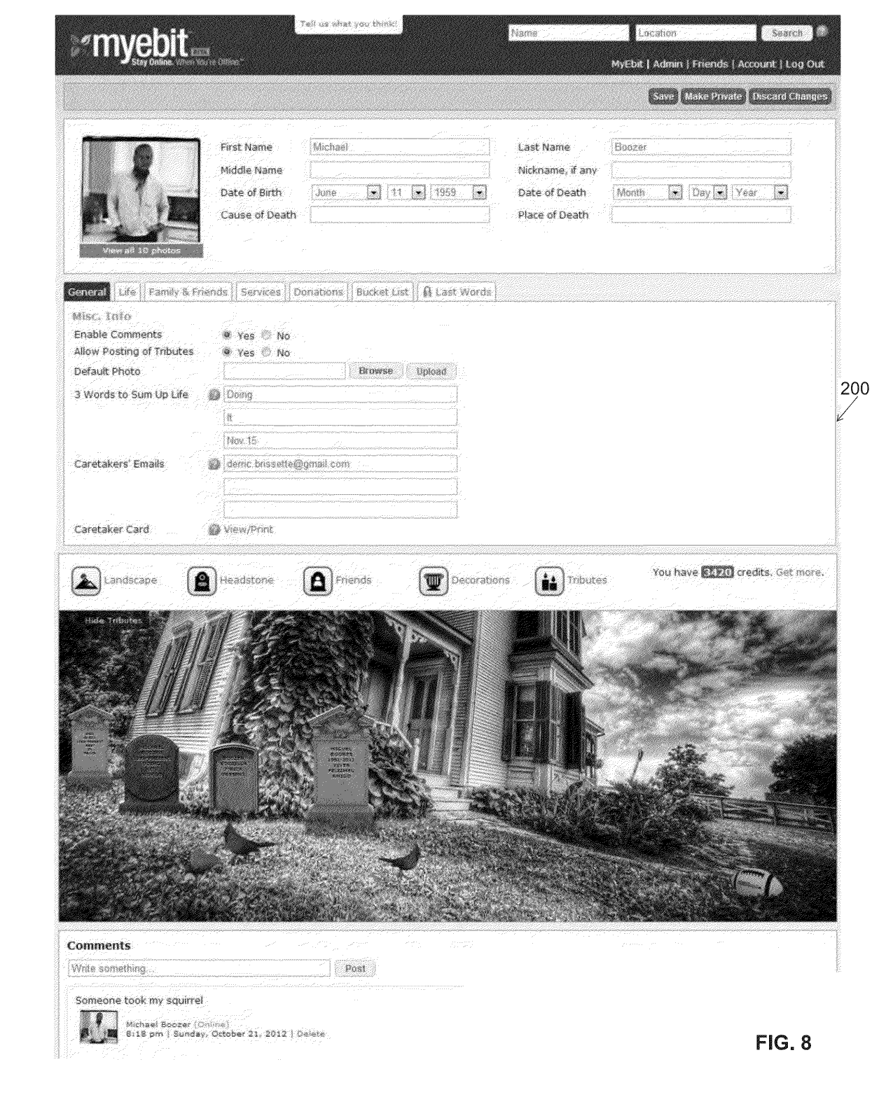

As illustrated in FIG. 2e, to create or edit an ebit 200, the user can set or modify settings for the ebit 200 (at 201), such as whether other users can place comments or tributes (described below) on the ebit 200 (see, e.g., FIG. 8). In some embodiments, as noted above, the settings also include whether the default headstone generated by the VRS 50 should be hidden or unhidden.

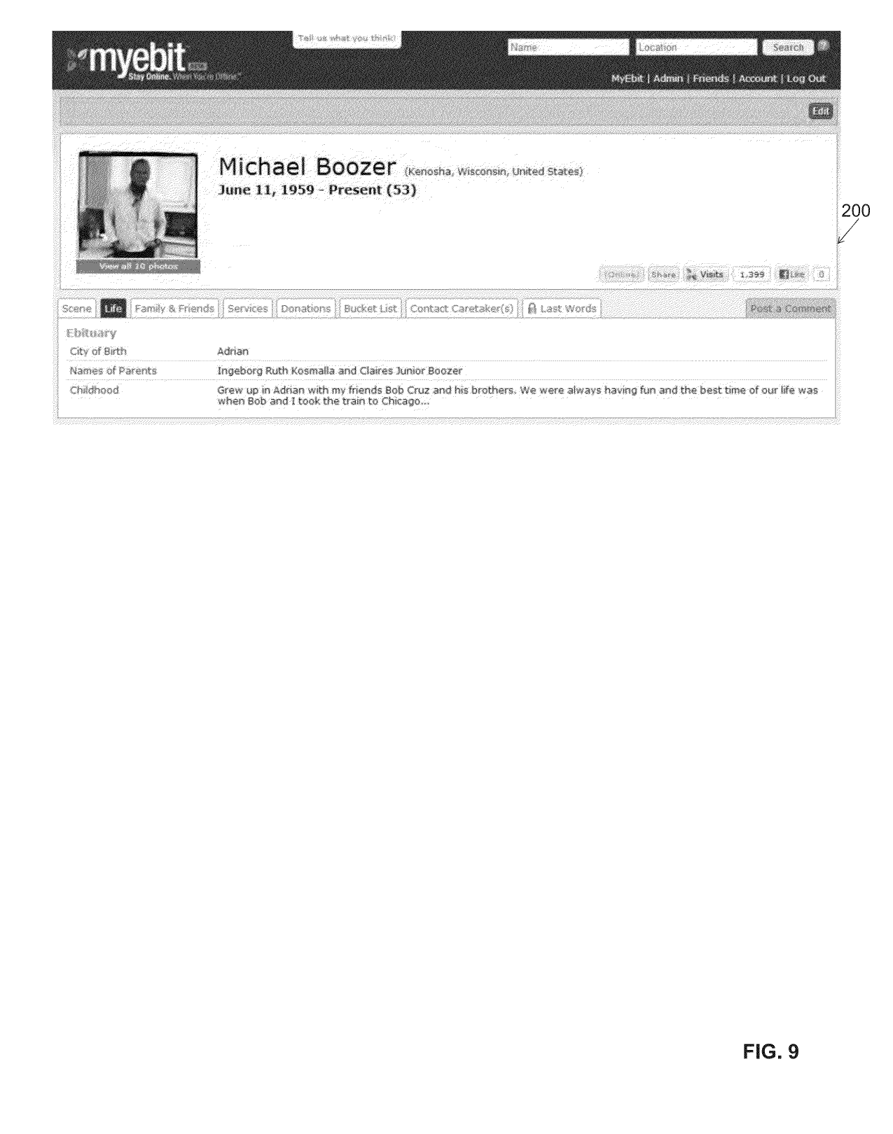

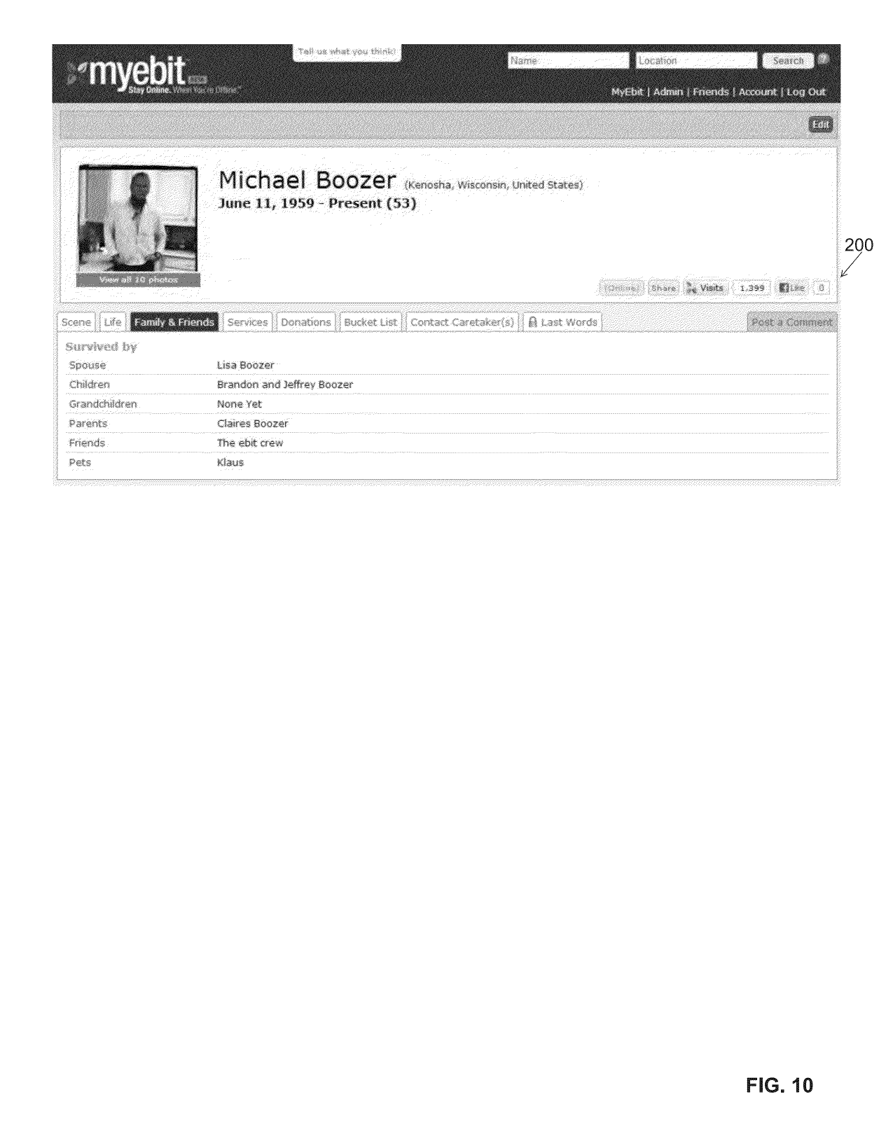

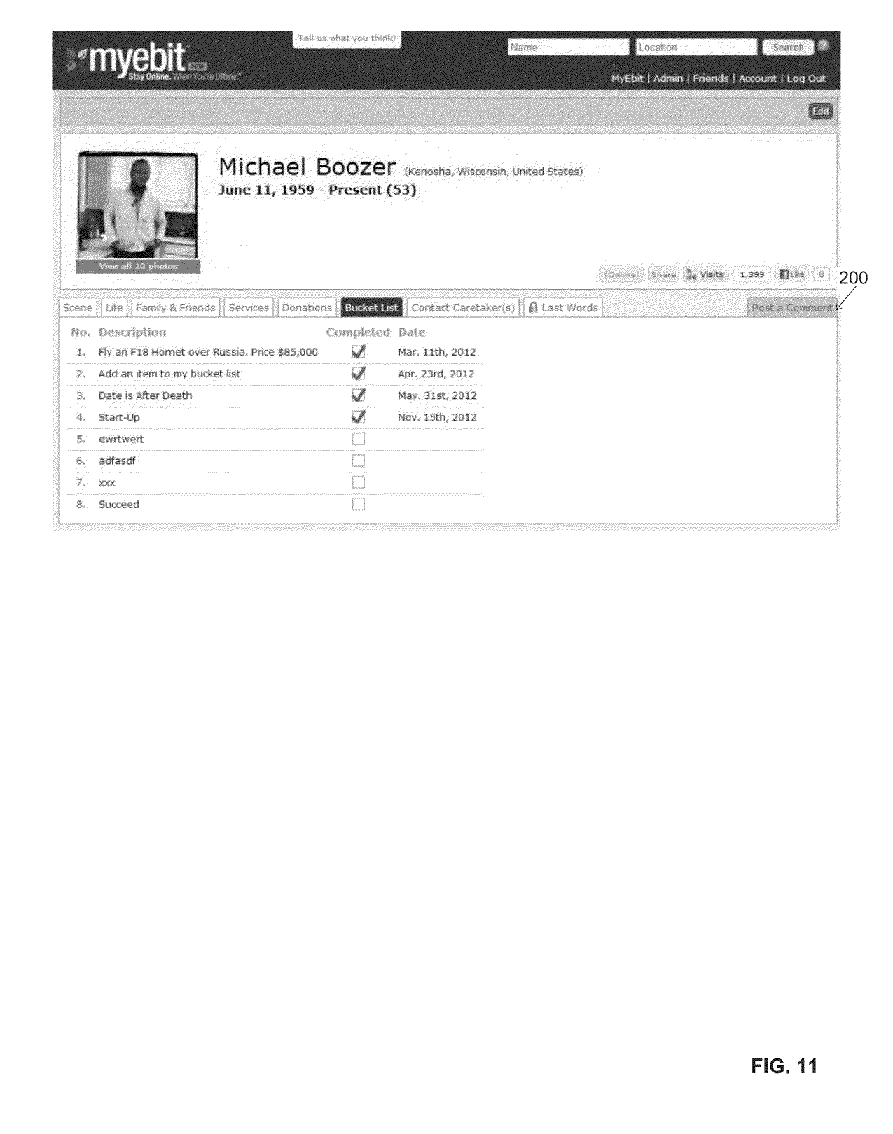

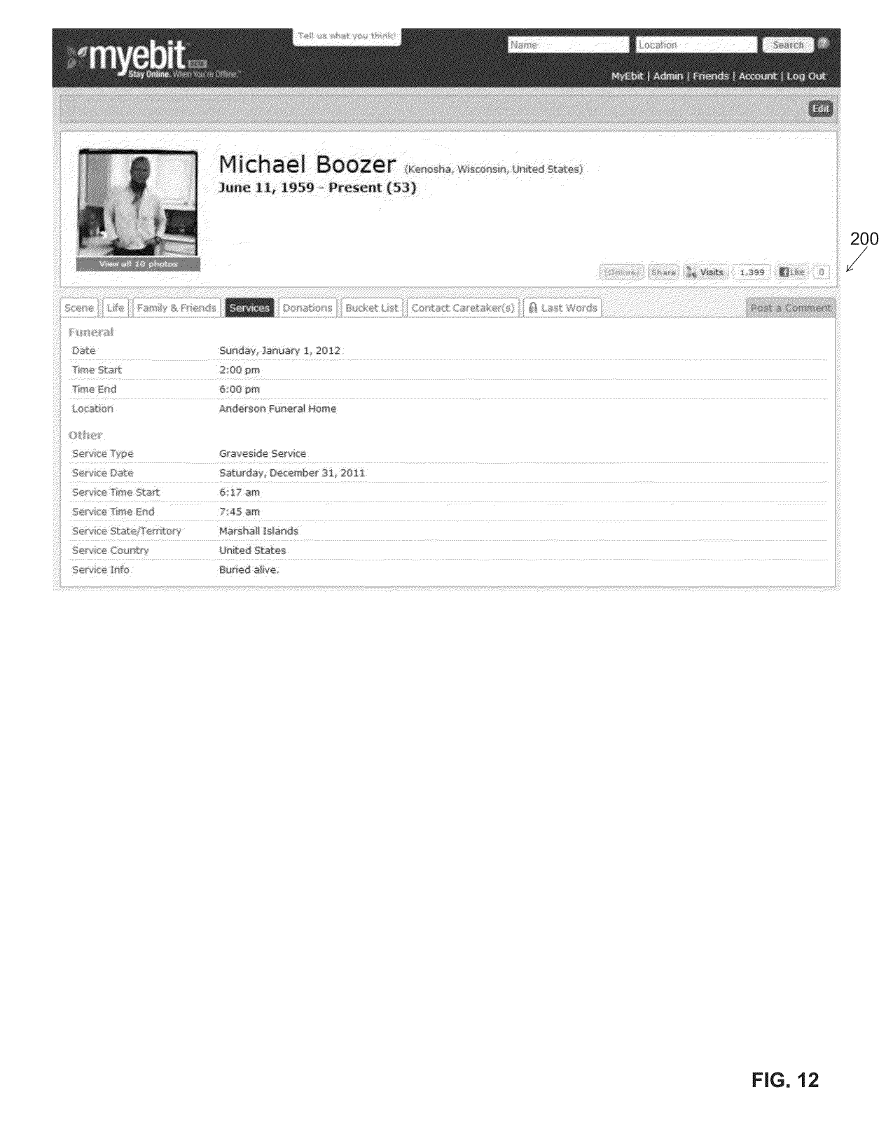

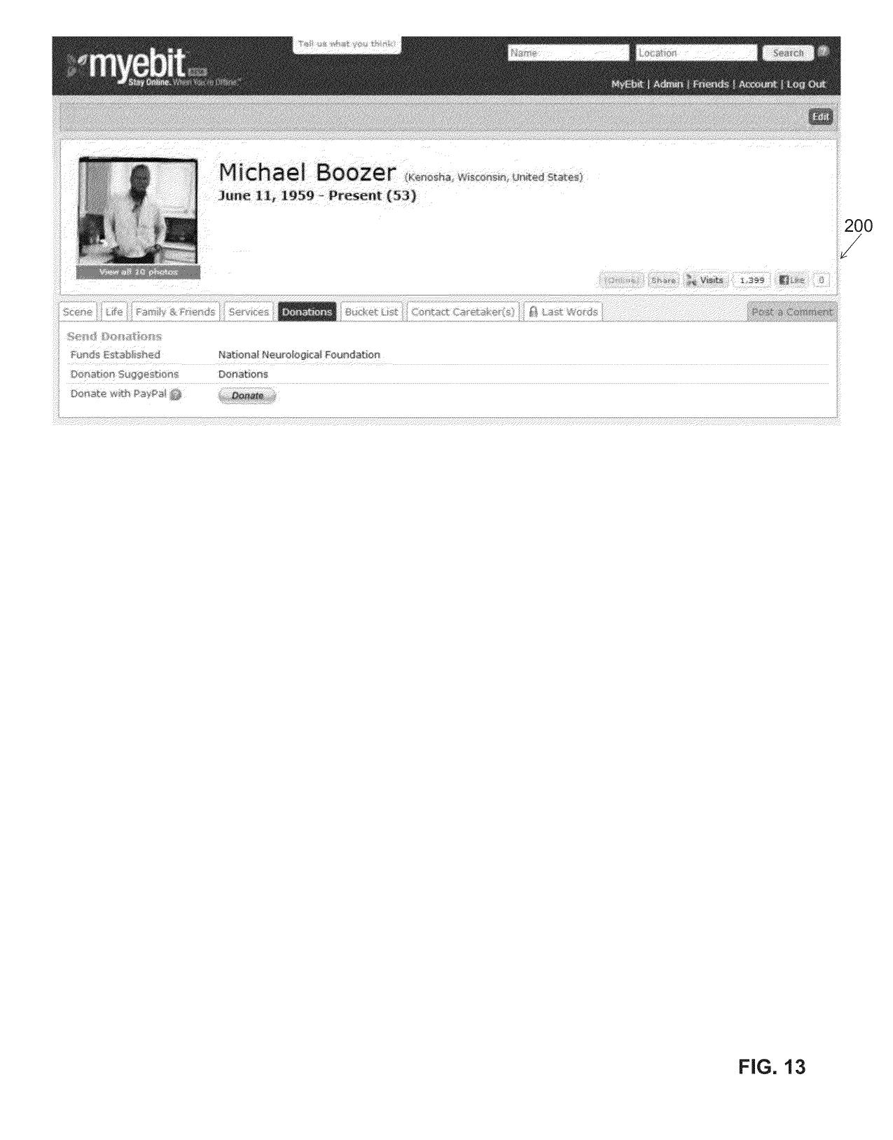

The user can also provide textual and non-textual content or information for the ebit 200 (at 202). As noted above, the content can be referred to as an “ebituary.” The ebituary can include general information about the person, such as a photo and descriptions of the person (see, e.g., FIG. 8). The ebituary can also include information about the person's life (including biography information, family and friend information (e.g., survived by and predeceased by), and a bucket list) (see, e.g., FIGS. 9-11). As illustrated in FIG. 12, the ebituary can also include information about death-related services for the person (e.g., funeral services, visitations, receptions, masses, candle-light vigils, etc.). In some embodiments, the ebituary also includes a map and/or a mapping function that provides maps for locations specified for the death services (e.g., maps to cemeteries, funeral homes, etc.). The ebituary can also include information regarding what type of donations can be made in honor of the deceased (e.g., a list of charities) (see, e.g., FIG. 13).

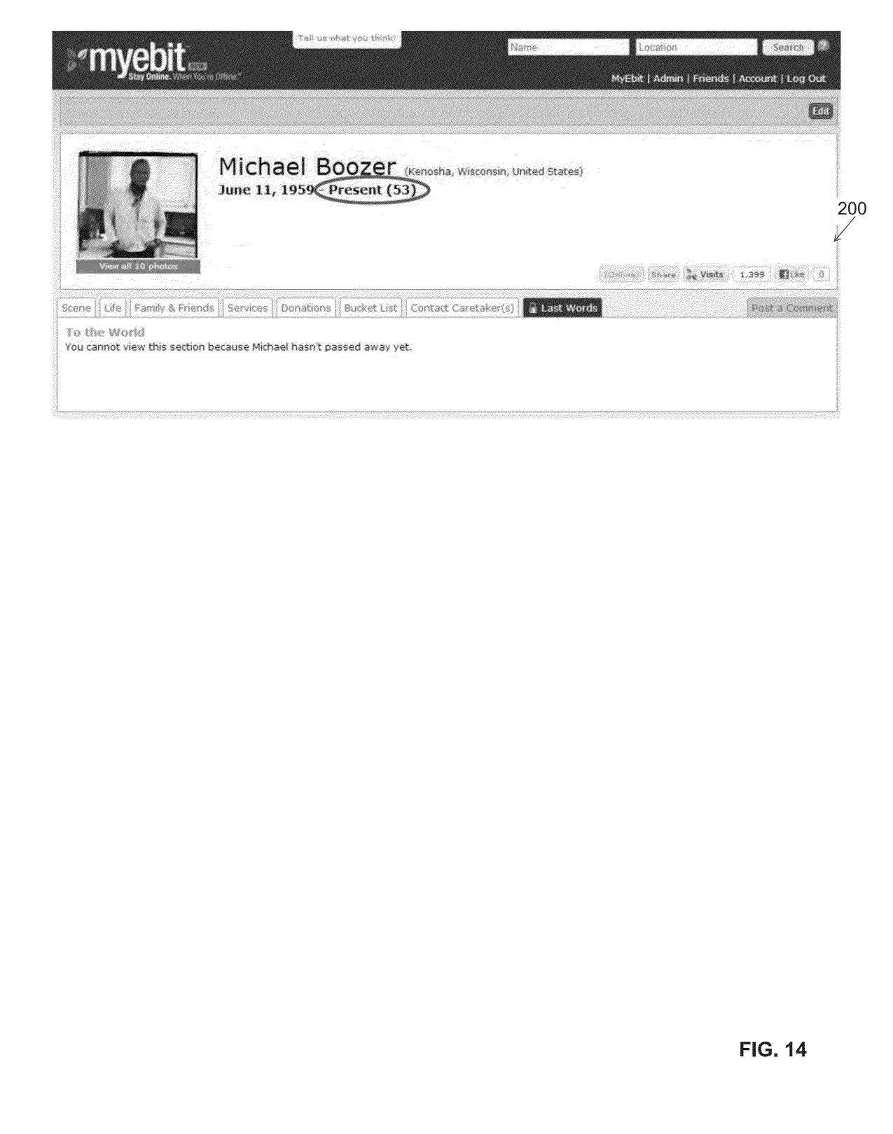

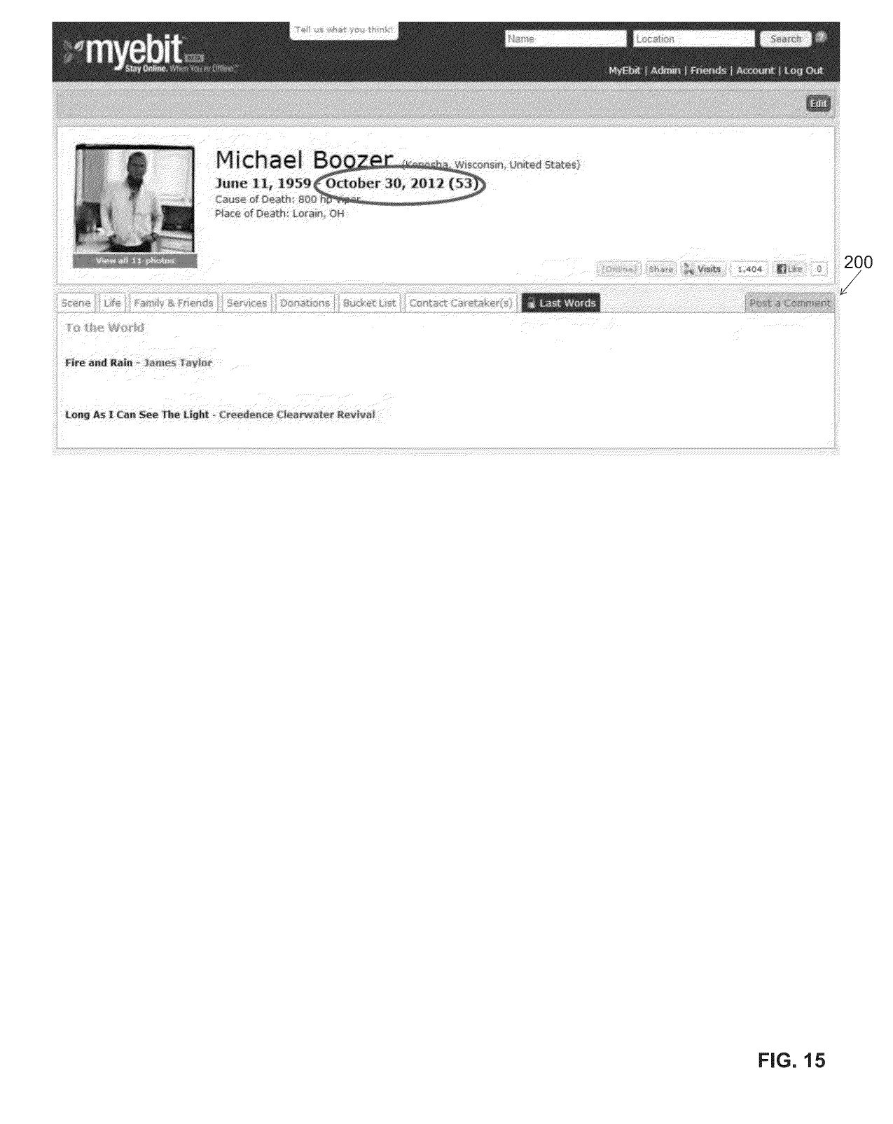

In some embodiments, the ebituary also includes a person's “last words.” For example, as illustrated in FIG. 14, in some embodiments, the VRS 50 locks and hides the person's “last words” until the person dies. When the person dies, the VRS 50 unlocks the person's “last words” and makes them available for view by other users and guests of the VRS 50 as illustrated in FIG. 15. Similarly, the VRS can be configured to allow users to write and save afterlife messages. In particular, the VRS 50 allows a user to create messages, and the VRS 50 automatically sends the messages to designated recipients (e.g., all “friends” in the VRS 50, particular email addresses or postal addresses, etc.) when the person dies. In some embodiments, the VRS 50 also automatically creates a notification after a person dies and sends the notification to any caretakers or “friends” (described below) (e.g., to the caretaker's or “friend's” ebit 200 and/or email address).

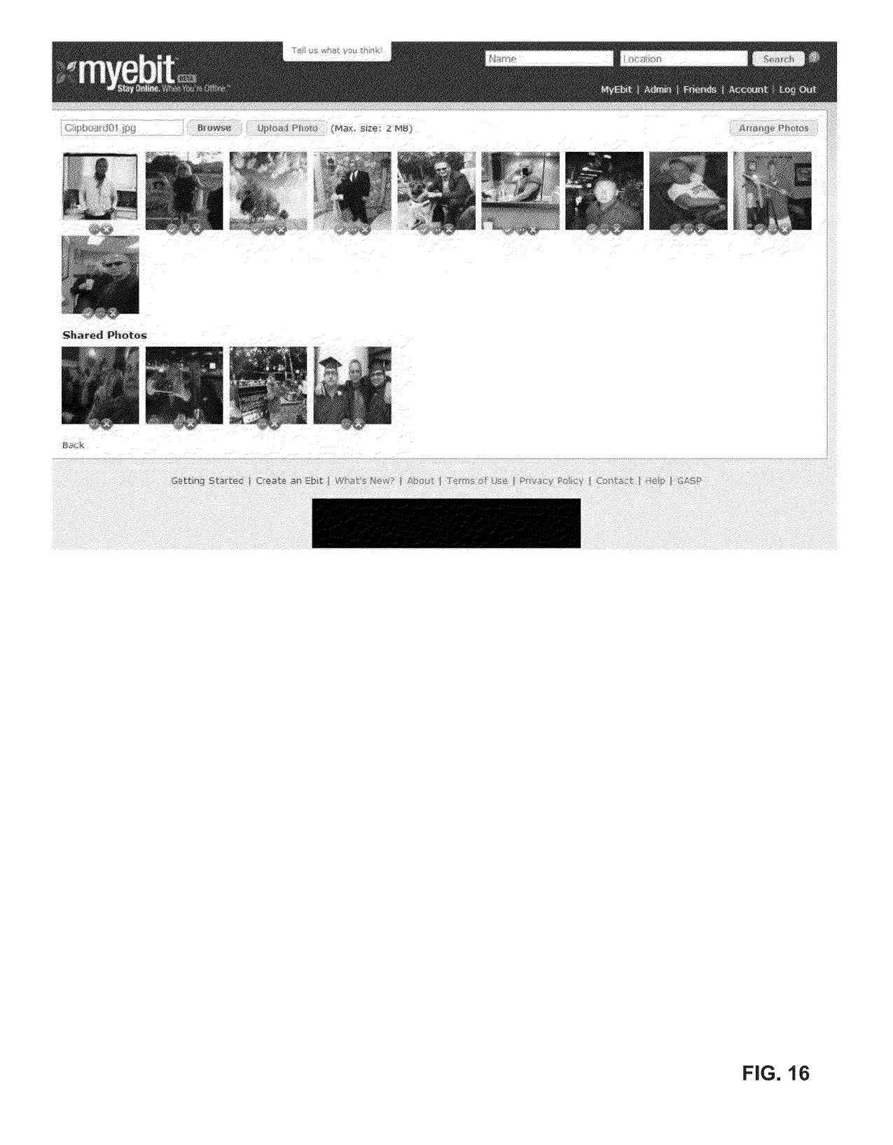

The VRS 50 can also be configured to allow users to input or upload non-textual information into an ebit 200 (at 203), such as images, videos, music files, recordings, etc. (see, e.g., FIG. 16). The user can upload, delete, and arrange photos (e.g., sequentially or in albums), tag other people or things in the photos, add or modify captions to photos, and set a photo as a default photo associated with the ebit 200.

Returning to FIG. 2e, a registered user can also specify manager information associated with the ebit 200 (at 204). The manager information identifies a person who shares management of the user's ebit 200 and, in particular, takes over management of the user's ebit 200 after the person dies (e.g., referred to herein as a “caretaker”). In particular, as illustrated in FIG. 8, a user can specify one or more caretakers for the ebit 200 (e.g., by a name and/or an email). As illustrated in FIG. 2e, when a user adds a caretaker to the ebit 200, the VRS 50 is configured to automatically create and send a confirmation message (e.g., email) to the designated caretaker (at 206). The message can inform the individual of their designation as a caretaker and can instruct the individual on how to use the VRS 50 to access the ebit 200. In some embodiments, the VRS 50 requires that the individual selected as the caretaker confirm the designation before the individual is as added as a caretaker to the ebit 200. After the individual is notified of the designation, and, optionally confirms the designation, the VRS 50 adds the individual to the ebit 200 (at 208).

In some embodiments, a caretaker is granted the same rights to access and modify an ebit 200 as the user who initially creates the ebit 200. These rights can be granted at any time (automatically by the VRS 50 or manually by the user) after the caretaker is designated, and, in some embodiments, may be granted automatically by the VRS 50 after the person associated with the ebit 200 dies. In particular, the caretaker can access the ebit 200 after the person's death to verify the person's death, provide information regarding funeral services and other death-related information, and generally manage the ebit 200.

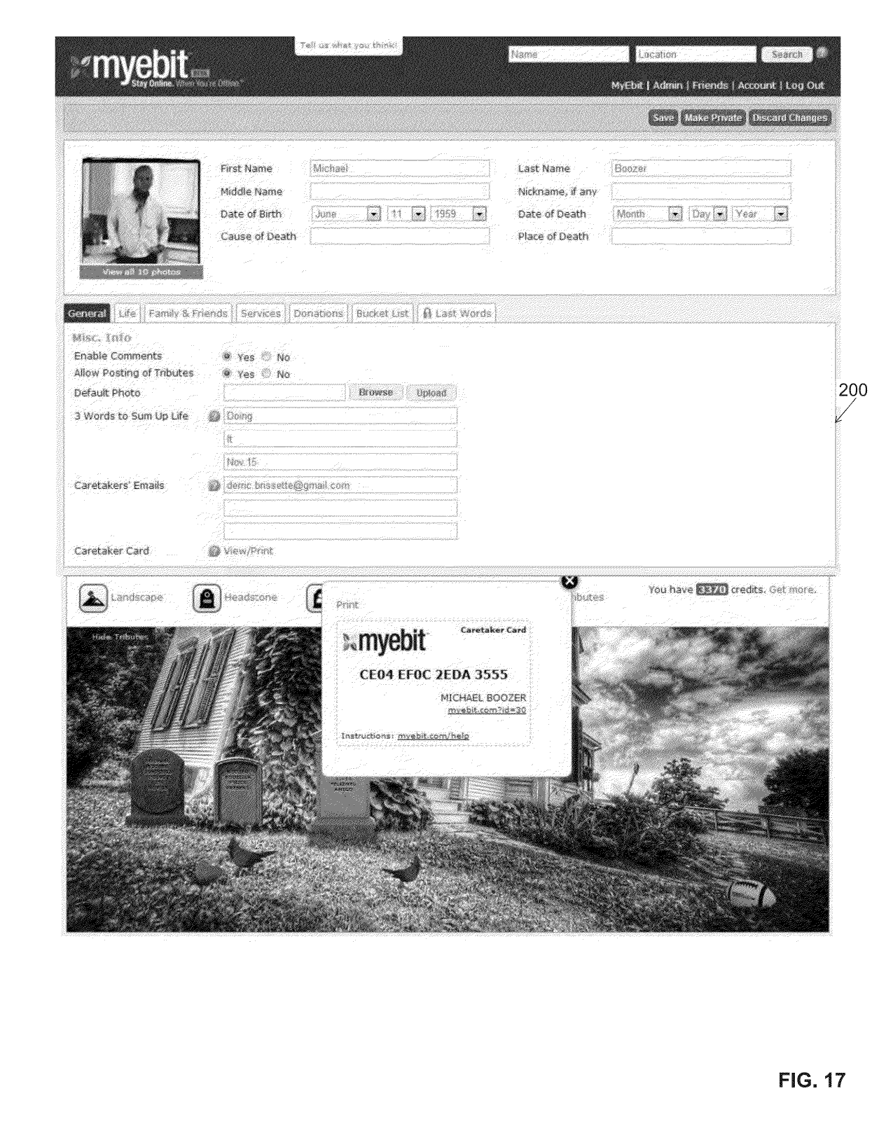

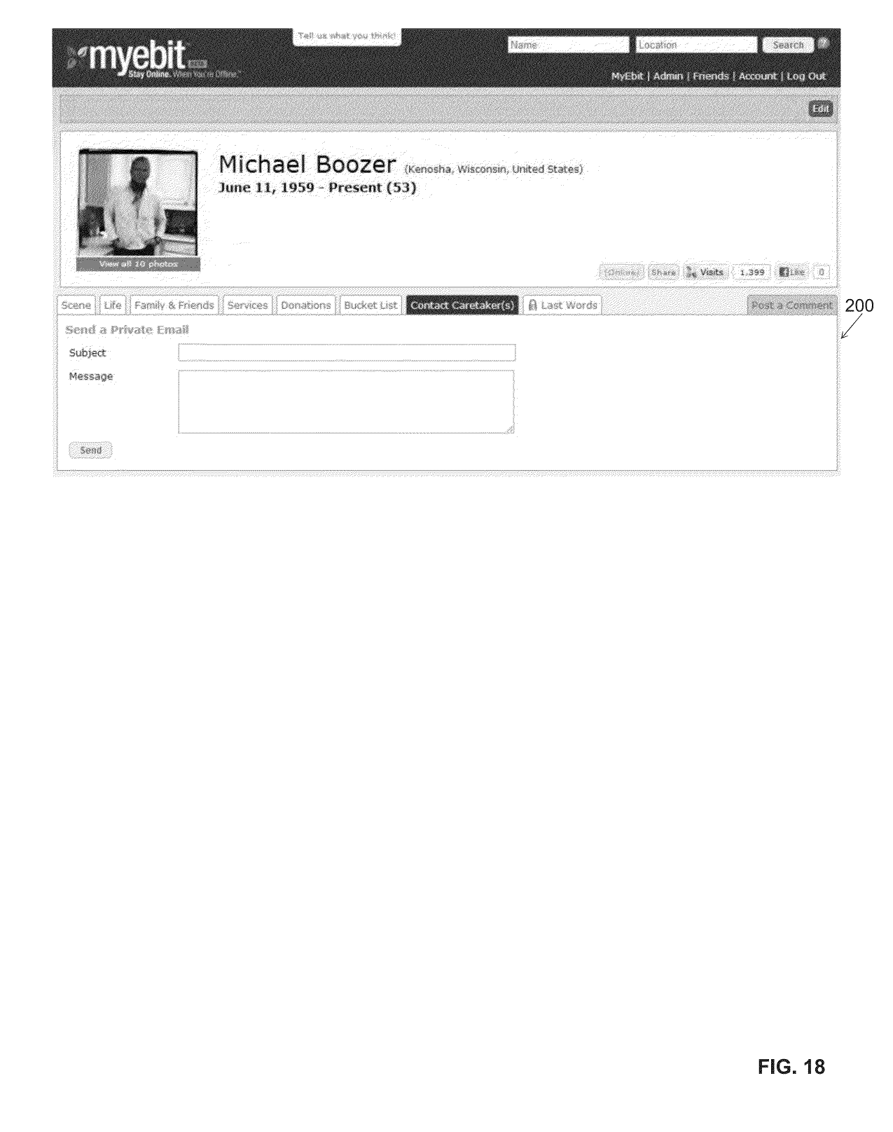

In some embodiments, the VRS 50 is configured to automatically create a caretaker card based on caretaker information input by the user or the caretaker. For example, as illustrated in FIG. 17, a user can view and print a caretaker card through the VRS 50. In some embodiments, the user can also use the VRS 50 to send a private message (e.g., an email message) to a caretaker (see, e.g., FIG. 18). In some embodiments, the VRS 50 also allows other users and, optionally, guests, to view caretaker information associated with an ebit 200, access a caretaker card, and/or send a private message to the caretaker (e.g., to request information regarding funeral services or donations).

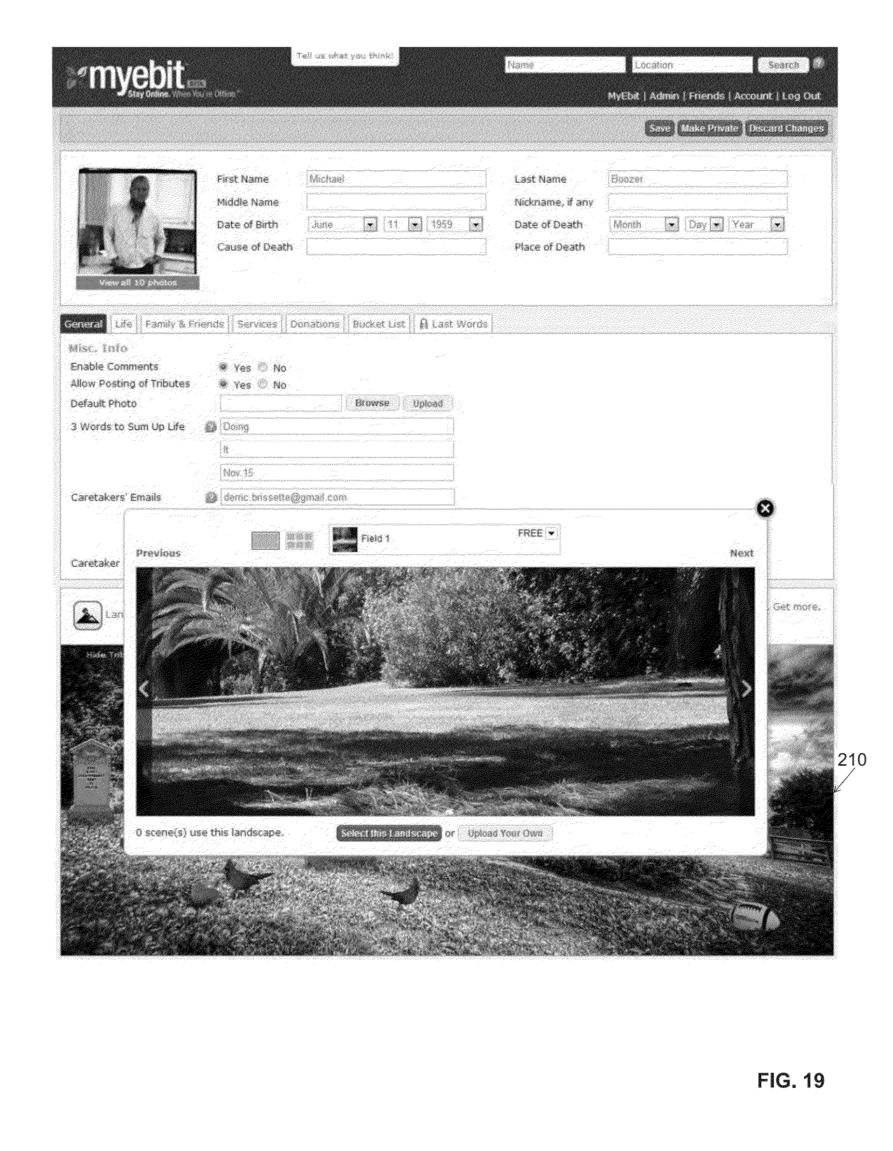

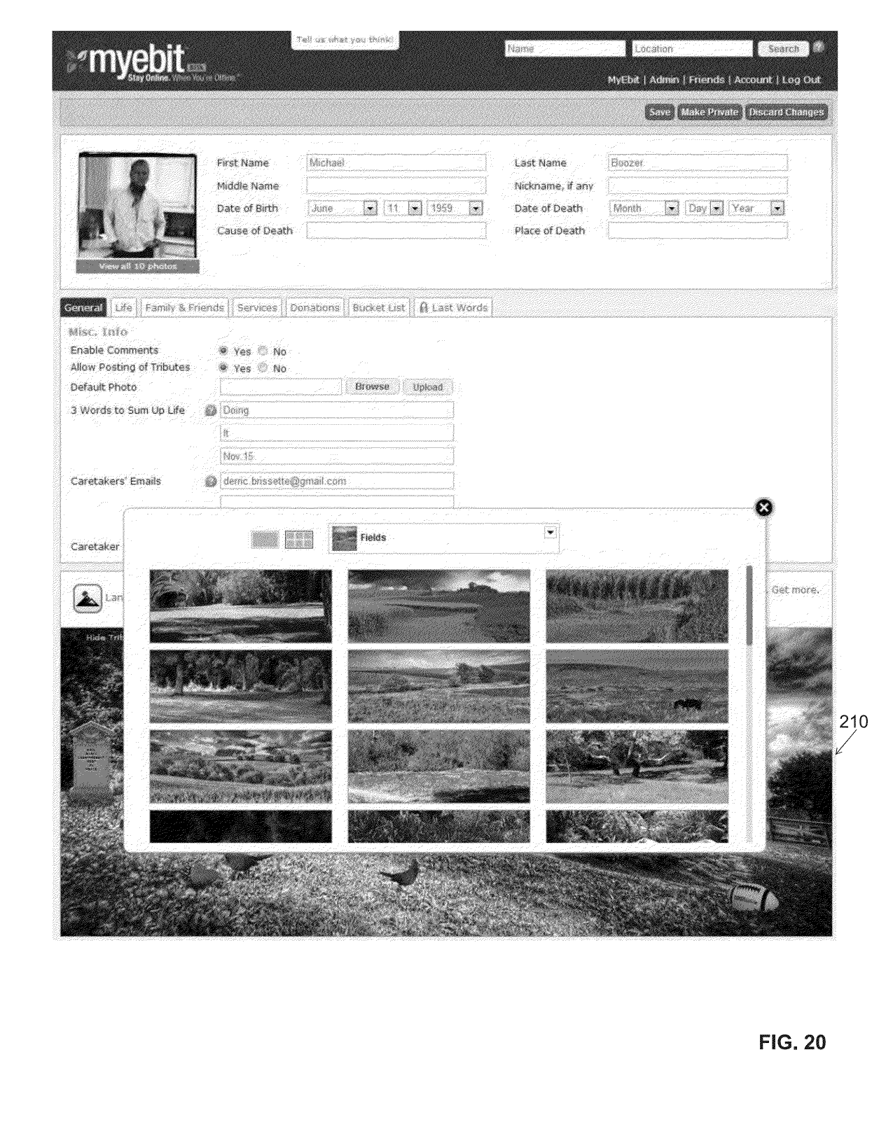

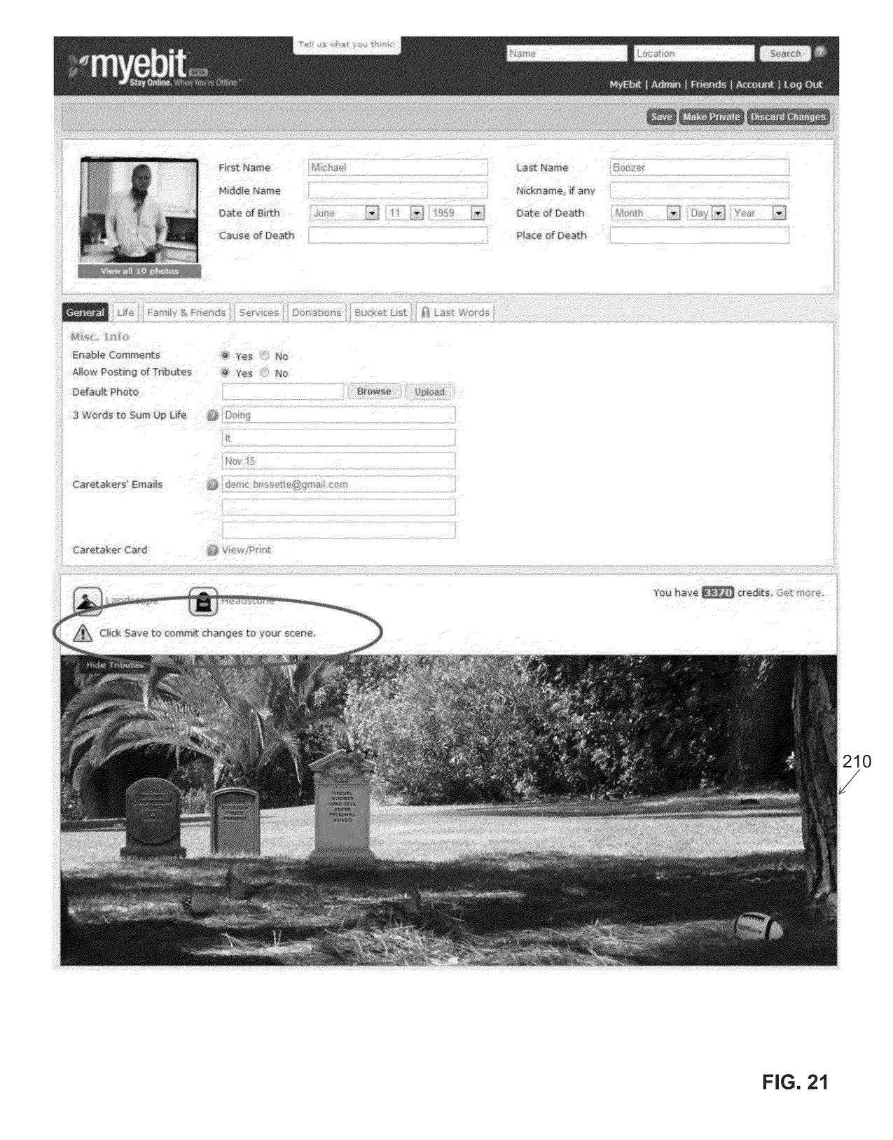

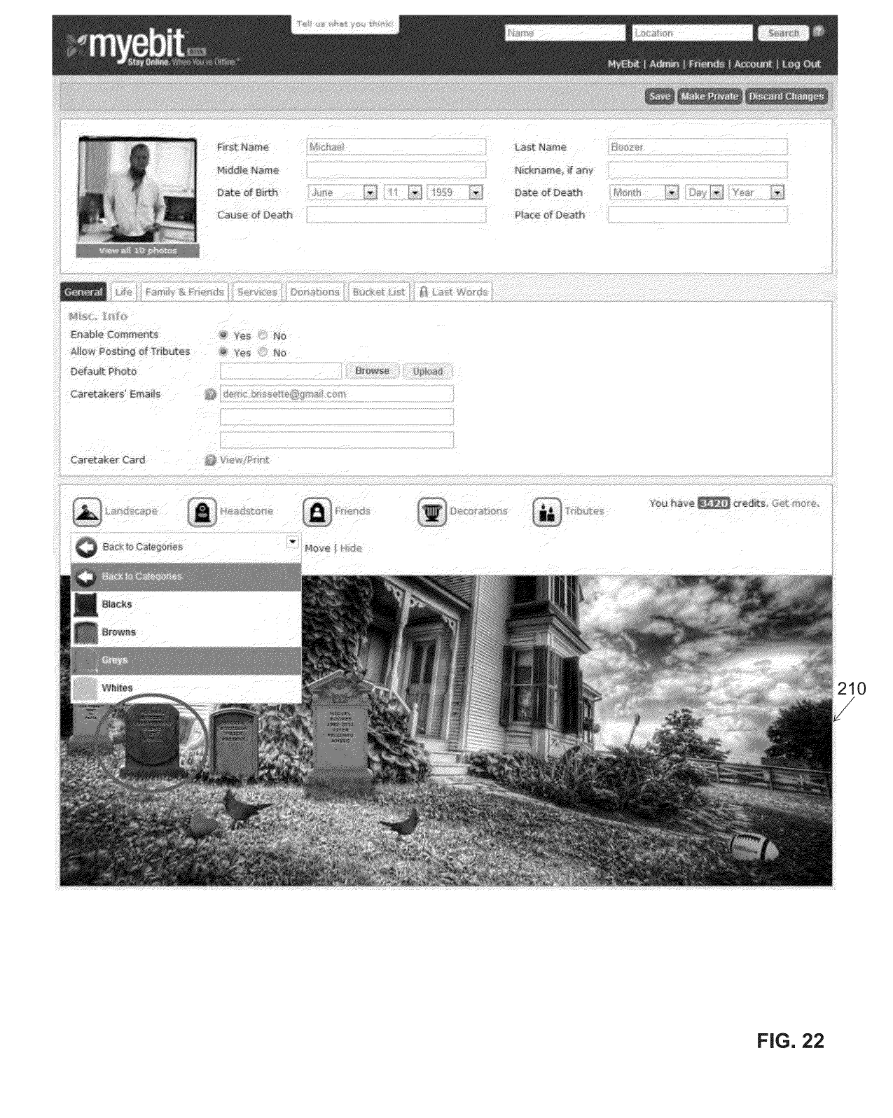

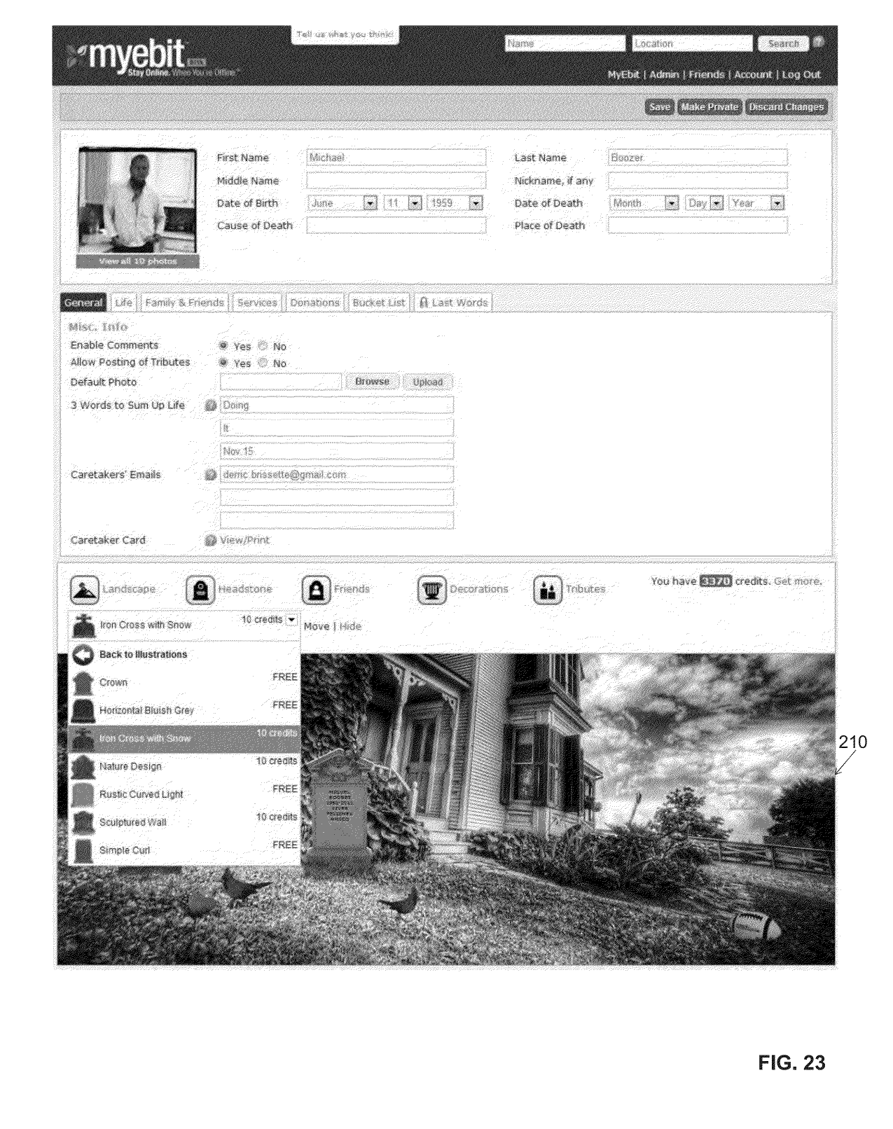

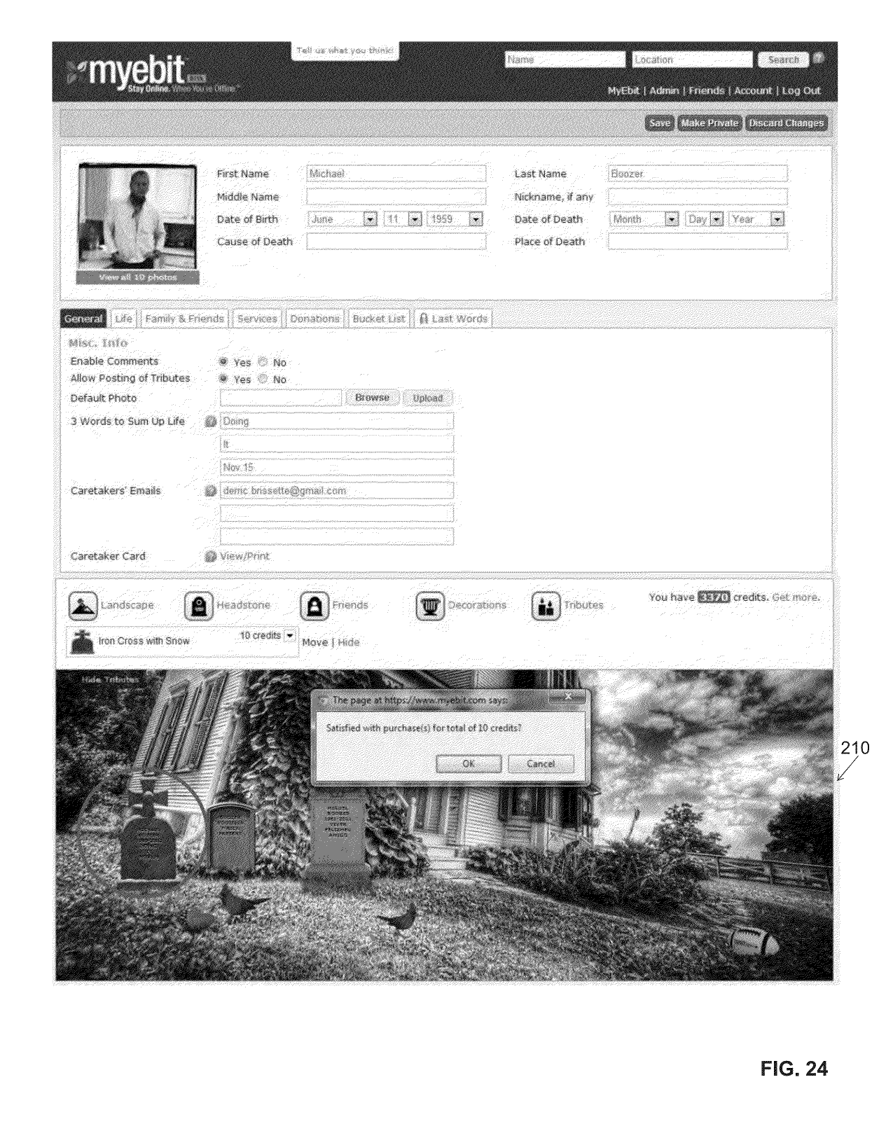

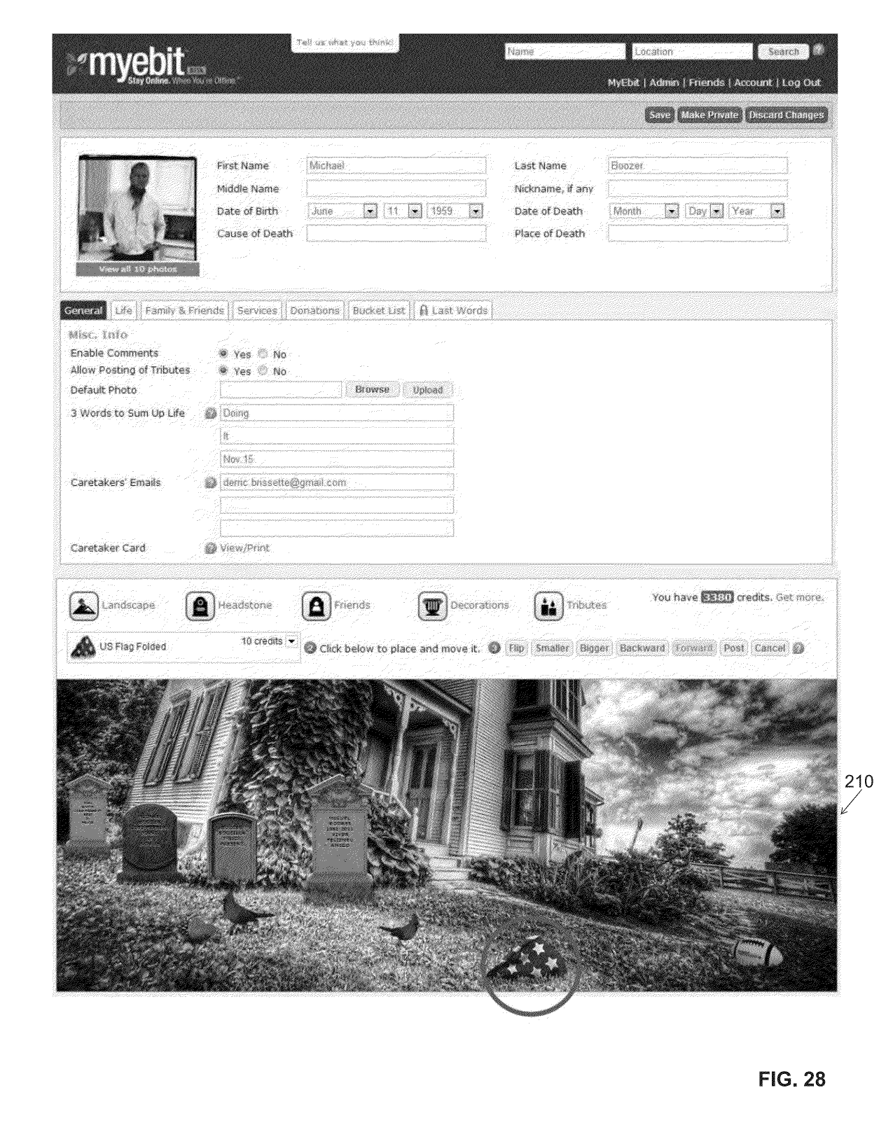

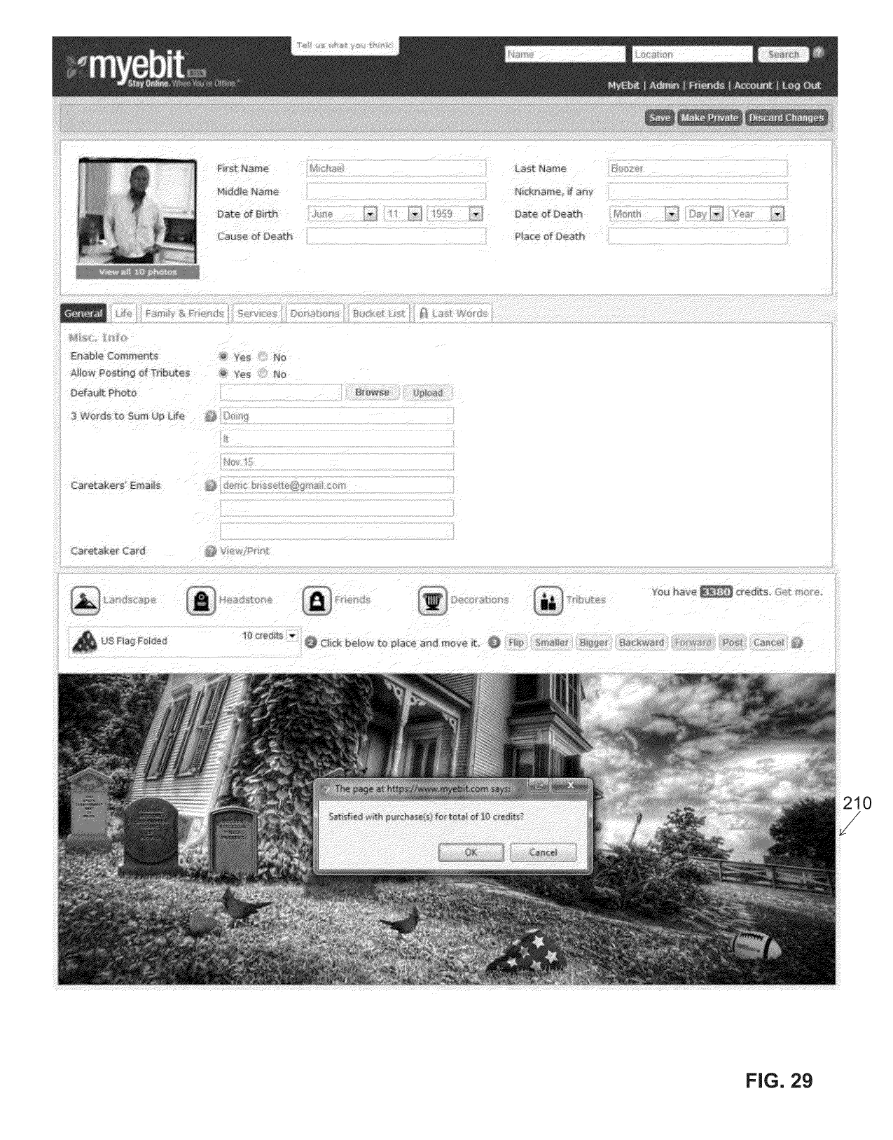

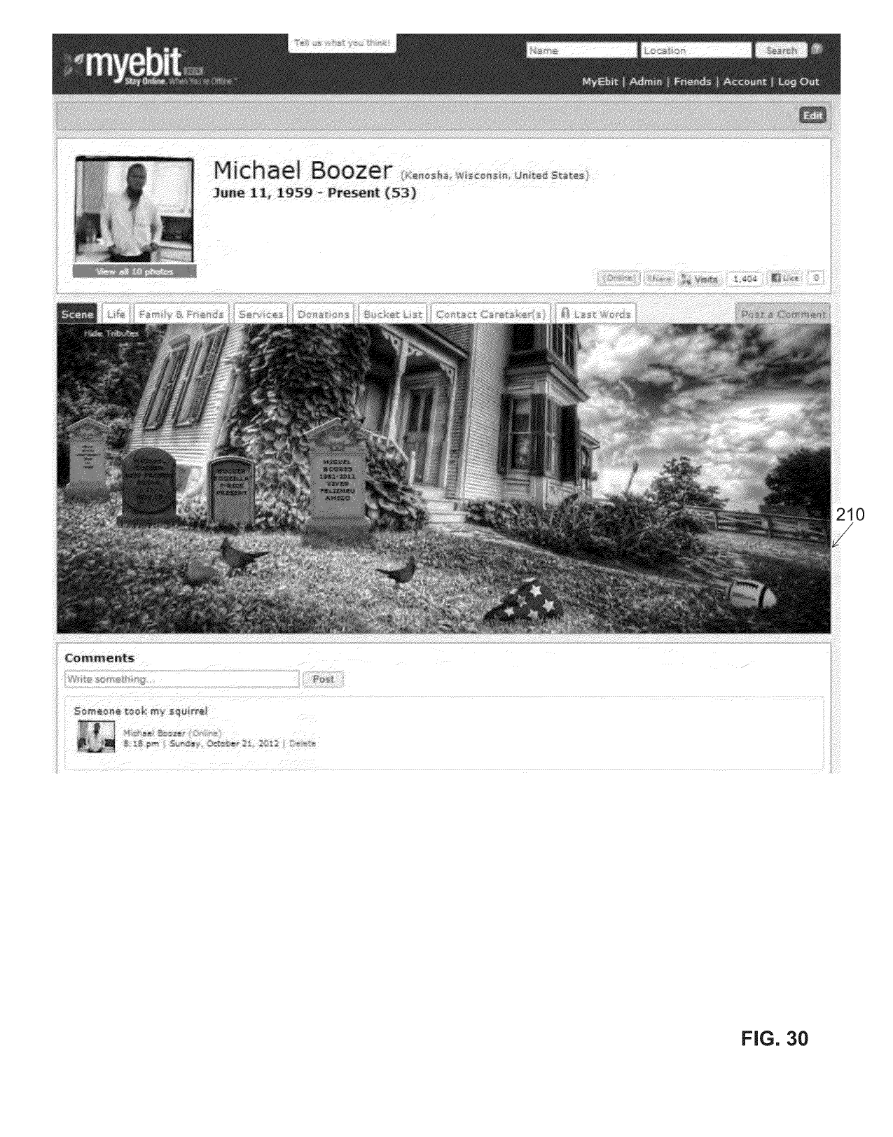

As part of the ebit 200, the VRS 50 allows a user to create a graphical scene, such as a virtual scene of remembrance 210 (e.g., a cemetery scene) (at 212). To create the scene 210, a user can select a background image (“landscape”) and one or more decorations (at 212). The decorations can include one or more headstones (e.g., a headstone for the person associated with the ebit 200 and, optionally, one or more headstones for the person's family and friends) and other graphical items, such as flags, rocks, trees, plants, etc. For example, FIGS. 19-31 illustrate various pages provided by the VRS 50 for creating and managing a scene 210.

As noted above, the VRS 50 can initially create a default scene for a user. The default scene can include a default landscape and, optionally, at least one default decoration (e.g., a default headstone). The user can customize the default scene by providing one or more customizations to the VRS 50. For example, as illustrated in FIGS. 19-21, the user can change the default landscape by selecting a new landscape (e.g., from a menu of available landscapes). The VRS 50 updates the scene 210 based on the user landscape selections and makes the updated scene 210 available for other users within the social networking environment.

The user can also customize the default decoration created by the VRS 50. For example, if the default decoration includes a headstone or other death memorial, a user can change the type of the default headstone (e.g., style, materials, size) as illustrated in FIGS. 22-24. The user can also change the location of the headstone within the scene 210 and edit text included in the headstone. In some embodiments, the VRS 50 is configured to automatically generate text for the headstone based on textual information included in the ebit 200. The VRS 50, however, can be configured to allow the user to manually edit the text. The VRS 50 updates the scene 210 based on the user's edits to the headstone and makes the updated scene 210 available for other users.

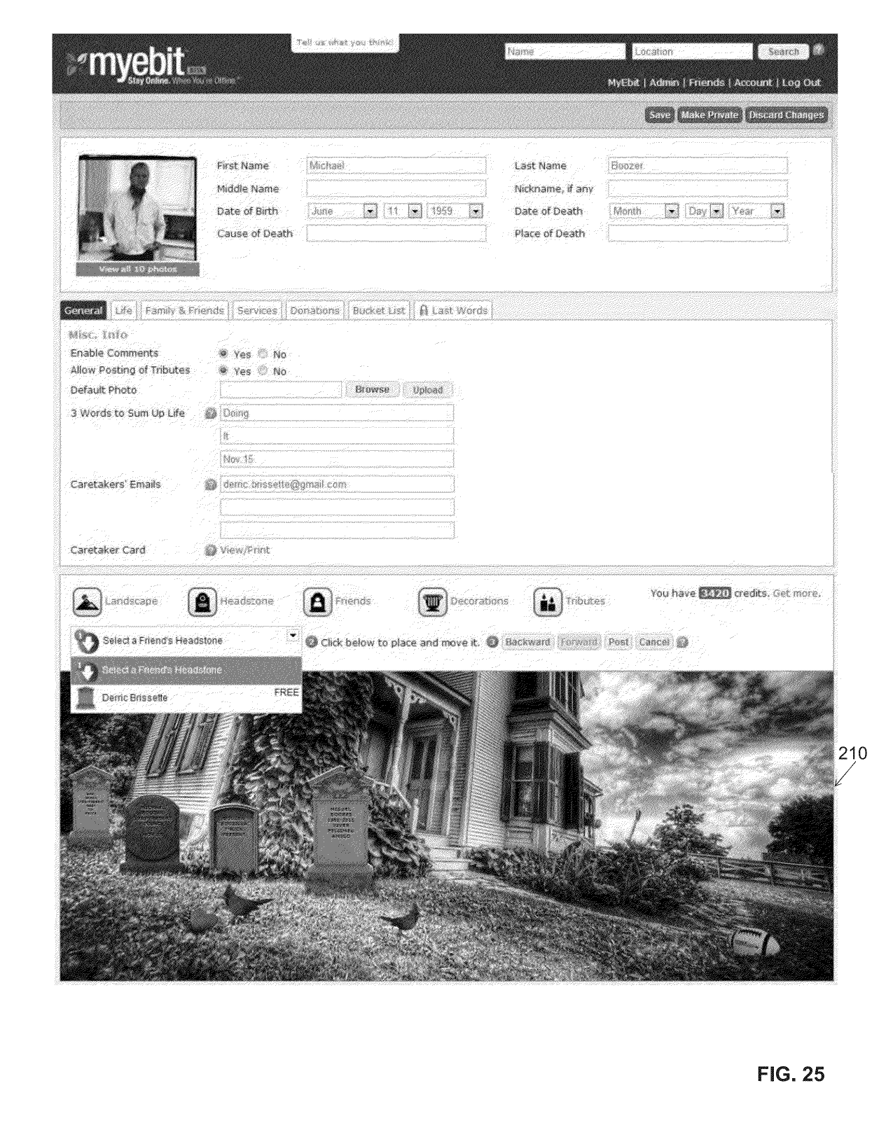

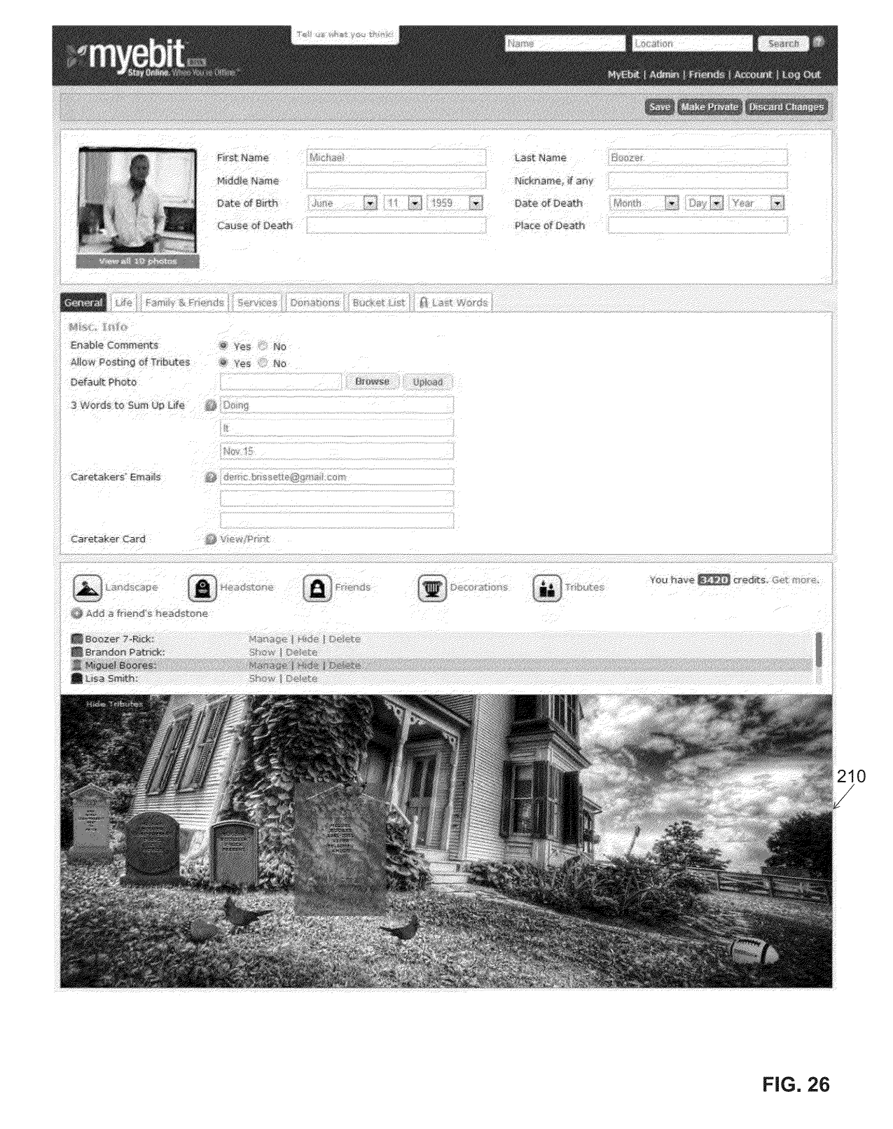

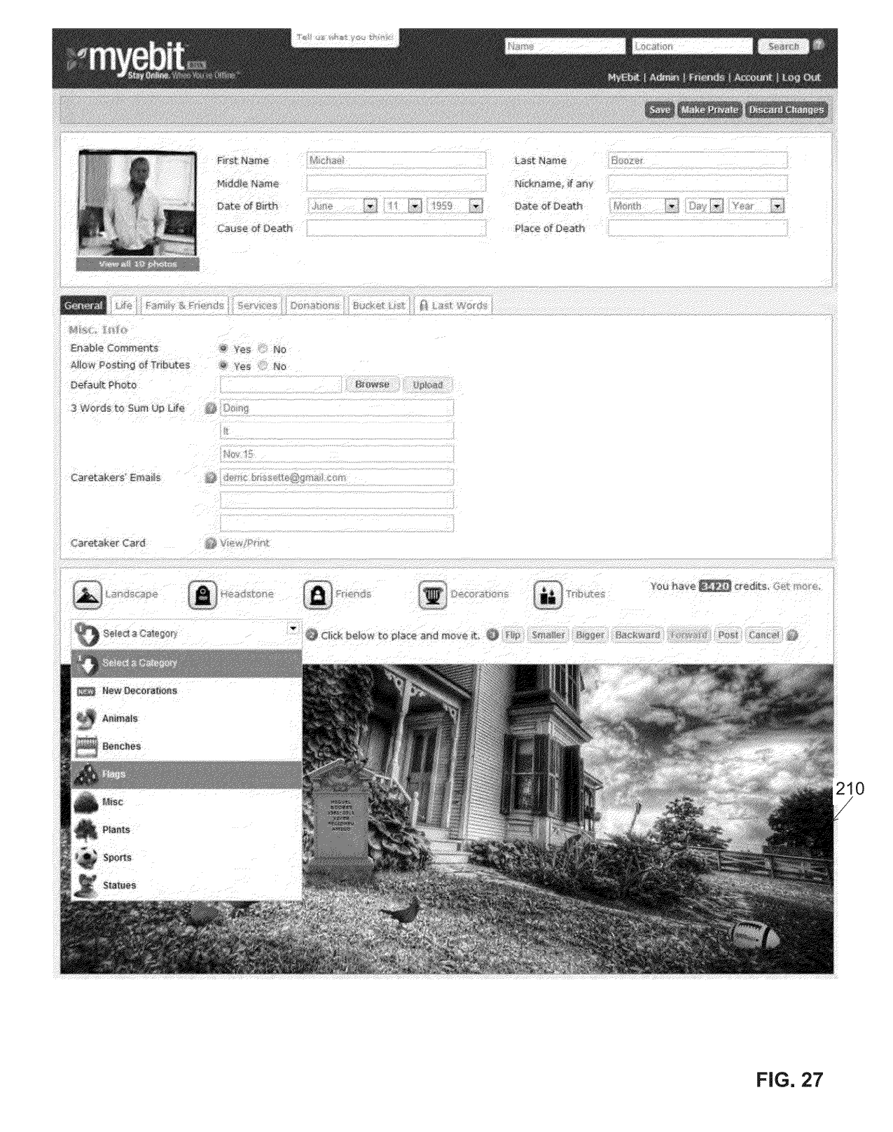

In addition to as an alternative to the default decoration, the user can add other decorations to the scene 210, such as headstones for friends or family members (see, e.g., FIGS. 25-26). It should be understood that the decorations can also include non-headstone graphics, such as animals, plants, rocks, benches, plaques, urns, fences, flags, etc. For example, as illustrated in FIGS. 27-30, a user can select a decoration from available decorations (which may be grouped in categories). The user can also modify a selected decoration, such as by changing its default size, colors, orientation, etc. After selecting a decoration, the user places the decoration at a particular location within the graphical scene 210. After selecting, optionally editing, and placing the decoration, the VRS 50 updates the scene 210 and makes the updated scene 210 available within the social networking environment. As illustrated in FIG. 31, in some embodiments, the VRS 50 also allows a user to manage previously placed decorations, such as by providing a list of decorations included in the scene 210 and allowing a user to edit or delete selected decorations from the list.

As illustrated in FIGS. 19-31 the landscapes and decorations can take the form of images or other digital media (including photographs, animations, videos, music, recordings, etc.) combined to form the scene 210. In some embodiments, the landscapes and decorations can be associated with textual information (e.g., text on a headstone or a message associated with a decoration). As described above, the VRS 50 can provide a library of available media that the user can select from to create the scene 210. The user can then position and combine the selected media. In particular, the VRS 50 can superimpose or overlay images selected by the user based on the positions or placement of each image selected by the user. The user can also add text to the scene 210 and can associate other media, such as music, animation, video, etc. with the scene 210. For example, a user can select a landscape, add and place headstones and other decorations on the landscape and change the entire scene 210 as the user see fits. It should be understood that the user can continue to customize the scene 210 as often as the user desires or can retain the default scene initially created by the VRS 50.

In some embodiments, the VRS 50 also allows users to create customized items for a scene 210 either directly and/or through the use of uploaded images and other digital media. For example, the VRS 50 can provide editing tools that allow users to customize images and other digital media (provided through the VRS 50 or uploaded to the VRS 50 by the user). These editing tools can include tools for changing lighting effects, applying borders, tagging friends, and adding transparent highlighting (e.g., to overlay headstone information (e.g., an epitaph or inscription) onto any object, such as cross markers, benches, and other decorations). The VRS 50 can also partner with third-party image resources that allow users to seamlessly choose images or other digital media from a source other than the VRS 50. Similarly, the VRS 50 can be configured to allow a user to upload a photo taken on their cellular telephone or other mobile device directly to the VRS 50. The VRS 50 can optionally be configured to automatically make the uploaded photo part of the user's scene 210 or ebit 200. In some embodiments, the VRS 50 can also be configured to provide custom design services that allow users to request custom designs for landscapes and decorations. In some embodiments, the VRS 50 may require that a user agree to a submission agreement when a user designs a custom item to ensure that the VRS 50 has the proper authority to publish and use the custom item.

In some embodiments, the VRS 50 also allows a user to create multiple scenes 202. The scenes 202 can be rotated (automatically or at the selection of the user) or one of the scenes 202 can be designated as a default scene. The VRS 50, however, can be configured to save the other scenes and can allow a user to set a saved scene as the default scene. Also, in some embodiments, the VRS 50 allows a user to associate a particular scene 210 with a particular type of user viewing the ebit 200, such as one scene 210 for family members, one scene 210 for co-workers, and one scene 210 for friends. The VRS 50 can also be configured to apply a static time lapse to a scene 210 that changes the landscape of the scene 210 from a day view to a night view. The VRS 50 can also allow a user to choose a time lapse, such as by choosing the speed at which the landscape of the scene 210 changes from day to night. Similarly, the VRS can be configured to apply a static or user-selected time lapse to a scene 210 that changes the landscape of the scene 210 between various seasons (e.g., spring, summer, fall, and winter).

In some embodiments, the VRS 50 uses one or more plug-ins for creating and displaying the scene 210, such as the Adobe Flash Player®. In some embodiments, the VRS 50 also allows users and guests to view a scene 210 as a full screen image (separate from a full browser mode). Similarly, the VRS 50 can allow users to access a scene 210 as a single graphic image that can be stored, printed, etc. (e.g., used as a screen saver or wallpaper).

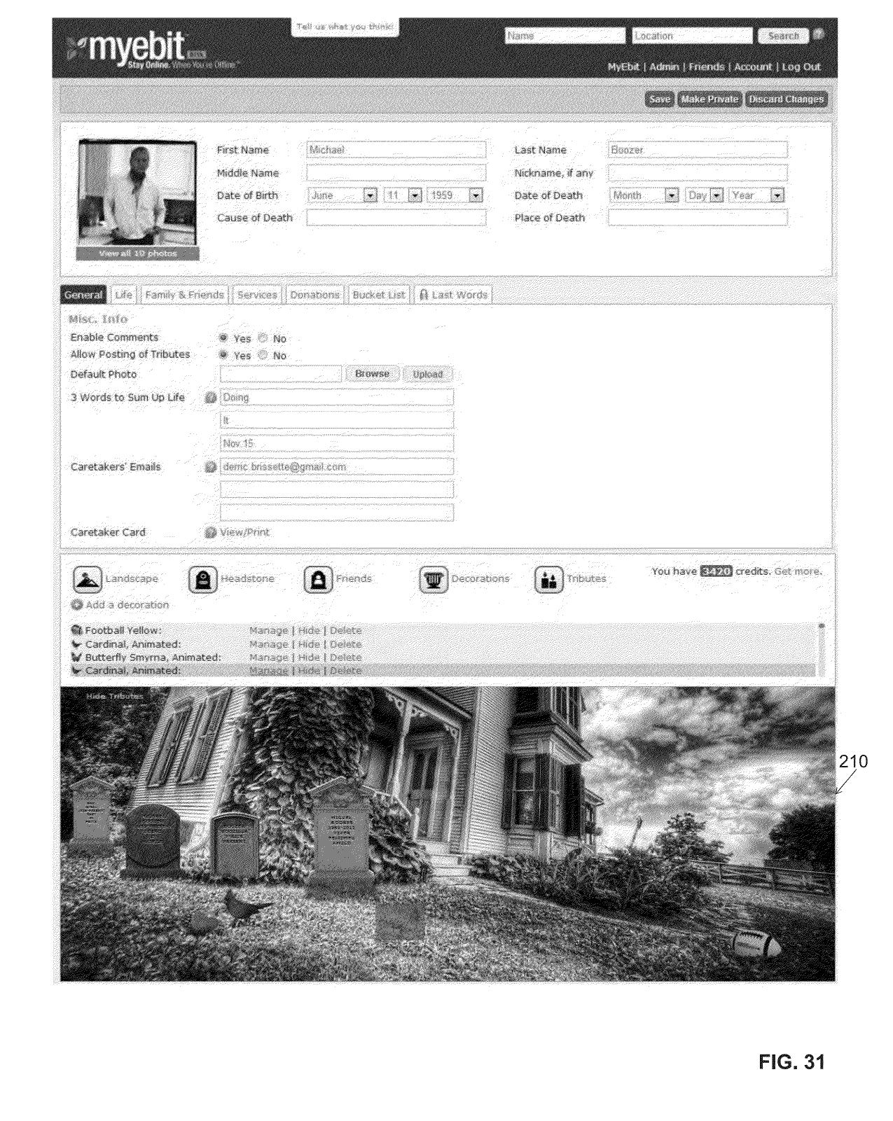

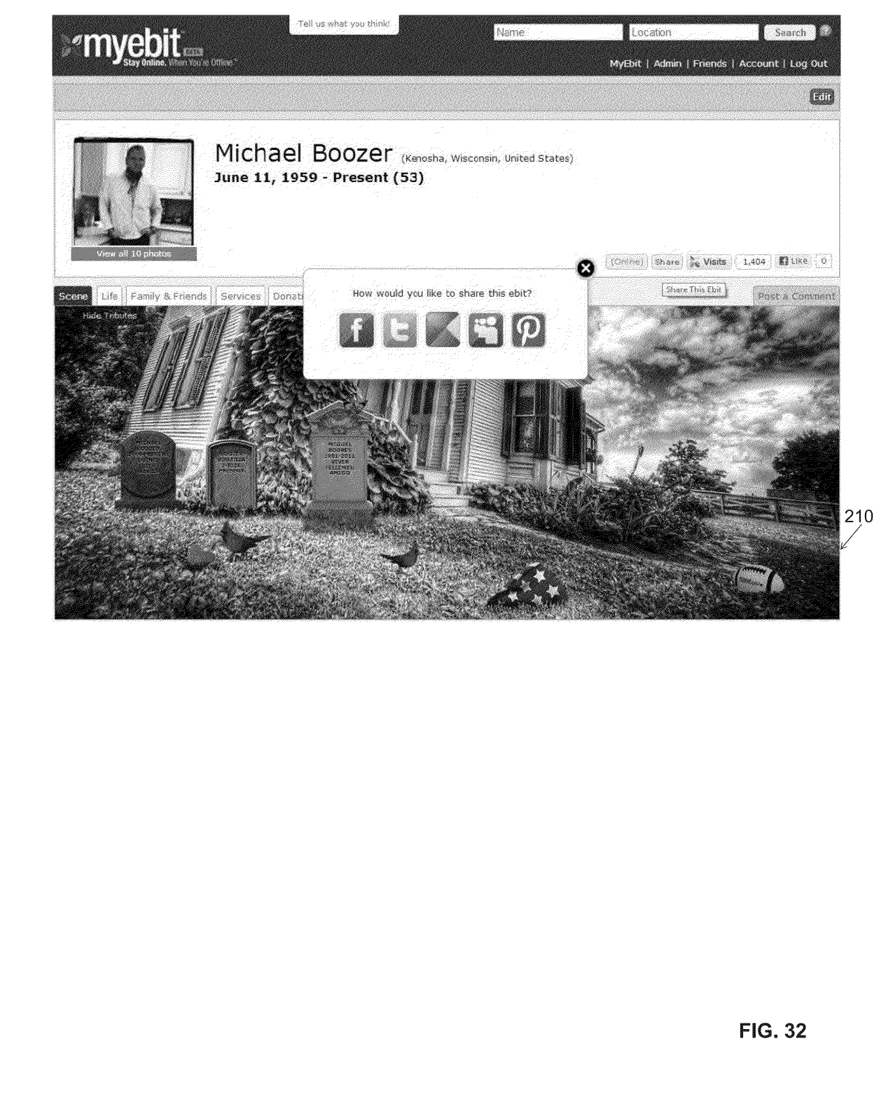

Therefore, the VRS 50 allows a user to create a customizable ebit 200 that include bibliographic and informational content (i.e., an ebituary) and a customized virtual scene 210. After creating the ebit 200, the VRS 50 makes the ebit 200 available within a social networking environment to allow other users to view the ebit 200 while the person associated with the ebit 200 is still alive and for future remembrance and reflection after the person's death. Accordingly, the ebit 200 serves as a centralized virtual place of remembrance. In some embodiments, the VRS 50 also allows a user to share all or part of an ebit 200 managed by the VRS 50 (e.g., the scene 210) through other social networking environments or applications (see, e.g., FIG. 32). In addition, in some embodiments, the VRS 50 is configured to transmit information to other systems based on an ebit 200. For example, the VRS 50 can automatically submit a conventional obituary to one or more newspapers or other publication services (e.g., designated by the user) when the person associated with an ebit 200 dies. The VRS 50 can be configured to automatically create the obituary based on the information contained in the ebit 200. In other embodiments, the VRS 50 allows a user to create and store an obituary, and the VRS 50 automatically transmits the obituary to the designated publication services when the person dies.

As illustrated in FIG. 2e, after the user creates the ebit 200 and the VRS 50 makes the ebit 200 available to other users and guests, the user can continue to manage the ebit 200 by editing settings (at 201), content (at 202), photos (at 203), caretaker information (at 204), and the scene 210 (at 212). Also, the user creating the ebit 200 can manage comments (at 214) and decorations (e.g., tributes) (at 216) placed on an ebit by other users and guests, such as by deleting, moving, or commenting on a comment or decoration.

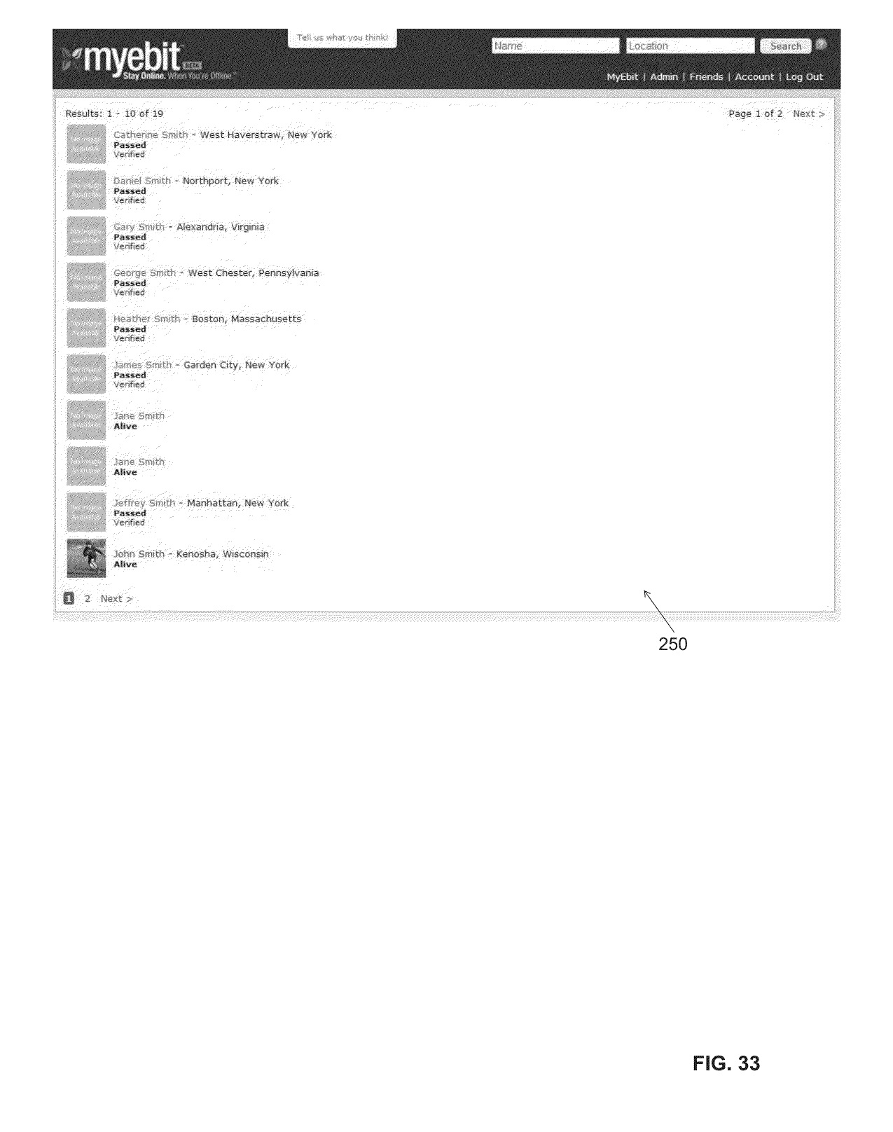

In particular, once the ebit 200 is created, the VRS 50 makes the ebit 200 available to other registered users and guests of the VRS 50. For example, the VRS 50 allows registered users and guests to search for ebits 200 (at 220, FIG. 2a and at 106, FIG. 2b). FIG. 33 illustrates a search page 250 provided by the VRS 50. The search page 250 lists ebits 200 matching search term(s) entered by the user or guest. As noted above, in some embodiments, the VRS 50 limits the list of matching ebits 200 for guests and/or based on settings associated with particular ebits 200 (e.g., settings indicating who can access a particular ebit 200).

When a user locates an ebit 200 (e.g., from the search page 250), the user's access to and manipulation of the located ebit 200 can be limited based on the status of the user. For example, as illustrated in FIG. 2f, guests viewing an ebit 200 can be limited to viewing ebit content (at 260), viewing comments posted to the ebit 200 (at 262), and viewing photos uploaded and associated with the ebit 200 (at 264). On the other hand, as illustrated in FIG. 2g, a registered user viewing an ebit 200 can view ebit content (at 266), view and post comments to the ebit 200 (at 268), view photos uploaded and associated with the ebit 200 (at 270), contact a caretaker associated with the ebit 200 (at 272), add themselves as a caretaker (at 274), verify a death (described in more detail below) (at 276), and leave a tribute (described in more detail below) (at 278).

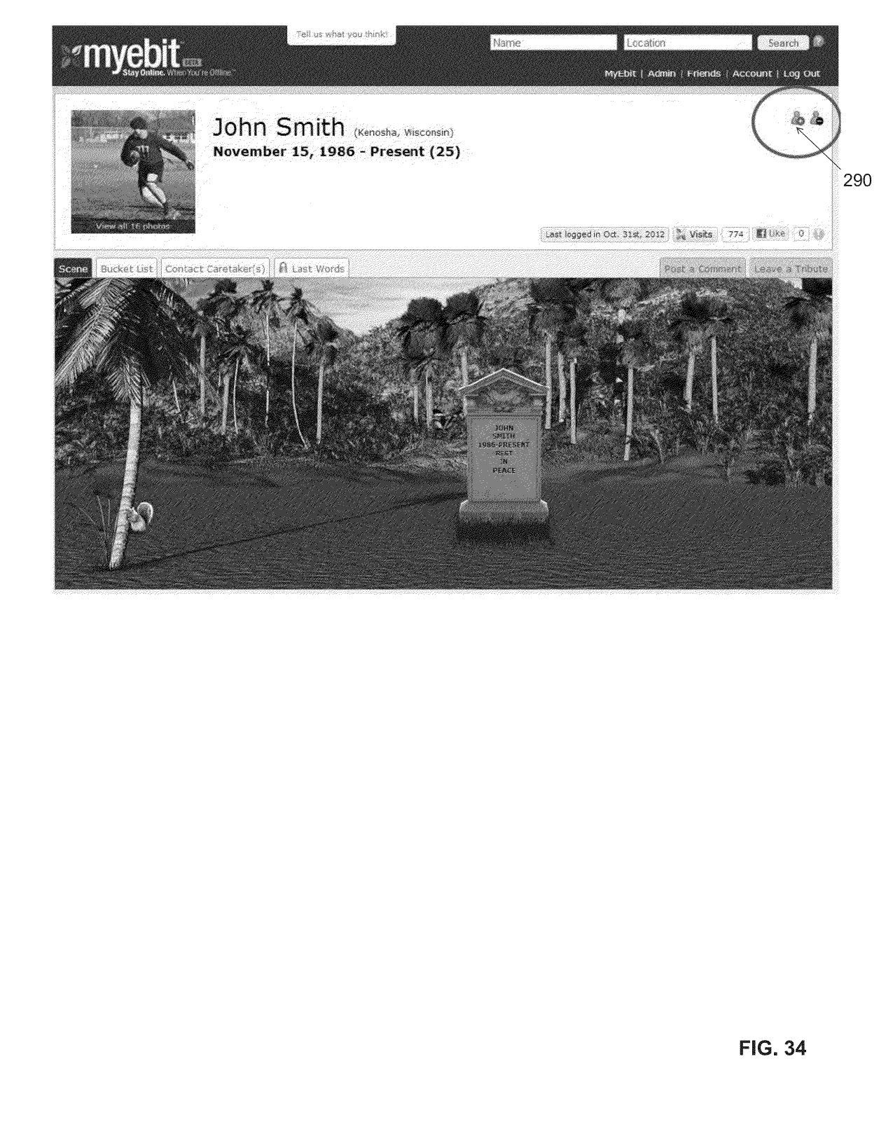

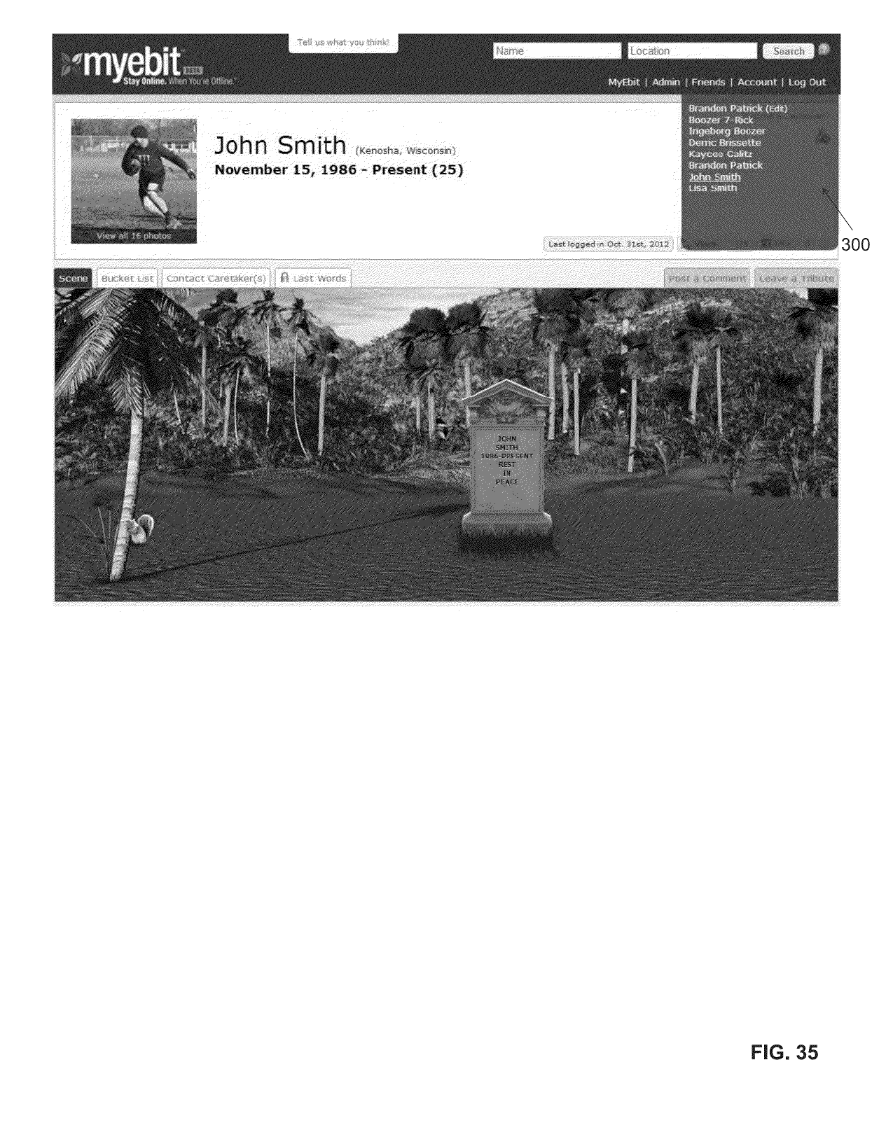

A registered user can also add an ebit 200 (i.e., the person associated with the ebit 200) as a “friend” (at 280). In particular, when a registered user locates and views an ebit 200 (e.g., through the search page 250 or through other means), the registered user can add the located ebit 200 to their “friends list.” For example, as illustrated in FIG. 34, an ebit 200 can include an “add-as-friend” selection 290. A registered user can select (e.g., click on) the selection 290, to add the currently-viewed ebit 200 (i.e., the “friend” ebit) to the user's “friends list.” A user can access their “friends list” through the VRS 50 (see, e.g., FIG. 35), by selecting a “Friends” selection 300. A user can access the ebit 200 of a “friend,” by selecting the “friend's” name from the “friends list.”

In some embodiments, the VRS 50 requires that the user associated with the “friend” ebit confirm that he or she knows the user before the VRS 50 allows the user to add the “friend” ebit to their “friends list.” In some embodiments, adding an ebit 200 to a user's “friends list,” gives the user viewing the ebit 200 an increased degree of access and/or manipulation. For example, in addition to the access and manipulation rights available to all registered users (see FIG. 2g), a user also can upload data, e.g., images and other digital media, to a “friends” ebit that becomes part of the ebit 200. It should be understood that the VRS 50 or individual ebits 200 can be configured in various ways to restrict or manage access to ebits 200 or particular portions of ebits 200 by “non-friends” or guests. For example, in some embodiments, the VRS 50 can set default access configurations for all ebits 200, but individual users can modify the access configurations for each ebit 200.

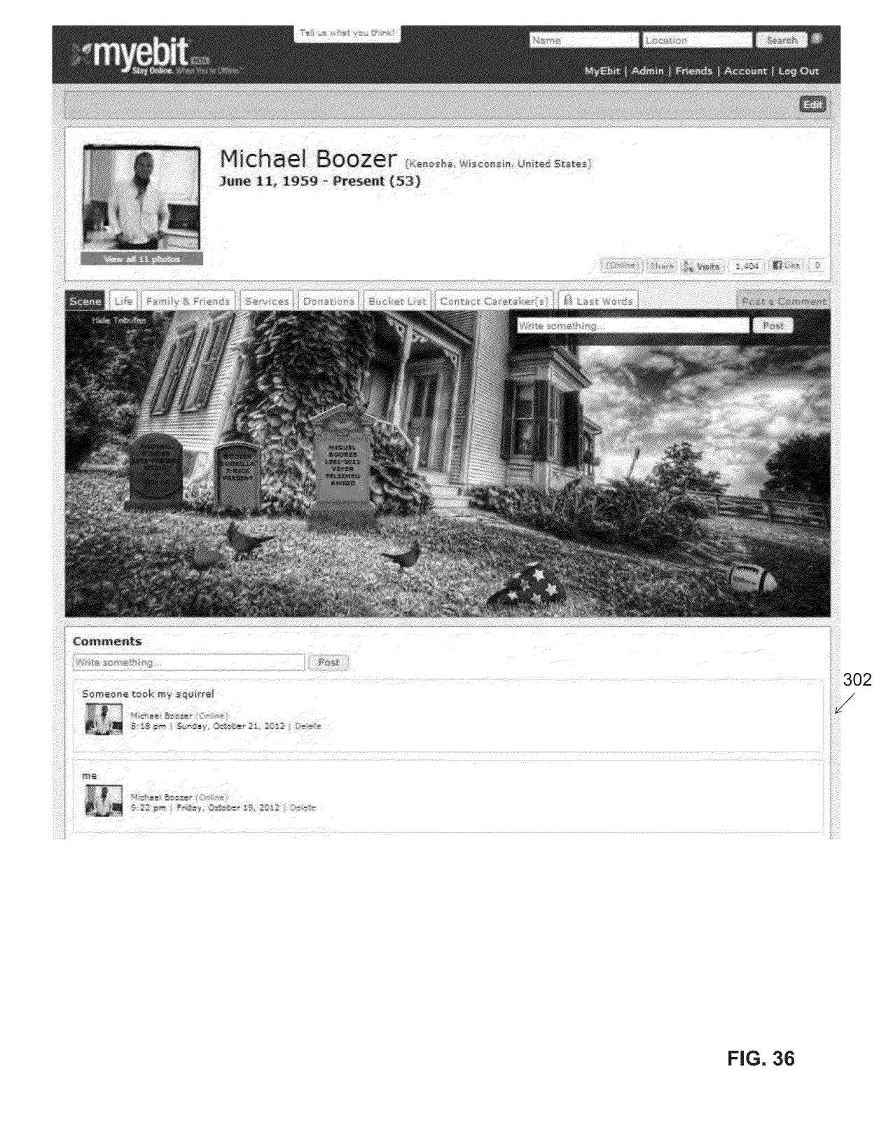

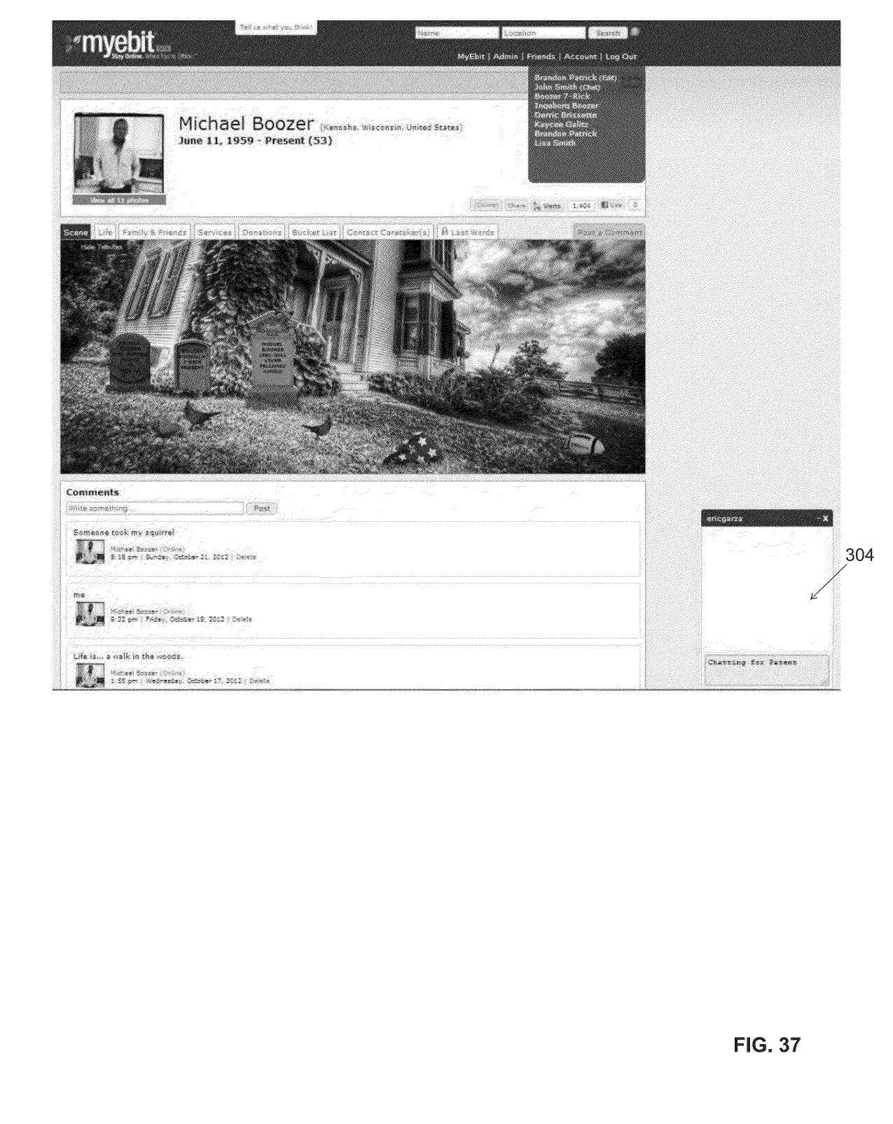

The VRS 50 also allows users to communicate with “friends.” For example, after being added as a “friend,” the VRS 50 allows a user to post comments on the “friend's” ebit within a comments section 302, as illustrated in FIG. 36. The VRS 50 can also allow users to send email messages or text messages to “friends” and chat with “friends” using a chat section 304, as illustrated in FIG. 37. It should be understood that, in some embodiments, a user can also communicate with an ebit 200 even if the ebit 200 is not associated with a “friend.”

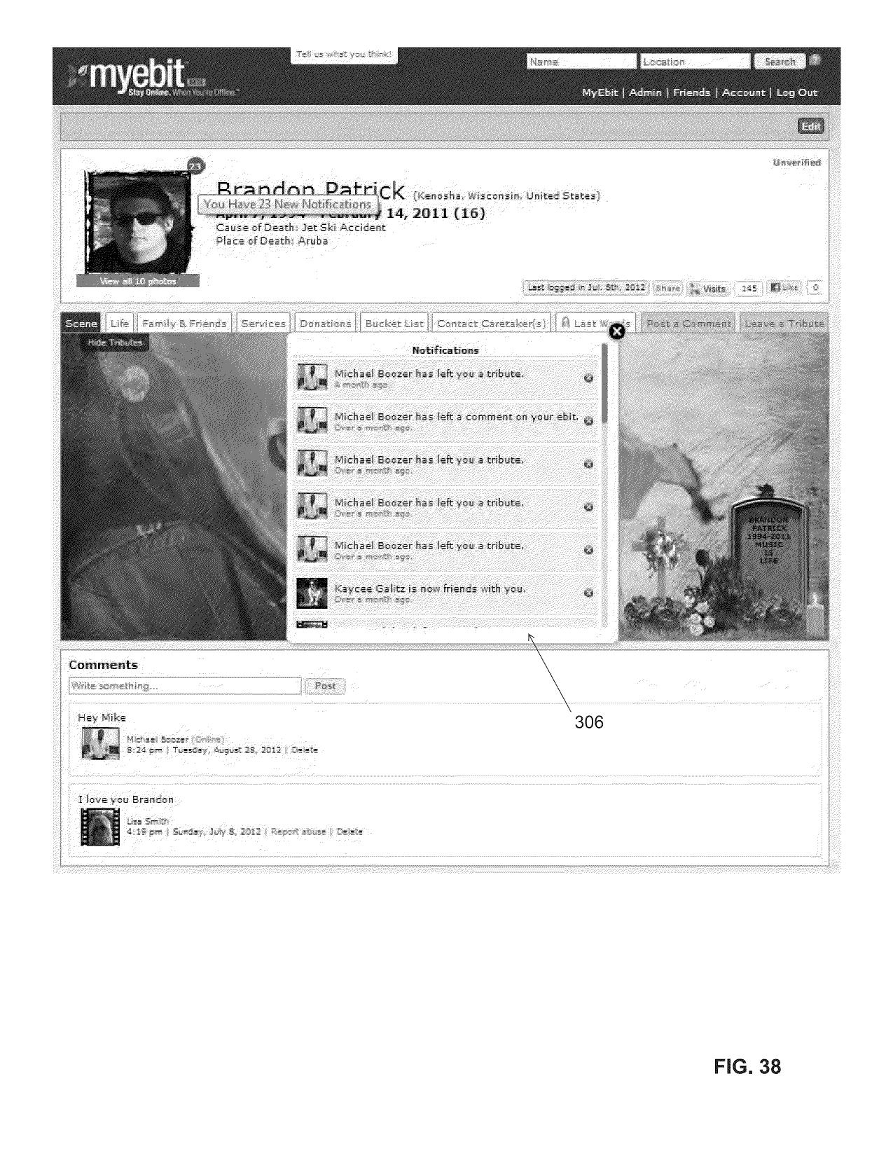

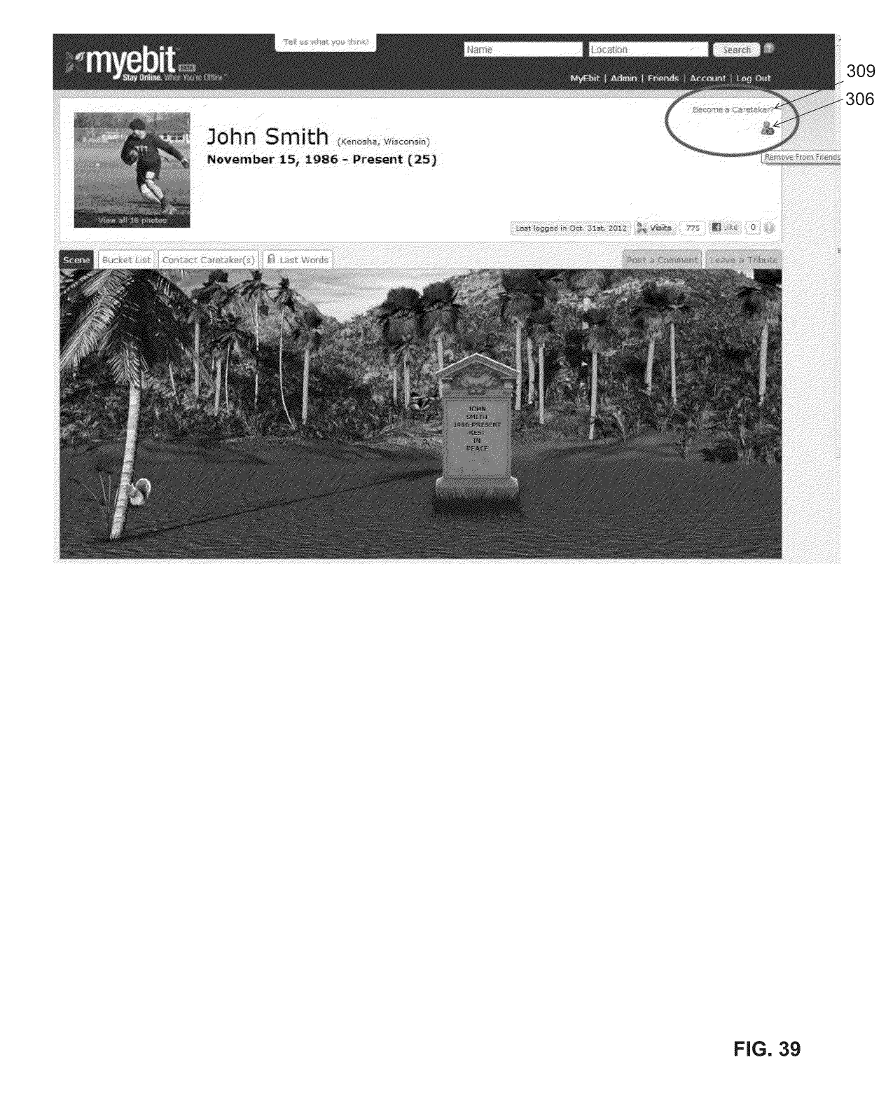

As illustrated in FIG. 38, once added as a “friend,” the VRS 50 can also provide notifications 306 to the user regarding changes each “friend” ebit (e.g., changed landscape, new decoration, new “friends,” death, etc.). The VRS 50 also allows a user to manage their “friends” list, such as by removing ebits 200 from their “friends list.” For example, as illustrated in FIG. 39, a user can select a “remove-as-friend” selection 306 to remove an ebit 200 from the user's “friends list.”

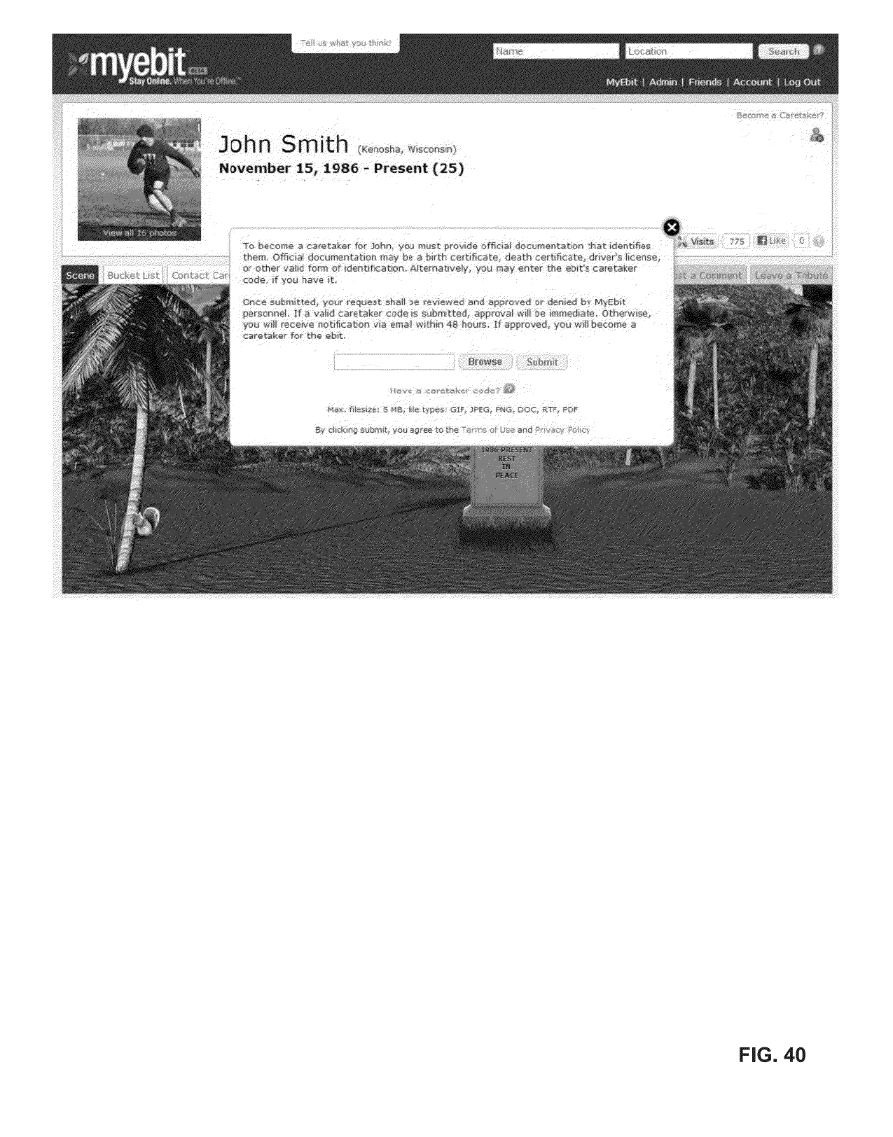

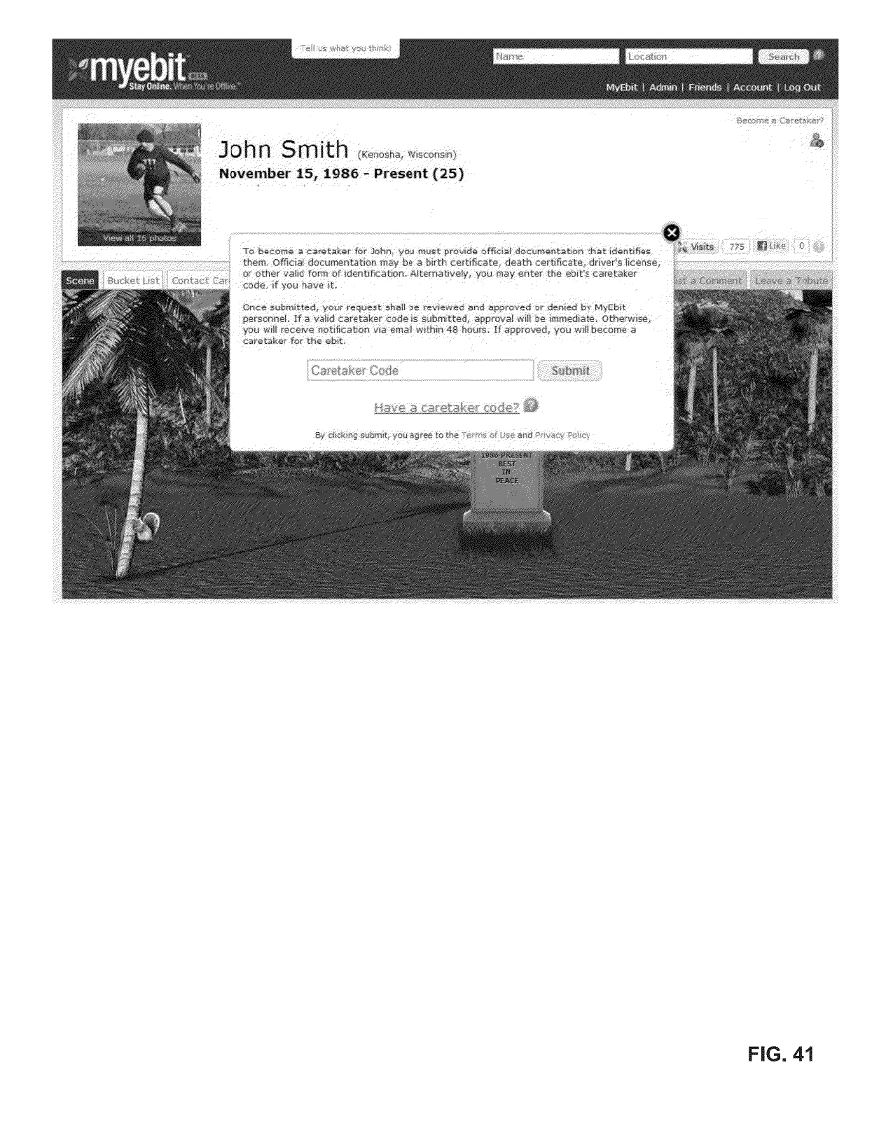

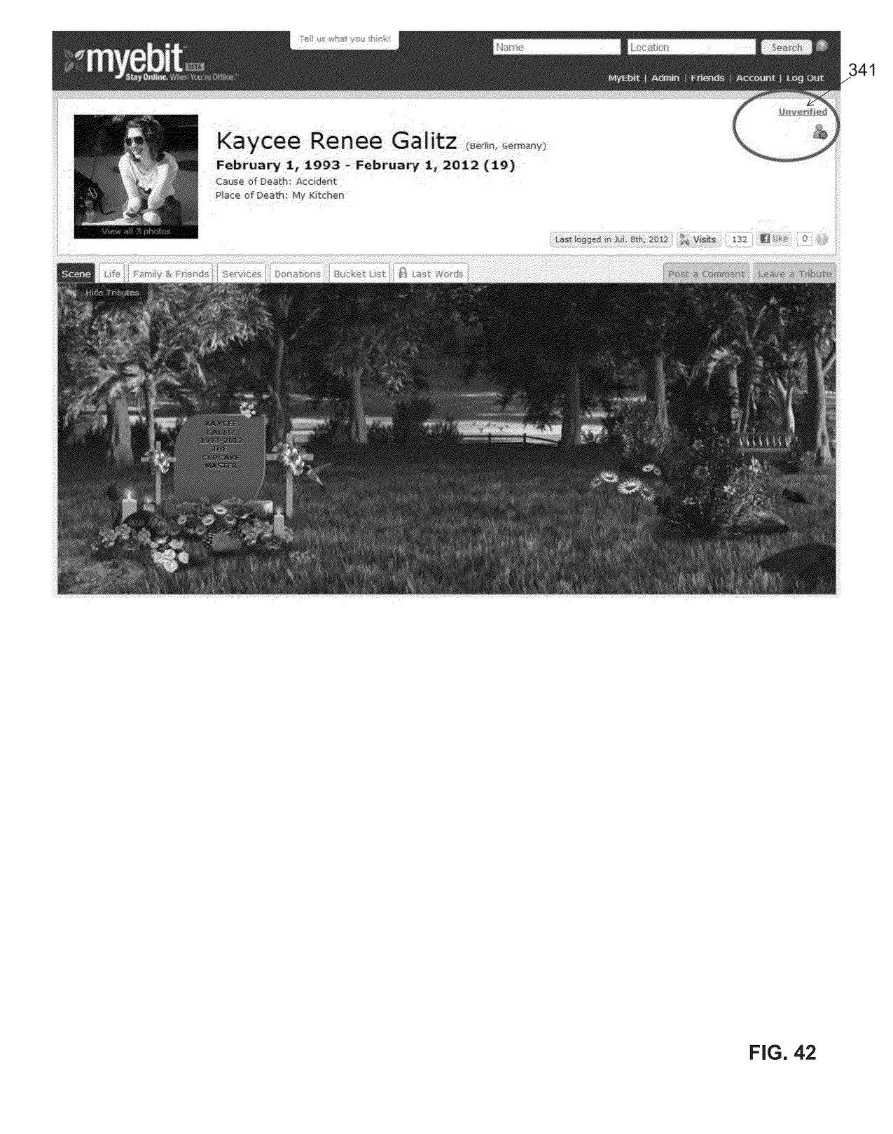

As noted above, a registered user can also add themselves as a caretaker for another ebit 200. Accordingly, although a user can specify one or more caretakers for an ebit 200 (FIG. 2e, at 204-206), the VRS 50 can also be configured to allow users to add themselves to ebits 200 created by other users. In particular, as illustrated in FIG. 39, an ebit 200 can include an “add-as-caretaker” selection 309. If a user selects the selections 309, the VRS 50 can prompt the user for official identifying documentation (at 310, FIG. 2h). As illustrated in FIG. 40, the official documentation can identify the user and/or the person associated with the ebit 200 (e.g., a birth certificate, a death certificate, a driver's license, or other valid form of identification). The VRS 50 can verify the submitted documentation (at 312) (e.g., automatically or through a manual review process) and can add the user to the ebit 200 as a caretaker if the documentation is verified (at 314). For example, a registered user can submit a copy of a person's death certificate to verify that the person has died and that the registered user is authorized to act as a caretaker for the person's ebit 200. Alternatively or in addition, in some embodiments, a user can add themselves as a caretaker to an ebit 200 by supplying the VRS 50 with at least a portion of a unique identifier associated with the user creating the ebit 200, such as the last four digits of a social security number or a driver's license number.

Alternatively, in some embodiments, the VRS 50 allows registered users to request a unique caretaker code for their ebit 200 (at 320). The VRS generates and provides the user with a unique code (at 322), and the user provides the code to a selected caretaker (e.g., outside of the VRS 50) (at 324). As illustrated in FIG. 41, the caretaker submits the caretaker code through the VRS 50 to add himself or herself as a caretaker to the user's ebit 200 (at 326). The VRS 50 verifies the code to ensure that the entered code matches the generated code for the ebit 200 (at 328). If the VRS 50 verifies the code, the VRS 50 adds the caretaker to the ebit 200 (at 330). It should also be understood that in some embodiments, a user does not need to be a “friend” to be added as a caretaker for a particular ebit 200 and, in these situations, the VRS 50 can be configured to automatically add a caretaker as a “friend.”

The VRS 50 also allows users and guests to report a person's death (at 276, FIG. 2g). In particular, as illustrated in FIG. 2i, when a person associated an ebit 200 dies, a registered user can report the person's death through the VRS 50. For example, when a person dies, a user (e.g., a “friend” or the caretaker) can report the death to the VRS 50 (at 340). In particular, in some embodiments, a user reports a death by accessing the person's ebit 200 within the VRS 50 and updating the ebit 200 to reflect the person's date of death. The VRS 50 updates the profile based on the updated or completed date of death and makes the updated profile available within the social networking environment.

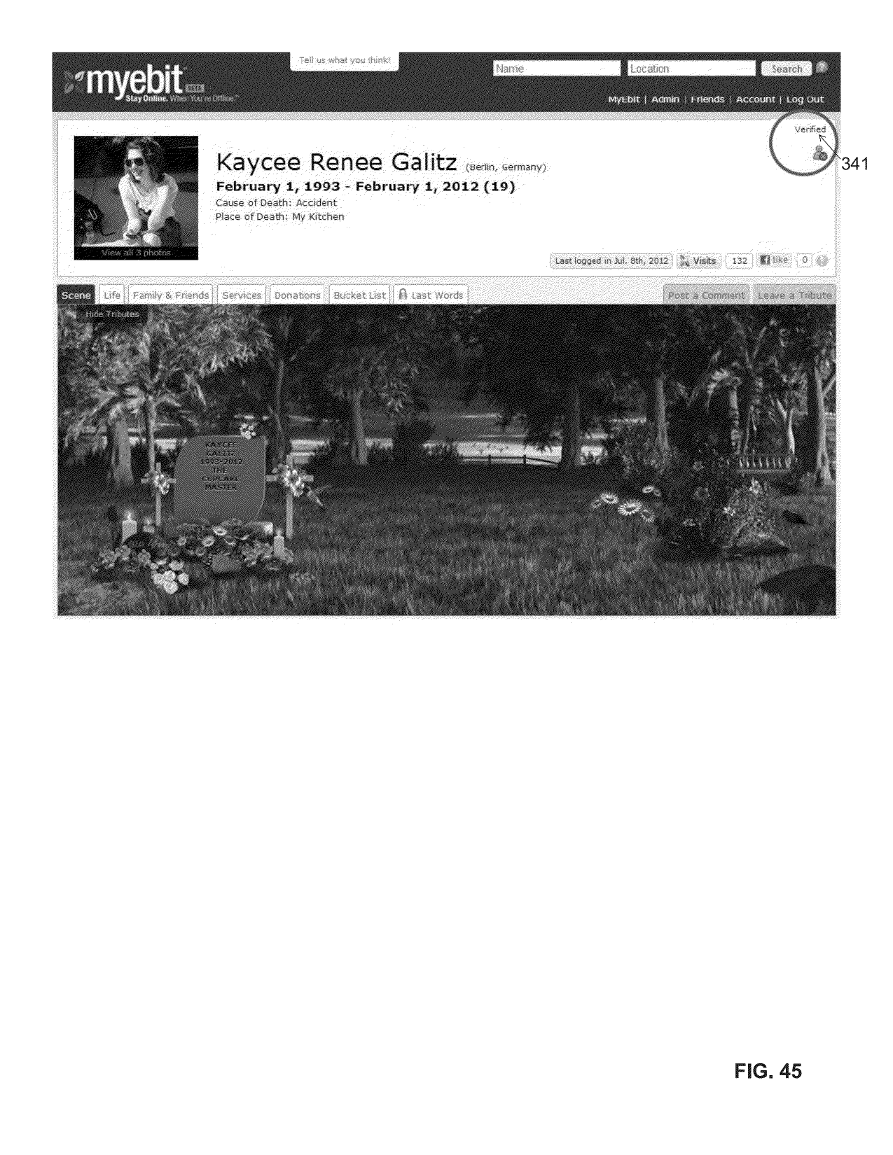

As illustrated in FIG. 2i, if the VRS 50 receives the death report from a preauthorized certified user (at 342), the VRS 50 can be configured to directly mark the reported death as verified (at 344). For example, in some embodiments, users of the VRS 50 are assigned a level of authority, such as level 1, level 2, or level 3. Administrative users are assigned a level 3, and non-administrative users are assigned a level 1. Certified users are assigned a level 2. Certified users are preauthorized by the VRS 50 (e.g., manually or automatically) as having the authority to report deaths. Certified users can include funeral homes, medical examiners, newspapers, etc. When a certified user reports a death, the VRS 50 verifies the death based on the user's preauthorized status and marks the reported death as verified (at 344). To mark a reported death as verified, the VRS 50 can add a “verified” indication 348 to the person's ebit 200, as illustrated in FIG. 45. In some embodiments, administrators (i.e., with a level 3 authority) are also authorized to report deaths without requiring additional verification as described below for non-certified users. Also, in some embodiments, a caretaker can be authorized to report deaths without requiring additional verification (e.g., by reporting a death as a previously-established caretaker or by reporting a death and submitting a caretaker code as verification).

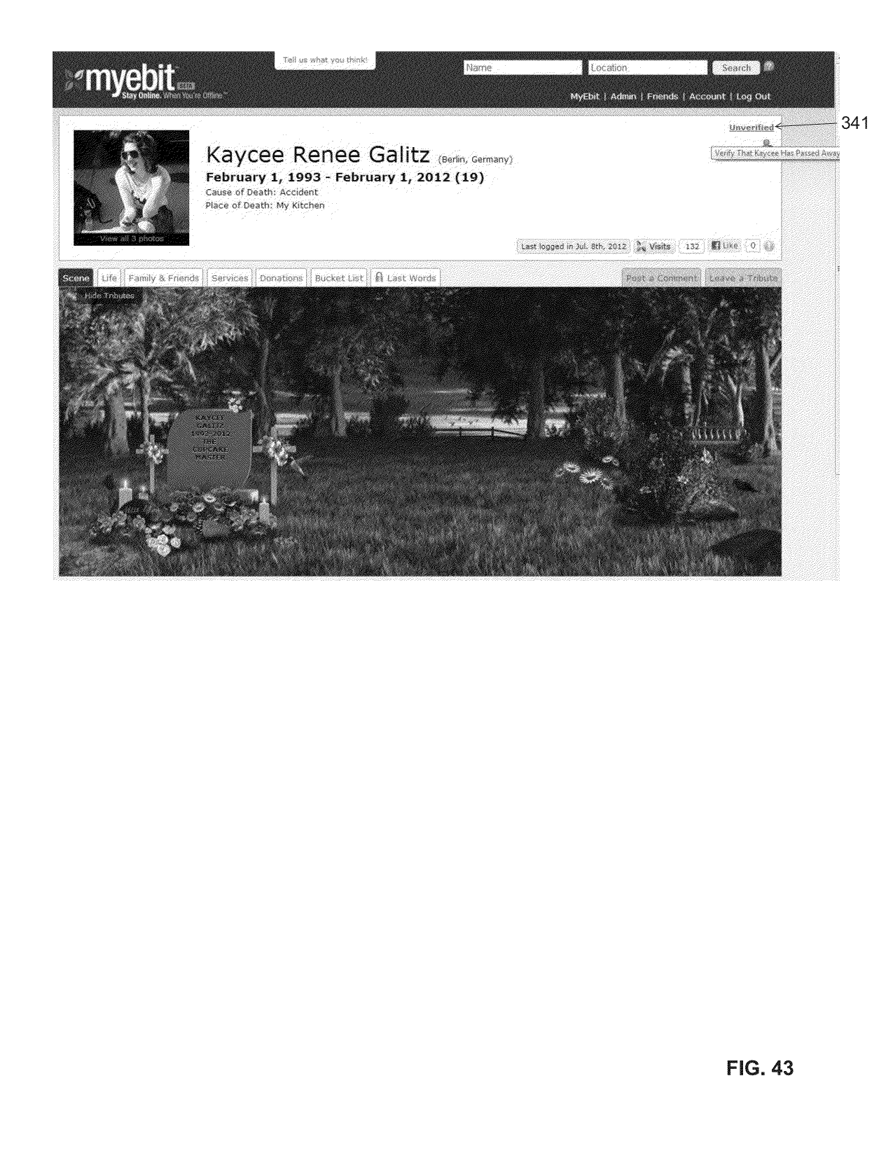

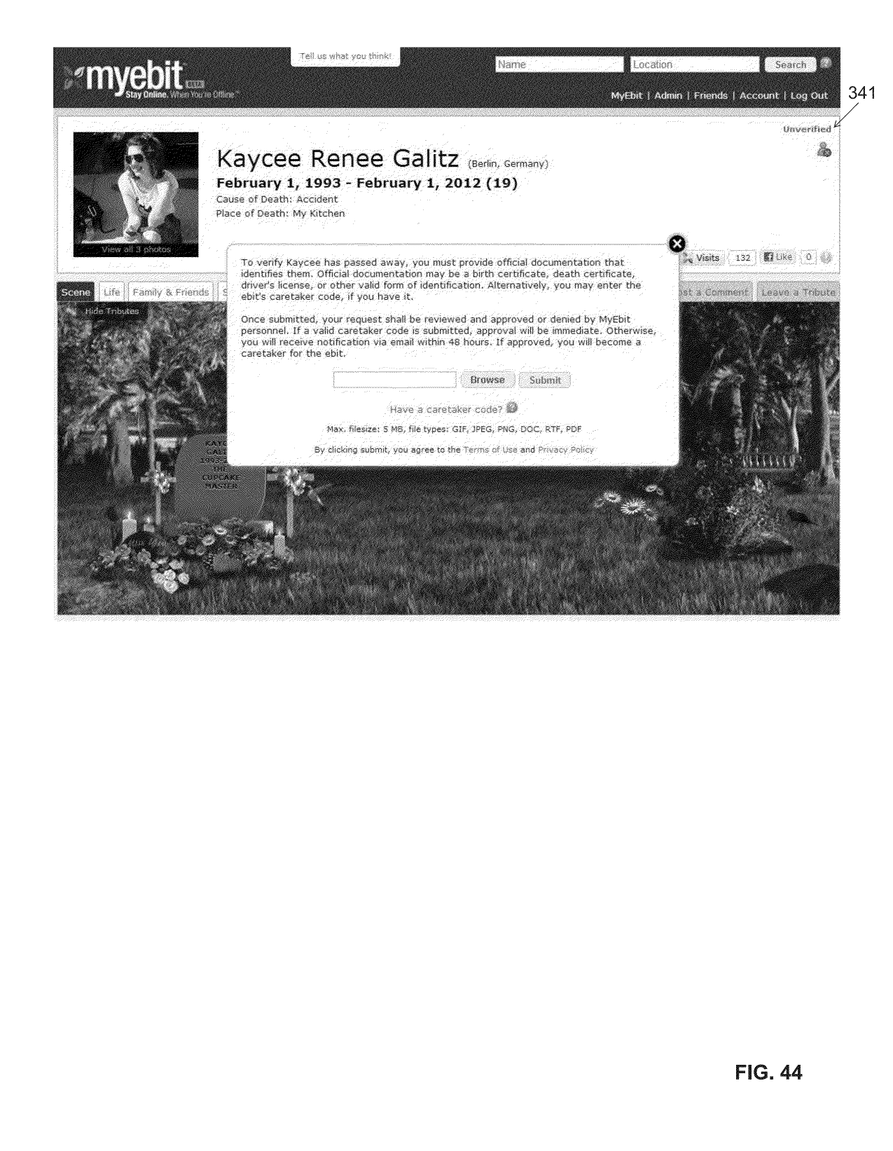

If the reported death is not received from a certified user (at 342), the VRS 50 marks the reported death as unverified (at 346). For example, as illustrated in FIG. 43, the VRS 50 can add an “unverified” indication 341, as illustrated in FIG. 43. The VRS 50 then verifies the reported death (at 348). A registered user can verify a reported death by selecting (e.g., clicking on) the “unverified” indication 341 and providing official documentation relating to the reported death, such as a government-issued death certificate (see, e.g., FIG. 44) (at 350). If the submitted documentation is verified by the VRS 50 (e.g., automatically or through a manual-review process) (at 352), the VRS 50 marks the reported death as verified (at 354).

Alternatively or in addition, the VRS 50 can be configured to automatically verify deaths, such as by accessing one or more external sources 355, as illustrated in FIG. 1a (at 358). For example, to verify a reported death, the VRS 50 can be configured access death records published by external sources (electronically or in paper) and/or database records maintained by various levels of government (e.g., death certificate records, social security records, etc.). In particular, the VRS 50 can be configured to access or import data from the Social Security Death Index (“SSDI”) and/or an associated news feed to identify new deaths. The VRS 50 can be configured to access similar death index databases in other countries. If the VRS 50 confirms a reported death through one or more of the external sources (at 358), the VRS marks the reported death as verified (at 354).

Accordingly, the VRS 50 can provide timely death notifications that are more current than other death-related notification services, such as the SSID. This timely information is useful to the general public and to external systems and organizations, such as credit companies, that need or could benefit from verifying an individual's status as “alive” or “dead” in a timely, efficient, and authoritative manner.

In some embodiments, the VRS 50 is also configured to actively identify deaths (e.g., before an ebit 200 is modified by a user or guest to report the death) based on the external sources 355. In particular, the VRS 50 can be configured to routinely access an external source 355 storing records of deaths and determine if any of the deceased identified in the records have an associated ebit 200. If so, the VRS 50 automatically updates the ebit 200 to mark the individual as being deceased (e.g., by displaying the “verified” indication 348) and optionally updates the ebit 200 to indicate the person's date of death (e.g., if this information is available through the external source). If the VRS 50 identifies the death of a person through the external sources and the person does not have an ebit 200, the VRS 50 can be configured to automatically create an ebit 200 for the person indicating the verified death, which simplifies the verification process and increases credibility and consistency of ebits 200. A user (e.g., a caretaker) can take over the automatically-created ebit 200 if desired. In some embodiments, the VRS 50 only allows caretakers or other registered users providing sufficient official documentation (e.g., identifying the user, the deceased, or the death) to take over an automatically-created ebit 200. In some embodiments, a user can also specify at least a portion of a unique identifier for the deceased, such as the last four digits of the deceased's social security number, to take over an automatically-created ebit 200.

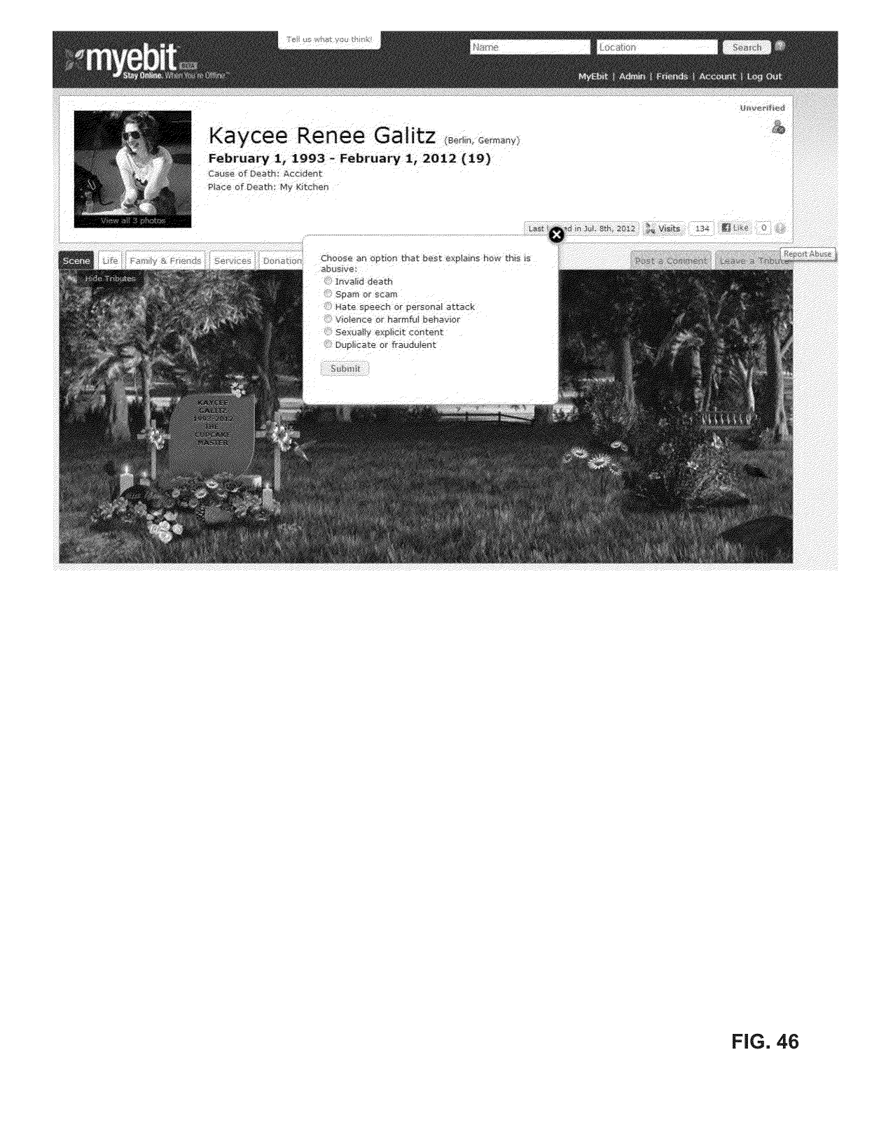

Other ways of verifying a person's death are also possible. For example, the VRS 50 can be configured to verify a person's death if a predetermined number of other users (e.g., other “friends”) and/or guests select the “unverified” indication 341 to verify a person's death. Regardless of how a person's death is reported to the VRS 50 and/or verified by or through the VRS 50, the VRS 50 allows users to report improper death verification as illustrated in FIG. 46. Users can also use a similar reporting mechanism to report other types of abusive or improper use of the VRS 50 to an administrator of the VRS 50.

In some embodiments, the VRS 50 also allows other registered users (e.g., “friends” or all registered users) to add to the scene 210 of an ebit 200, such as by adding decorations to a landscape (e.g., more trees, animals, etc.). In particular, as noted above, the VRS 50 allows other users to place a decoration as a tribute on a scene 210, such as when the person associated with the ebit 200 dies (at 280, FIG. 2g). As compared to a gift that technically can only be given to a living person, a tribute is meant for a deceased person as a form of respect, remembrance, and reflection. In some embodiments, the VRS 50 allows users to place recurring or scheduled tributes. In particular, the VRS 50 can be configured to automatically place a tribute based on the time interval specified by the user.

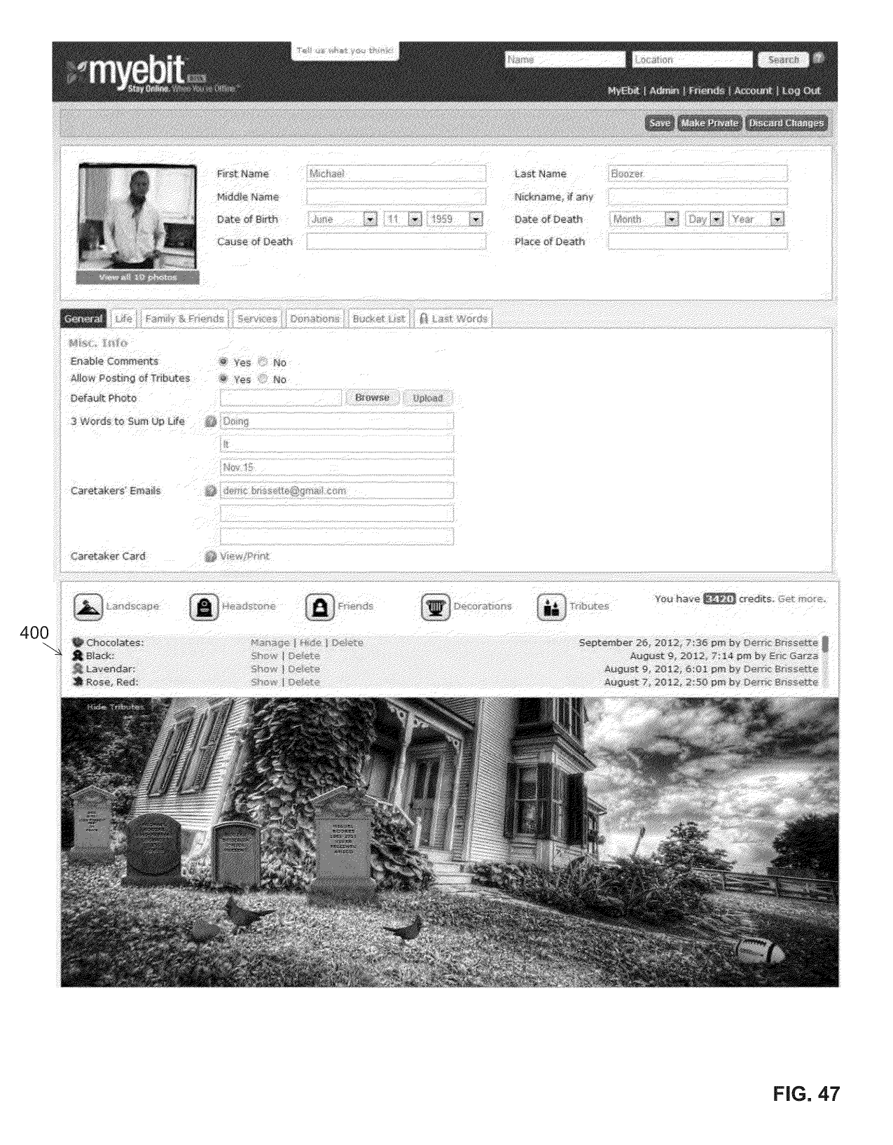

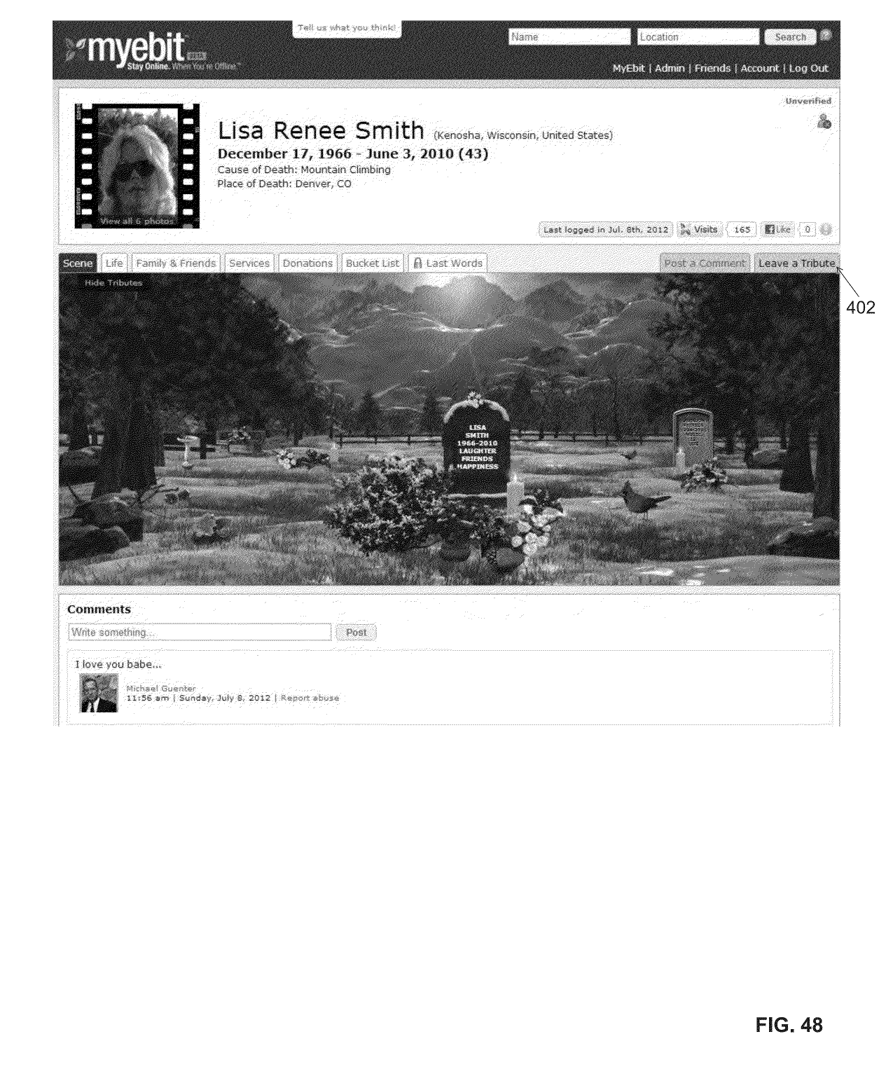

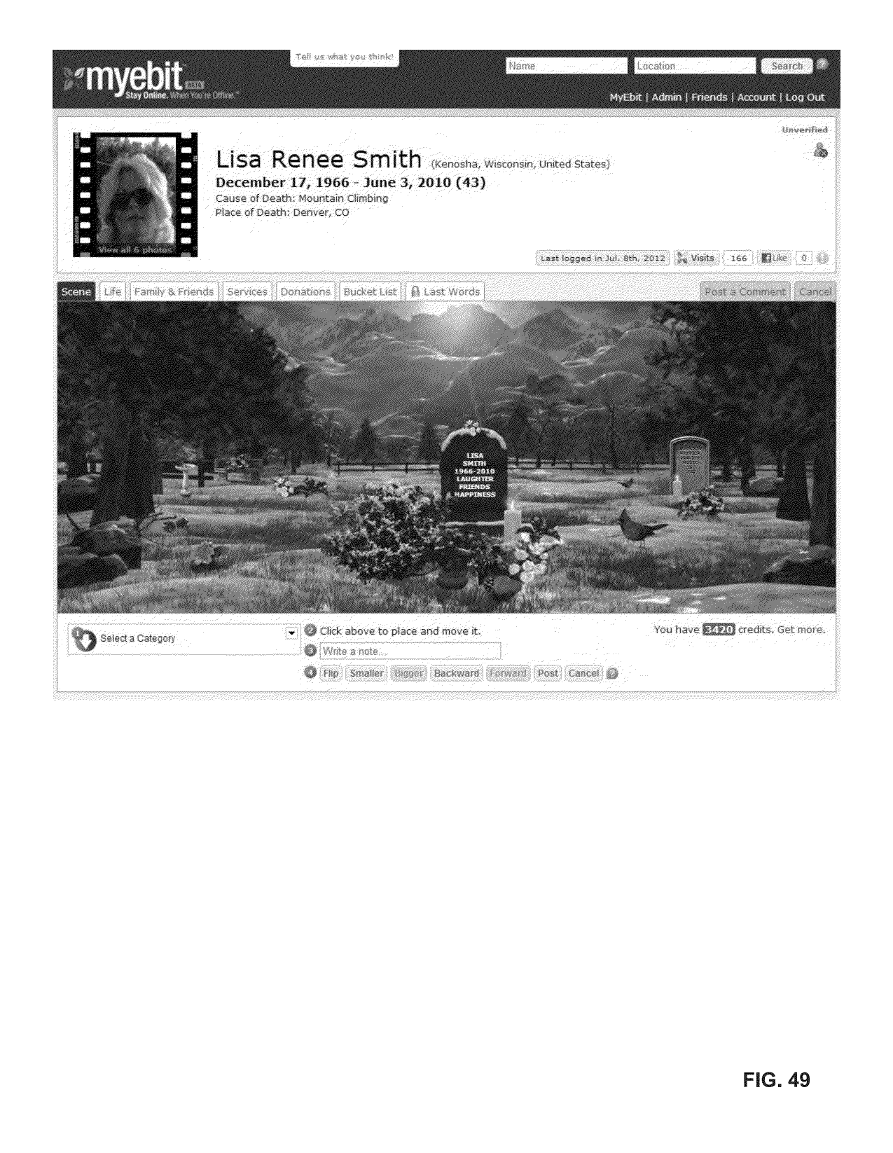

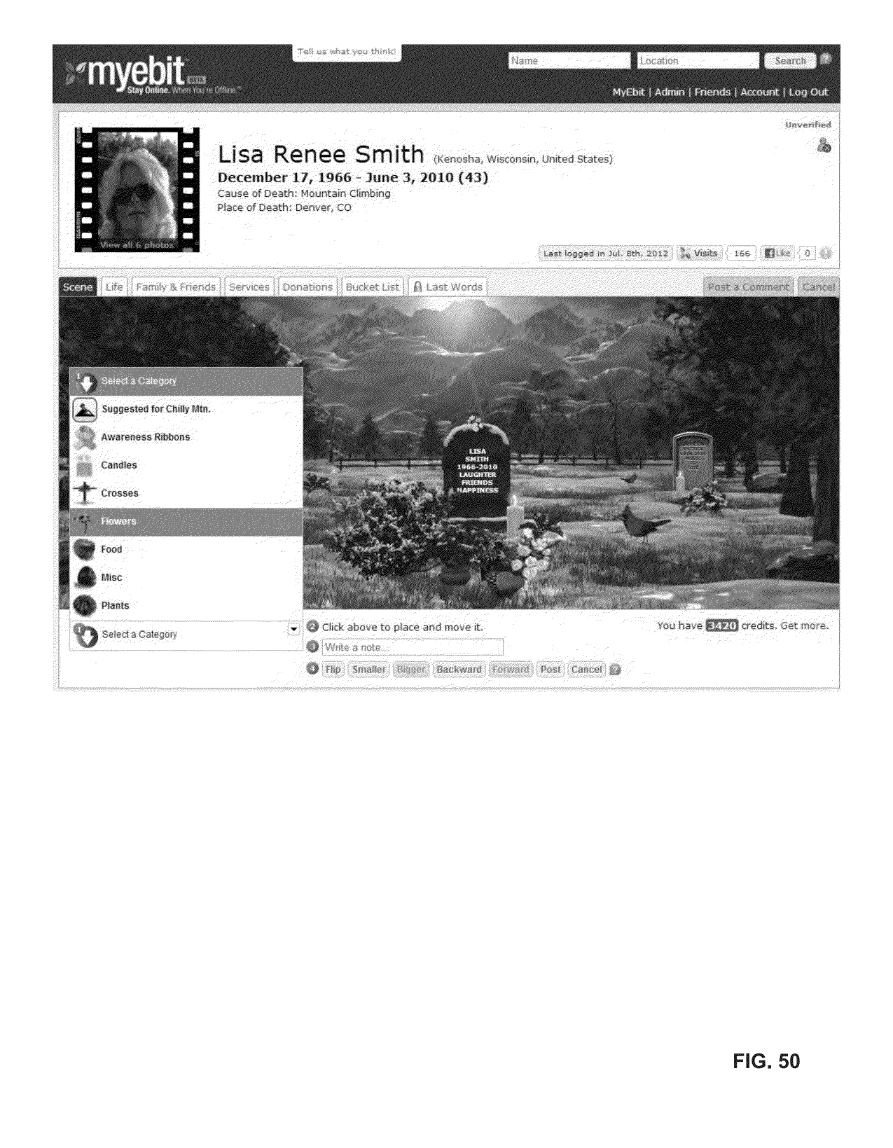

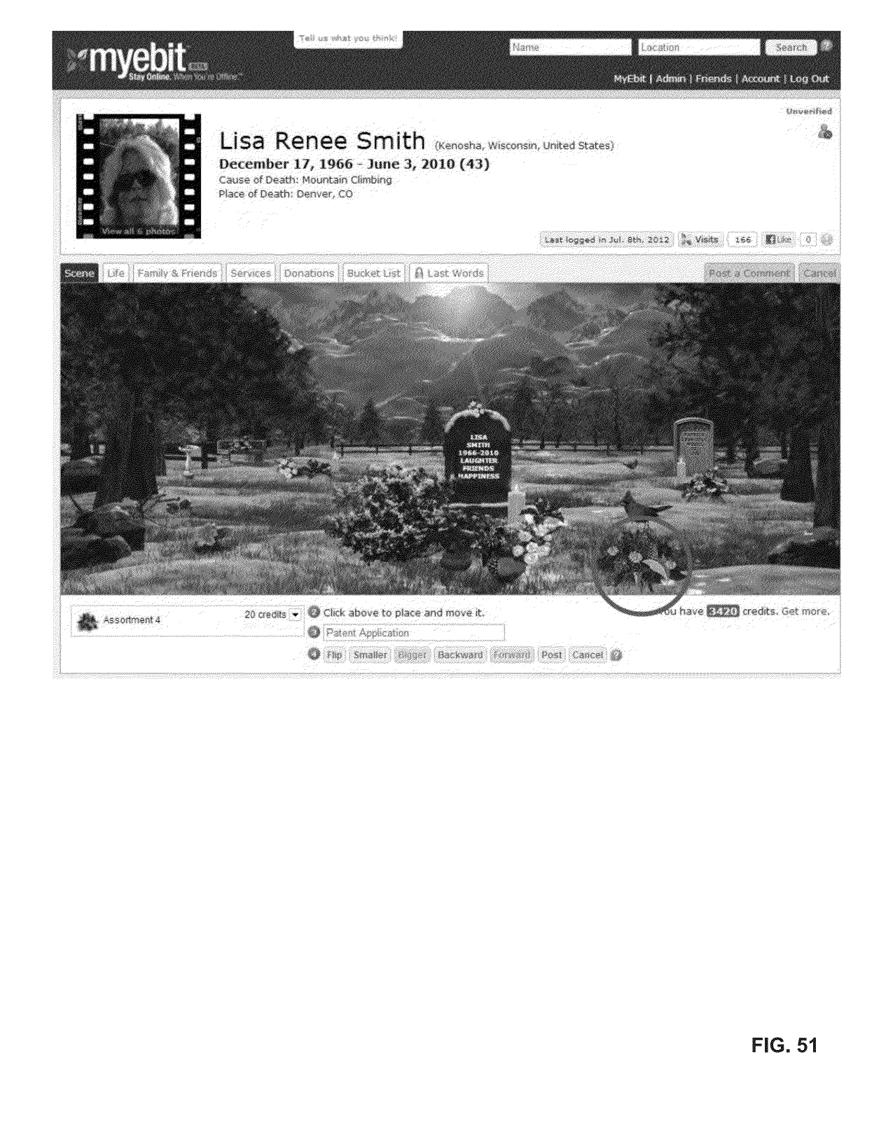

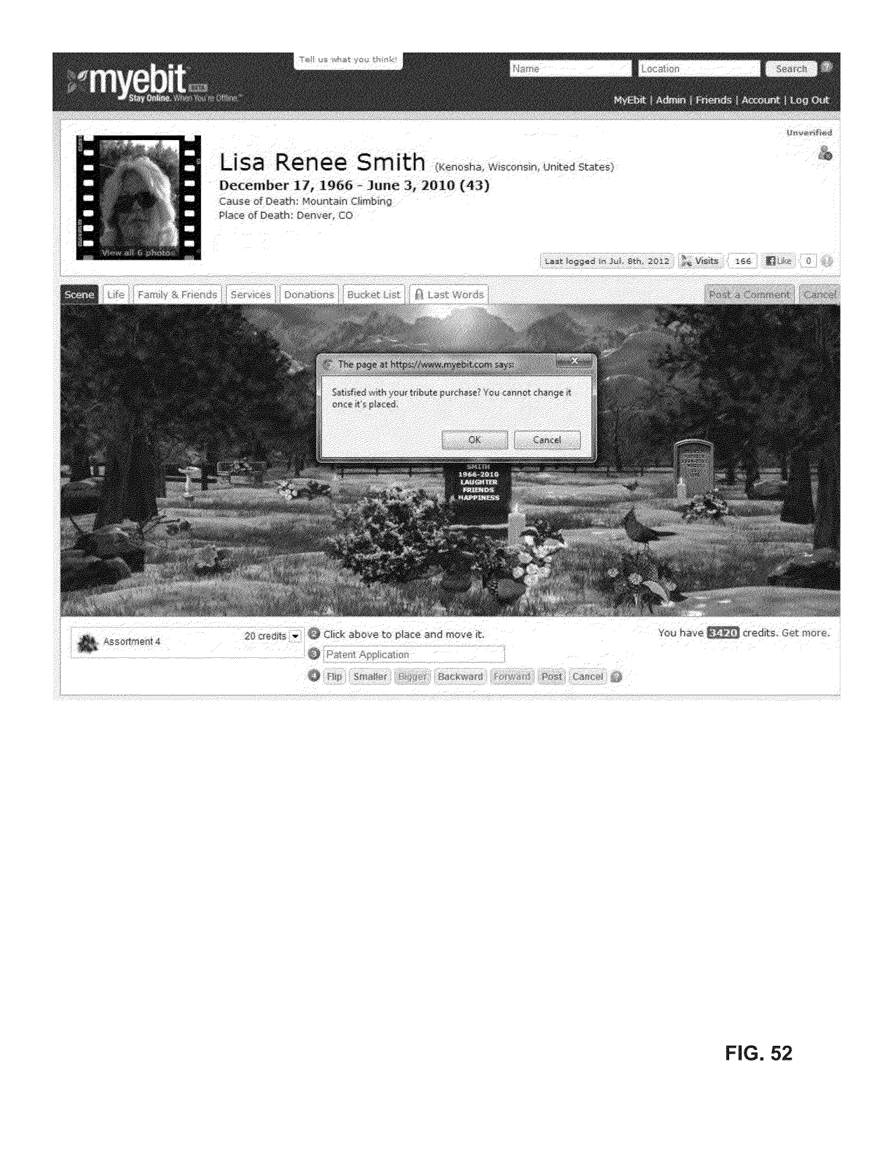

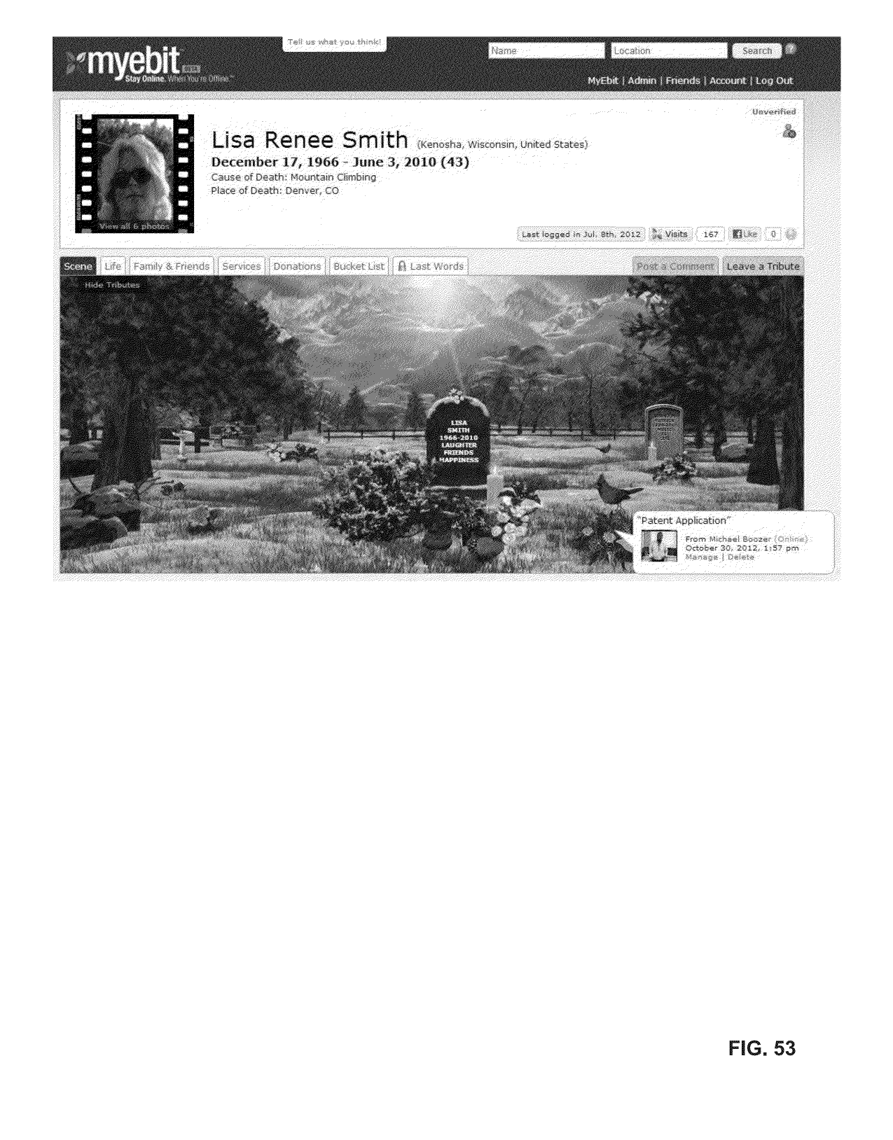

FIGS. 47-55 illustrate pages generated by the VRS 50 for placing and viewing tributes 400. As illustrated in FIG. 47, the tributes 400 are decorations as described above and can take the form of images or other digital media (including photographs, animations, videos, music, recordings, etc.). For example, the tributes 400 can include images of flowers, ribbons, flags, candles, etc. To leave a tribute, a user can select a “Leave Tribute” selection 402, as illustrated in FIG. 48. As illustrated in FIGS. 49 and 50, the VRS 50 can provide a list of tribute categories and the user can select a particular category (at 404). The VRS 50 can then provide a list of available tributes within the selected category, and the user can select a specific tribute 400 from the selected category (at 406). It should be understood that the VRS 50 can be configured to group available tributes in additional sub-levels of categories to assist the user in selecting a tribute 400. Optionally, the user can provide text associated with a selected tribute 400, such as a message from the user (at 408). In some embodiments, the VRS 50 displays textual information, if any, associated with a tribute 40 when a user or guests selects or mouses-over a tribute 400 (see, e.g., FIG. 53). In some embodiments, the VRS 50 allows the receiver and/or sender of a tribute 400 to edit or update the textual information included in the tribute 400 (e.g., change a previously sent message, add a reply to the message, and/or add a new message).

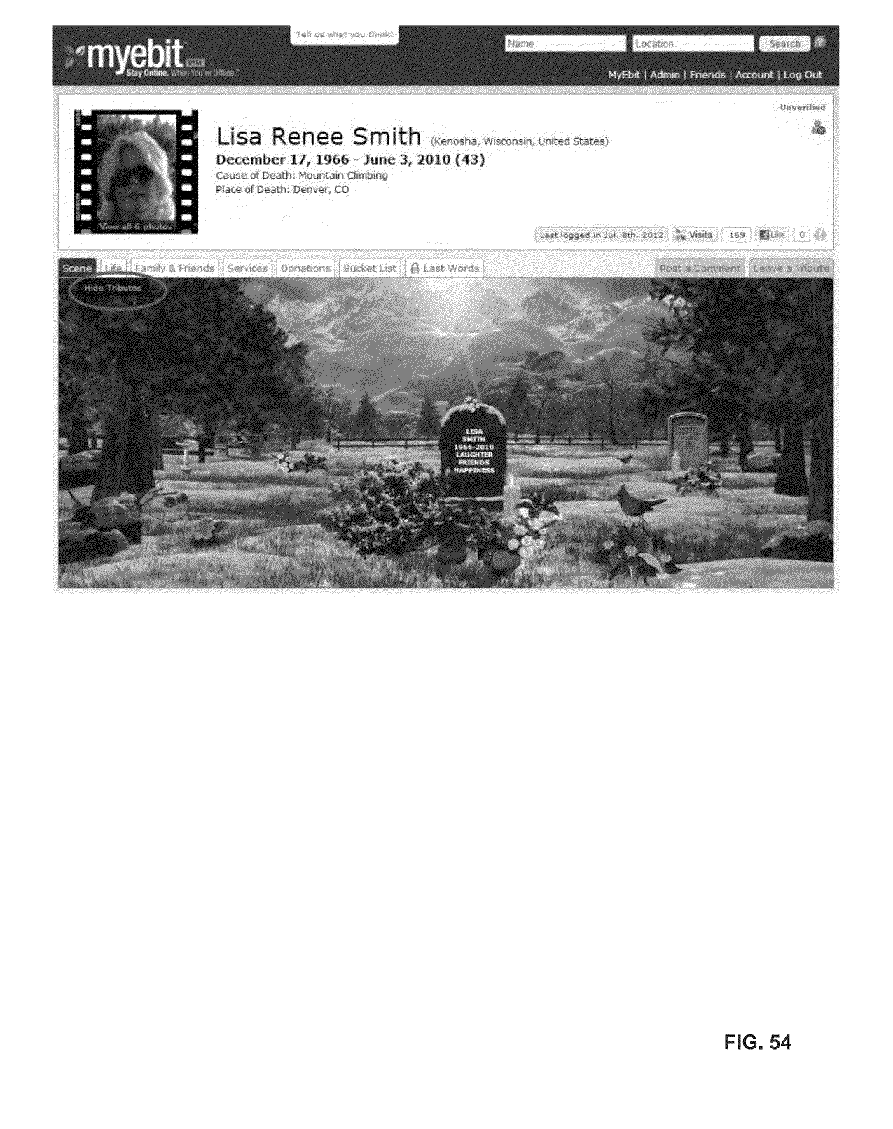

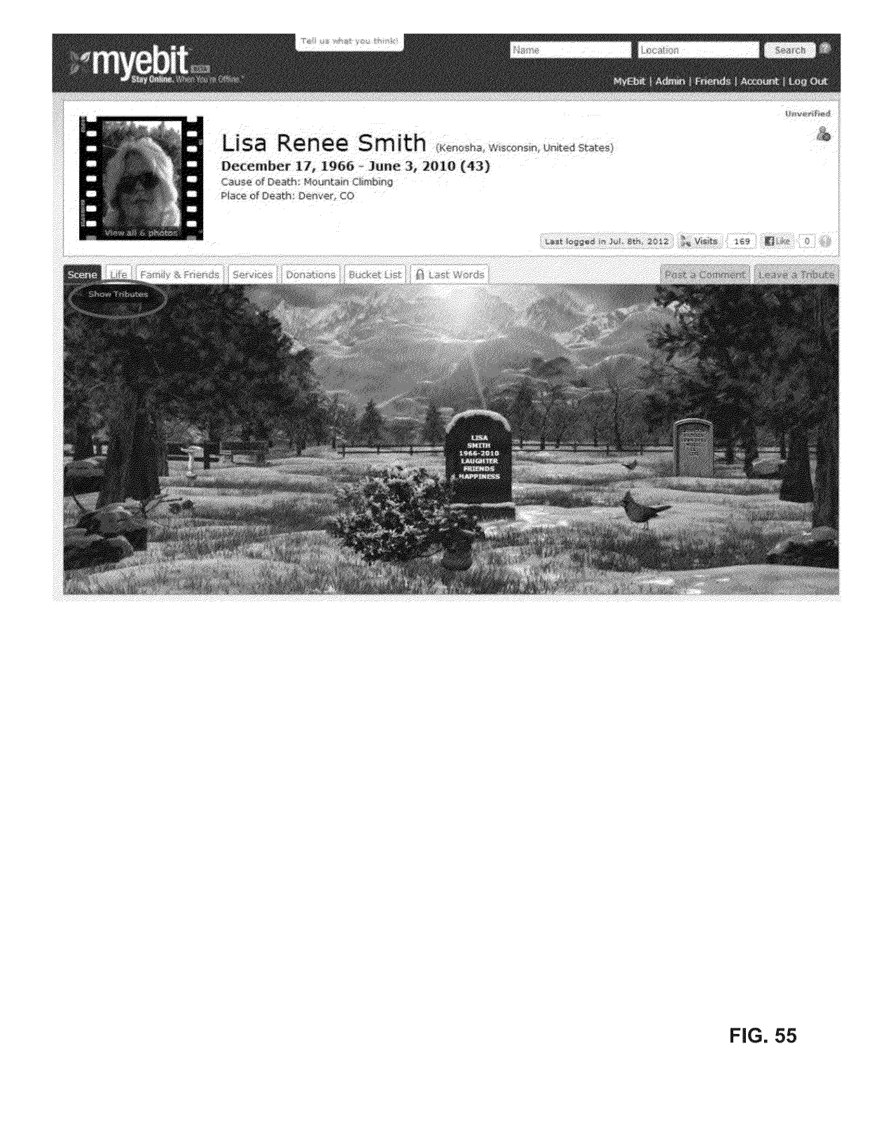

After selecting a tribute 400, the user places the selected tribute 400 on the scene 210 of the ebit 200 (at 410). In particular, the user can select and drag the selected tribute 400 to a desired location within the scene 210. The VRS 50 updates the scene 210 accordingly by superimposing or overlaying the selected tribute 400 at the designated location. As illustrated in FIGS. 49-52, in addition to allowing the user to place the tribute 400 at a desired location within the scene 210, the VRS 50 can also allow a user to edit the tribute 400, such as by changing its size or orientation. Accordingly, a user can customize the tribute 400. Also, in some embodiments, the VRS 50 allows users to create customized tributes 400 as described above for customized scenes 210. As illustrated in FIGS. 54 and 55, a user can manage tributes 400 added to their ebit 200 by hiding or displaying placed tributes. In some embodiments, a user can also delete and edit tributes 400, such as by moving a tribute 400 to a new location within a scene 210 or adding a comment to the tribute 400.

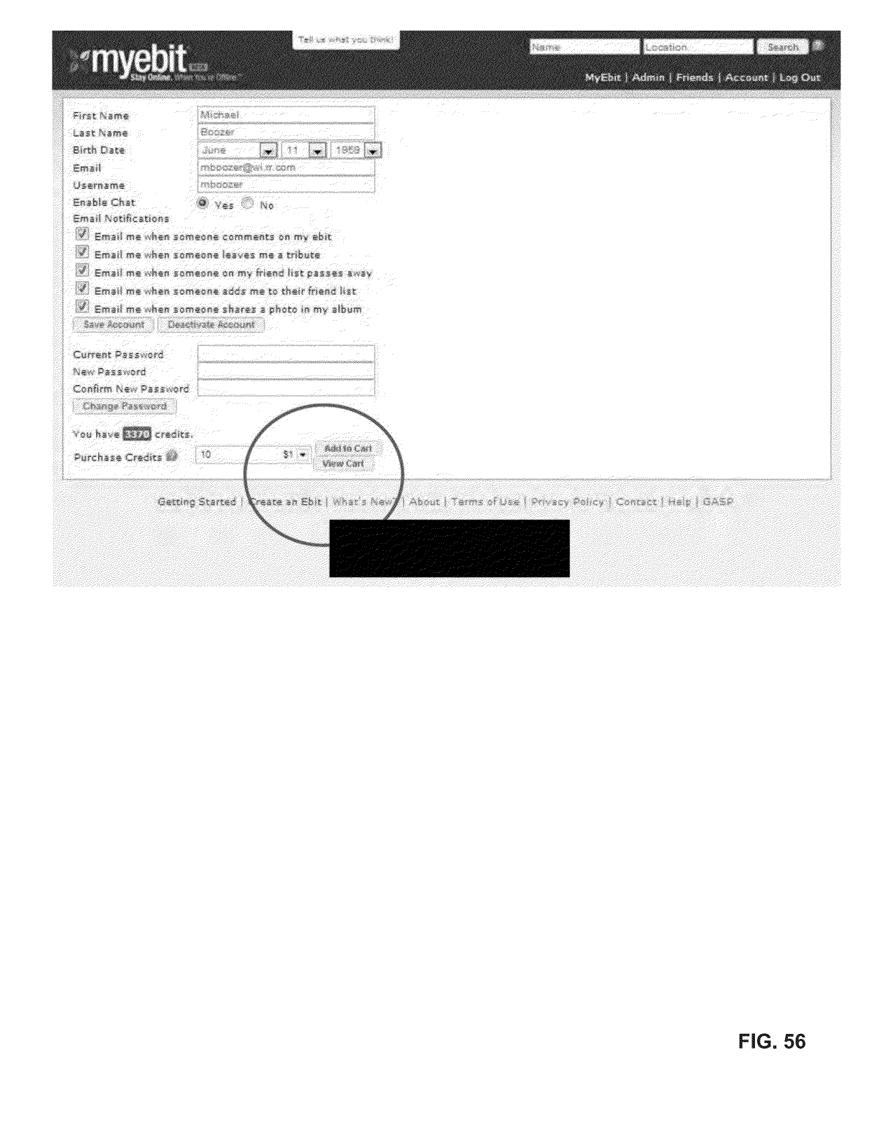

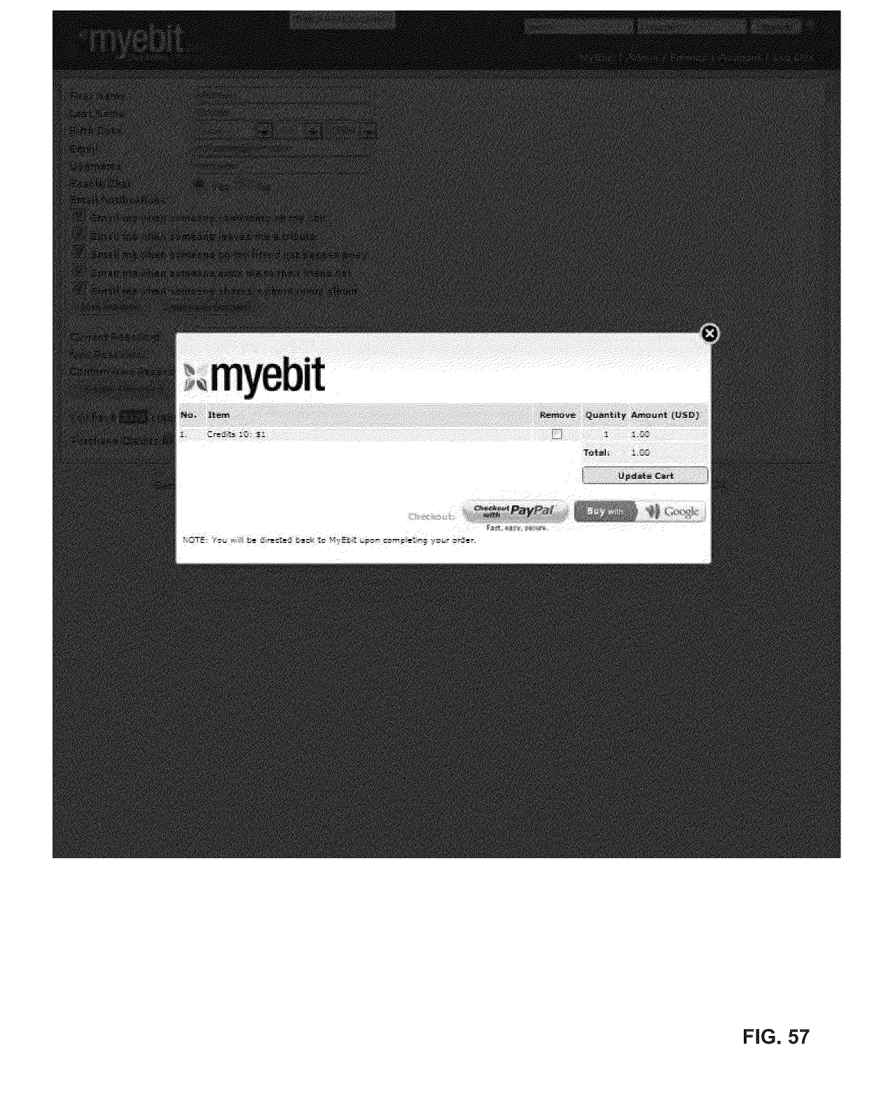

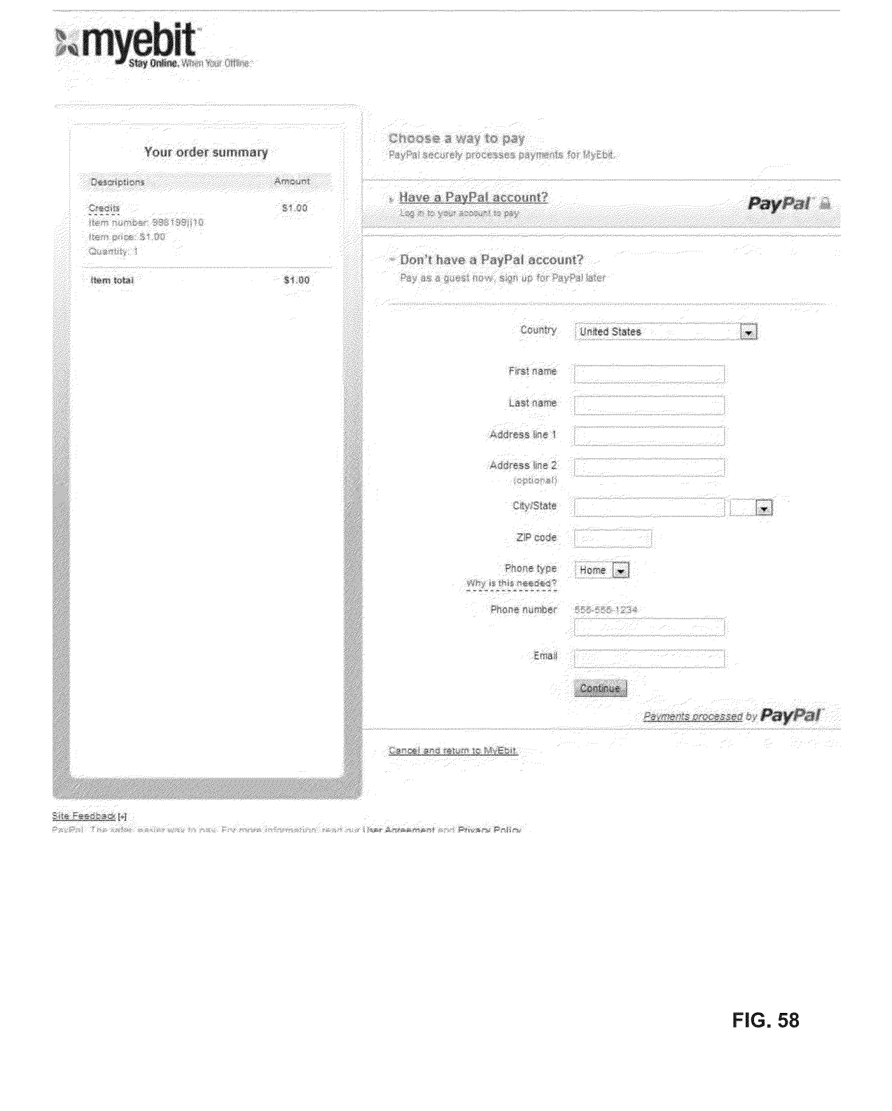

In some embodiments, the VRS 50 allows users and guests to add tributes 400 to a scene 210 for free. In other embodiments, the VRS 50 charges for all or a portion of a tribute 400. Users and guests can pay for tributes 400 by providing the VRS 50 with payment information, such as a debit or credit card number or bank account information. As noted above with respect to FIG. 6, in some embodiments, users pay for tributes 400 through the use of credits. For example, as illustrated in FIG. 56, a registered user can purchase a requested amount of credits through the VRS 50. The user can use a payment card, such as a debit or credit card, to pay for the credits or can charge the monetary amount of the requested credits to a payment processing service, such as PayPal® (see, e.g., FIGS. 57 and 58). The VRS 50 may similarly charge users for creating a scene 210. For example, the VRS 50 may be configured to charge users for selecting “premium” landscapes or decorations or customizing particular aspects of a scene 210. In some embodiments, the VRS 50 provides a user with an object library that organizes items purchased by the user in a centralized and searchable location.

The VRS 50 can also derive revenue through other services provided by the VRS 50, such as tangible flower orders, hardcopies and/or framed versions of a scene 210 or other portions of a particular ebit, notification services for selectable hardcopy publications, and/or exports or downloads of photos or videos from an ebit 200 in a slideshow format. It should be understood that any feature of the VRS 50 can be associated with a fee or provided for free.

Also, in some embodiments, the VRS 50 can serve as a central location for purchasing death-related products and services. For example, the VRS 50 can be configured to allow users to directly purchase such products or services, provide recommended links to third-party providers (e.g., for monetary consideration or on a shared revenue basis), and/or provide third-party advertisements (e.g., for monetary consideration).

For example, in some embodiments, the VRS 50 allows users and guests to send condolences. In particular, the VRS 50 allows users or guests to select, compose, and send an electronic condolence card (e.g., for a fee) to identified friends and family of a deceased. In some embodiments, the sender of the card can specify the recipients. In other embodiments, the VRS 50 automatically determines the recipients based on the deceased person's ebit 200 (e.g., identified friends and family included in the ebit 200). In some embodiments, the VRS 50 makes received and/or sent cards available within an ebit 200 (e.g., through a “Cards” tab or selection).

Also, in some embodiments, the VRS 50 is configured to provide subscription-based services. For example, a user can register with the VRS 50 as a “Premium” user by paying a one-time or recurring fee. The VRS 50 can include or be associated with a payment processing system that charges “Premium” users on a monthly or yearly basis. The VRS 50 can be configured to provide additional or improved services to “Premium” users, such as premium landscapes and decorations as well as discounted prices and the ability to hide advertising.

In some embodiments, the VRS 50 can be integrated with other systems associated with the death industry. For example, conventional newspaper obituaries can be published with a logo that identifies that an ebit 200 exists for the deceased within the VRS 50. Additional information can also be provided for accessing the ebit 200, such as a website address, code, or a quick response (“QR”) code that a reader of the obituary can use to quickly access the deceased's ebit 200 within the VRS 50. For example, in some embodiments, the VRS 50 is configured to generate a QR code for each ebit 200. A user can print out the code or cut and paste it into items (tangible or electronic), such as programs for a funeral service, obituaries (print or electronic), etc. Scanning the QR code with the appropriate scanner would take the operator of the scanner to the associated ebit 200. Similarly, the VRS 50 can be integrated with headstone barcode technology that allows users to quickly access an ebit 200 by scanning a bar code on a physical headstone or taking a picture of a code on the headstone.

The VRS 50 can also be configured to support users in their time of need. For example, in some embodiments, the VRS 50 designates ebits 200 associated with the option of making charitable donations as “Charitable.” As a way to promote charitable donations, the VRS 50 can make “Charitable” ebits 200 more visible in search results. Similarly, the VRS 50 may spotlight the death of people associated with “Charitable” ebits 200 (e.g., by posting the death on a home or main page generated by the VRS 50 or through other mechanisms). Also, in some embodiments, the VRS 50 is configured to automatically donate a portion of all tributes posted to a “Charitable” ebit 200 (e.g., to the charity associated with the ebit, a charity selected by the administrator of the VRS 50, and/or a charity randomly selected by the VRS 50).

The VRS 50 can also provide a free cross program to users. In particular, the VRS 50 can allow a user to submit a request that another user place a cross or other memorial marker at a particular location. The user can input the user for placing the cross and the location to the VRS 50, or the VRS 50 can be configured to automatically identify a registered user (e.g., a “friend”) that resides close to the user-designated location. The identified user obtains a cross or other marker (either directly or through the VRS 50) and places the marker as requested. In some embodiments, the VRS 50 allows the user placing the marker to indicate to the VRS 50 that the marker has been placed, such as by uploading a photo of the placed marker. When the user indicates that they have placed the marker, the VRS 50 can be configured to award the user with recognition within or outside of the VRS 50, such as by designating the user as having a particular designation indicating that the user is considered within the VRS 50 as a “Respected” or “Responsible” user (which can be associated with free, discounted, or advanced features within the VRS 50) or providing the user with free or discounted items or services through the VRS 50 or external system (e.g., coupons for flowers, etc.).

In some embodiments, the VRS 50 also provides a virtual online funeral service. In particular, the VRS 50 can allow a user to set a time period for an online funeral for a particular ebit. During the set time period, other users and guests can access the VRS 50 to virtually attend the online funeral. In some embodiments, the VRS 50 posts a notification of each person attending the online funeral, such as by posting a small image of a photo associated with the attendee. The VRS 50 can then display an online funeral service including images, videos, graphics, music, and other elements automatically selected and arranged by the VRS 50 or selected by the user setting up the online funeral (e.g., based on uploaded media or selected from templates available through the VRS 50). Attendees of the online funeral can post messages, chat, and place tributes during and after the service. Also, in some embodiments, the online funeral can include live streaming video or prerecorded video of an actual funeral service.

Accordingly, embodiments of the present invention provide systems and methods for creating, editing, customizing, decorating, managing, and sharing an ebituary and virtual scene of remembrance and reflection for themselves or another person or animal before and after death within an interactive social networking environment that allows others users to view, reflect, comment, share, and place tributes.

Various features and advantages of the invention are set forth in the following claims.

What is claimed is:

1. A virtual remembrance system comprising:
at least one processor configured to:
receive registration information from a first user,
generate a profile for the first user within a social networking environment based on the registration information, wherein the profile includes a text portion and a graphical scene,
set the graphical scene to a default scene including a default landscape,
receive a plurality of customizations to the default scene from the first user, wherein the plurality of customizations include a selection of a landscape for the graphical scene and a selection of one or more decorations for the graphical scene at positions selected by the first user,
update the graphical scene based on the plurality of customizations,
make the profile available within the social networking environment,
receive a selection of an additional decoration at a selected location within the graphical scene from a second user within the social network environment,
update the graphical scene based on the additional decoration, and
make the updated profile available within the social networking environment.

2. The system of claim 1, wherein the default scene further includes at least one default decoration.

3. The system of claim 2, wherein the at least one processor is further configured to initially make the at least one decoration hidden within the graphical scene until receiving an instruction to unhide the at least one decoration from the first user.

4. The system of claim 2, wherein the at least one processor is further configured to receive at least one customization to the at least one default decoration from the user.

5. The system of claim 1, wherein the plurality of customizations further includes at least one customization to the at least one decoration, the at least one customization including at least one moving, resizing, and editing the at least one decoration.

6. The system of claim 1, wherein the at least one processor is further configured to receive text associated with the additional decoration from the second user.

7. The system of claim 1, wherein the at least one processor is further configured to display the text when a user positions a cursor over the additional decoration included in the graphical scene.

8. The system of claim 1, wherein the at least one processor is further configured to charge an account associated with the second user based on the additional decoration.

9. The system of claim 1, wherein the at least one processor is further configured to allow the first user or a user designated as a caretaker for the profile to edit the additional decoration included in the graphical scene.

10. The system of claim 1, wherein the at least one processor is further configured to allow the first user or a user designated as a caretaker for the profile to delete the additional decoration from the graphical scene.

11. The system of claim 1, wherein the at least one processor is further configured to automatically apply a time-lapse to the graphical scene to change the graphical scene from a day scene to a night scene.

12. A system of handling profiles within a social networking environment, the system comprising:
at least one processor configured to:
receive registration information from a first user,
generate a profile for the first user within the social networking environment based on the registration information,
generate a unique code for the profile,
provide the unique code to the first user,
receive the unique code from a second user within the social networking environment,
update the profile to identify the second user as a manager of the profile, and
automatically grant the second user rights to modify the profile after the first person dies.

13. The system of claim 12, wherein the at least one processor is configured to grant the second user rights to modify the profile before the first person dies.

14. The system of claim 12, wherein the at least one processor is further configured to
receive a request from a third user within the social network to be added as a manager of the profile, and
update the profile to identify the third user as a manager of the profile if the third user provides approved official identifying information, wherein the approved official identifying information includes at least one of a government document identifying the first user or the third user or at least a portion of a unique identifier associated with the first user.

15. The system of claim 14, wherein the unique identifier includes the first user's social security number.

16. A method of handling a death of a user within a social networking environment, the method comprising:
receiving, at at least one processor, a report of a death of a first user associated with a profile available within the social networking environment from a second user;
updating, by the at least one processor, the profile to indicate that the first user has been reported dead;
making, by the at least one processor, the updated profile available within the social networking environment;
verifying the report, wherein verifying the report includes one of
receiving, at the at least one processor, official documentation of the death from at least one of the second user and a third user, and
identifying, by the at least one processor, the death in at least one external database storing identifiers of deceased individuals;
after verifying the report, updating, by the at least one processor, the updated profile to indicate that the first user has been reported dead and that the death has been verified and making the further updated profile available within the social networking environment.

17. The method of claim 16, wherein verifying the report includes verifying the report if the second user is not a preauthorized certified user.

18. The method of claim 17, further comprising updating the profile to indicated that the first user has been reported dead and that the death has been verified if the second user is a preauthorized certified user.

19. The method of claim 16, wherein identifying the death in at least one external database includes identifying the death in a Social Security death index.
